(19) United States
(12) Patent Application Publication
(10) Pub. No.: US 2012/0056547 A1
(43) Pub. Date: Mar. 8, 2012

(54) LIGHT-EMITTING ELEMENT DRIVING DEVICE AND IMAGE FORMING APPARATUS USING THE SAME

(75) Inventors: Toshihiko MITSUSE, Fukuoka (JP); Yuuji TOYOMURA, Fukuoka (JP)

(73) Assignee: PANASONIC CORPORATION, Osaka (JP)

(21) Appl. No.: 13/297,925

(22) Filed: Nov. 16, 2011

Related U.S. Application Data
(62) Division of application No. 11/734,534, filed on Apr. 12, 2007.

(30) Foreign Application Priority Data
Apr. 14, 2006 (JP) 2006-112322
Apr. 14, 2006 (JP) 2006-112323
Apr. 14, 2006 (JP) 2006-112324
Apr. 14, 2006 (JP) 2006-112325

(51) Int. Cl. H05B 37/02

(52) U.S. Cl. 315/192

(57) ABSTRACT

A light-emitting driving device includes a light-emitting element array including a plurality of light-emitting elements, and a driver including a plurality of driving elements. The plurality of light-emitting elements included in the light-emitting element array are driven by the plurality of driving elements included in the driver. A plurality of signal lines are connected to the plurality of driving elements, respectively. A plurality of power supply lines and a plurality of ground lines are connected to the plurality of driving elements, respectively. An entire line width of each of the plurality of signal lines is greater as a distance thereof from a signal source increases.

### CROSS-REFERENCE TO RELATED APPLICATION

This application is a divisional of pending U.S. application Ser. No. 11/734,534 filed on Apr. 12, 2007, which claims priority to Japanese Application Nos. 2006-112322, filed Apr. 14, 2006; 2006-112323, filed Apr. 14, 2006; 2006-112324, filed Apr. 14, 2006 and 2006-112325, filed Apr. 14, 2006, which are expressly incorporated herein by reference in their entireties.

### BACKGROUND OF THE INVENTION

1. Field of the Invention

The present invention relates to a driving circuit for use in an image forming apparatus equipped with a light emitting element array including a plurality of light emitting elements aligned in an array configuration and an image forming apparatus equipped with the driving circuit.

2. Description of the Related Art

In an exposure device used in an image forming apparatus employing a so-called electro-photographic process, a photosensitive member charged with a predetermined electric potential is exposed in accordance with image information to form an electrostatic latent image, the electrostatic latent image is developed with a toner, and the developed toner image is transferred and fused on a recording paper, thereby forming an image on the recording paper. As a method of forming the electrostatic latent image in the exposure device, there is known a method in which light beams emitted from a laser diode serving as a light source are irradiated on a photosensitive member through a rotatory polygonal mirror called a polygon mirror, thereby forming the electrostatic latent image on the photosensitive member, and a method in which light emitting portions of a light emitting element array constituted by aligning light emitting elements such as light-emitting diodes (hereinafter referred to as an LED) or organic EL elements in an array configuration are individually lighted or unlighted (ON/OFF) so as to form the electrostatic latent image on the photosensitive member.

Particularly, in the exposure device having the organic EL elements as the light emitting element, the organic EL elements and a drive circuit constituted by switching elements composed of thin film transistors (hereinafter referred to as a TFT) can be integrally formed on a substrate such as a glass substrate. Therefore, a manufacturing process is simplified, and it is possible to achieve a further downsizing and a cost reduction, compared with the exposure device having the LED as the light emitting element.

As disclosed in Patent Document 1, for example, there is known a configuration in which a programming operation of setting respective driving conditions of individual organic EL elements is performed to driver circuits. In such a configuration, it is important to perform the programming operation (writing operation) with respect to the driver circuits at a high speed in order to allow a stable and high-speed operation of the image forming apparatus.

The active matrix display apparatus disclosed in Patent Document 1 has been made in view of a problem that charge accumulation in a capacitor (a storage capacitor) is not properly made due to wire resistance or parasitic capacitance of source signal lines. To solve the problem, there is proposed a technology for decreasing a programming period and improving display performance by using a voltage source for supplying a voltage to the source signal lines, a current source for supply a predetermined current to the source signal lines, and a switching means for switching between the two sources.

Patent Document 1: JP-A-2003-066908

However, in the above-described technology, the element driving circuit would be inevitably complicated, thereby complicating the manufacturing process and increasing the manufacturing cost.

### SUMMARY OF THE INVENTION

Therefore, an object of the invention is to provide a light-emitting element driving device for use in an image forming apparatus and an image forming apparatus using the same, capable of realizing a further increase in an image forming speed and a printing speed while maintaining a stable operation with a simple structure.

A light-emitting element driving device in accordance with the invention includes a light-emitting element, a driving element for driving the light-emitting element, and a signal line connected to the driving element so as to control an operation of the driving element, in which the signal line is disposed between the light-emitting element and the driving element.

Accordingly, it is possible to control the light-emitting element at a high speed.

### BRIEF DESCRIPTION OF THE DRAWINGS

FIG. 1 is a diagram showing a configuration of an image forming apparatus in accordance with a first embodiment of the invention.

FIG. 2 is a diagram showing a peripheral configuration of a development station of the image forming apparatus in accordance with the first embodiment of the invention.

FIG. 3 is a diagram showing a configuration of an exposure device of the image forming apparatus in accordance with the first embodiment of the invention.

FIG. 4(a) is a top view of a glass substrate 50 related to the exposure device of the image forming apparatus in accordance with the first embodiment of the invention; and FIG. 4(b) is an enlarged view of a main part thereof.

FIG. 5 is a block diagram showing a configuration of a controller of the image forming apparatus in accordance with the first embodiment of the invention.

FIG. 6 is an explanatory diagram showing a content of a light intensity data memory of the image forming apparatus in accordance with the first embodiment of the invention.

FIG. 7 is a block diagram showing a configuration of an engine control unit of the image forming apparatus in accordance with the first embodiment of the invention.

FIG. 8 is a circuit diagram showing the exposure device of the image forming apparatus in accordance with the first embodiment of the invention.

FIG. 9 is an explanatory diagram showing a current programming period related to the exposure device of the image forming apparatus in accordance with the first embodiment of the invention, and a lighting and non-lighting period of an organic EL element.

FIG. 10 is an explanatory diagram showing a connection relationship between a source driver and a TFT circuit in accordance with the first embodiment of the invention.

FIG. 11 is a schematic diagram for explaining a problem that may be caused at the time of laying out various signal lines of the driver circuit in accordance with the first embodiment of the invention.

FIG. 12 is a diagram showing a layout of signal lines in the light-emitting element driving device in accordance with the first embodiment of the invention.

FIG. 13 is an explanatory diagram showing a relationship between the TFT circuit and the source driver in accordance with the first embodiment of the invention.

FIG. 14 is a top plan view of a peripheral configuration at a crosspoint of the signal lines in accordance with the first embodiment of the invention.

FIG. 15 is an explanatory diagram showing a configuration of a source driver signal line in accordance with the first embodiment of the invention.

FIG. 16 is a timing chart showing an example of a lighting and non-lighting control of the organic EL element in accordance with the first embodiment of the invention.

FIG. 17 is an explanatory diagram showing a layout example of the source driver in accordance with the first embodiment of the invention.

FIG. 18 is a diagram showing a configuration of a TFT circuit and a source driver in accordance with a second embodiment of the invention.

FIG. 19 is a diagram showing a configuration of a pixel circuit in accordance with the second embodiment of the invention.

FIG. 20 is a timing chart showing an example of a current programming operation in accordance with the second embodiment of the invention.

FIG. 21 is a timing chart showing timings of the lighting and non-lighting control in the course of an image forming operation in accordance with the second embodiment of the invention.

FIG. 22 is a timing chart for the case where a programming operation and a light emitting operation are performed to a pixel circuit in accordance with the second embodiment of the invention.

FIG. 23 is a timing chart showing timings of the image forming operation in the absence of the programming operation in accordance with the second embodiment of the invention.

FIG. 24 is a timing chart showing turing ON and OFF timings of programming control signals and light emission control signals in accordance with a third embodiment of the invention.

FIG. 25 is a diagram showing a configuration for the case where light emission control master signals generated by an external control signal generation unit are supplied to an inner part of a gate controller in accordance with the third embodiment of the invention.

FIG. 26 is an explanatory diagram showing a change in electric potential of a capacitance element in a programming period.

FIG. 27 is a diagram showing a configuration of a portion of an image forming apparatus related to generation of driving data in accordance with a fourth embodiment of the invention.

FIG. 28 is a diagram for explaining the concept of the driving data generation in accordance with the fourth embodiment of the invention in comparison with the known art.

FIG. 29 is a characteristic diagram showing an example of a relationship between a driving current and a luminance of the EL element in accordance with the fourth embodiment of the invention.

FIG. 30 is a characteristic diagram showing another example of a relationship between a driving current and a luminance of the EL element in accordance with the fourth embodiment of the invention.

### DETAILED DESCRIPTION OF THE PREFERRED EMBODIMENTS

Hereinafter, embodiments of the invention will be described with reference to drawings.

### First Embodiment

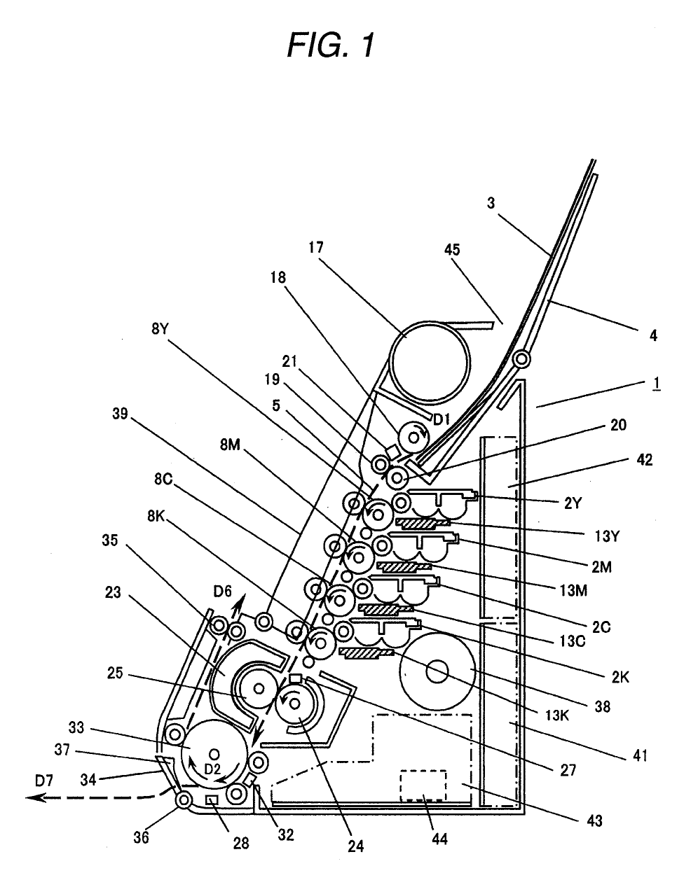

FIG. 1 is a diagram showing a configuration of an image forming apparatus in accordance with a first embodiment of the invention. In FIG. 1, the image forming apparatus 1 includes four development stations corresponding to four colors, i.e., a yellow development station 2Y, a magenta development station 2M, a cyan development station 2C, and a black development station 2K, which are arranged with an offset in a longitudinal direction. A paper feeding tray 4 accommodating a recording paper 3 as a recording medium therein is disposed above the development stations 2Y to 2K. At locations corresponding to the individual development stations 2Y to 2K, a recording paper conveyance path 5 serving as a conveyance path of the recording paper 3 supplied from the paper feeding tray extends in a longitudinal direction from an upstream side to the downstream side.

Each of the development stations 2Y to 2K forms a toner image of yellow, magenta, cyan, and black colors in this order from the upstream side of the recording paper conveyance path 5. The yellow development station 2Y has a photosensitive member 8Y, the magenta development station 2M has a photosensitive member 8M, the cyan development station 2C has a photosensitive member 8C, and the black development station 2K has a photosensitive member 8K. Moreover, each of the development stations 2Y to 2K includes components for performing a development process of a series of electro-photographic process, such as a development sleeve and a charger, which will be described later.

Exposure devices 13Y to 13K for exposing the surfaces of the photosensitive members 8Y to 8K so as to form electrostatic latent images are respectively disposed below each of the development stations 2Y to 2K.

Although colors of developing agents filled in the development stations 2Y to 2K are different from each other, the configurations of the development stations are equal to each other regardless of the developing agent color. Therefore, in the following descriptions, the development stations, the photosensitive members, and the exposure devices will be simply denoted by a development station (development unit) 2, a photosensitive member 8, and an exposure device 13 without including a specific color thereof in order to simplify the description, except a case where there is especially a need to state clearly.

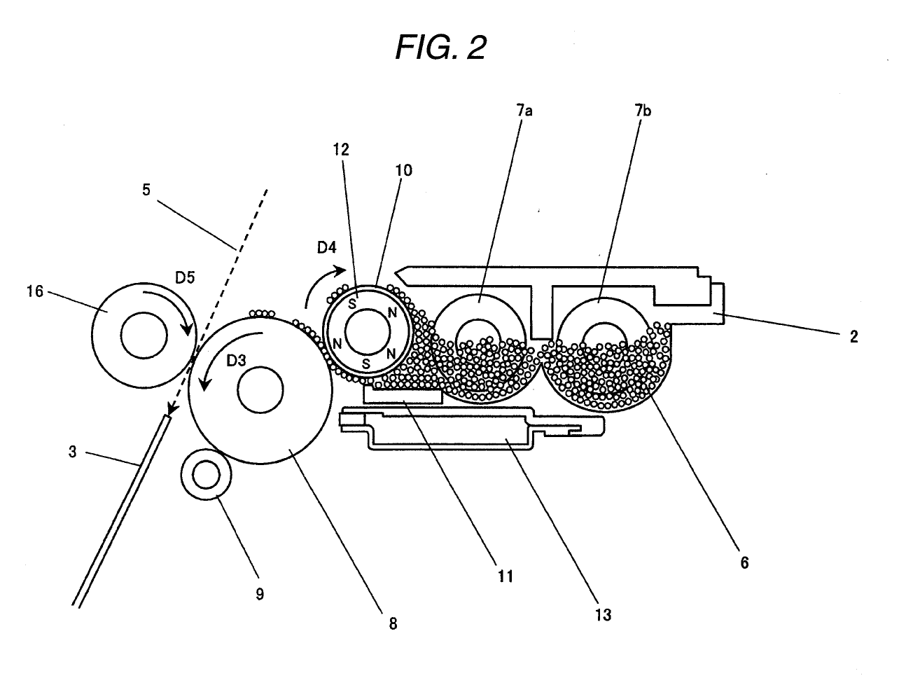

FIG. 2 is a diagram showing a peripheral configuration of the development station 2 of the image forming apparatus 1 in accordance with the first embodiment of the invention. In FIG. 2, a developing agent 6 as a mixture of a carrier and a toner is filled in the development station 2. Reference numerals 7a and 7b denotes stirring paddles for stirring the developing agent 6. With the rotation of the stirring paddles 7a and 7b, the toner in the developing agent 6 is charged with a predetermined electric potential by the friction with the carrier, and the toner and the carrier are sufficiently stirred and mixed while being circulated in the development station 2. The photosensitive member 8 is rotated in the D3 direction by a driving source (not shown). Reference numeral 9 denotes a charger that charges the surface of the photosensitive member 8 with a predetermined electric potential. Reference numeral 10 denotes a development sleeve and reference numeral 11 denotes a thin-layered blade. The development sleeve 10 includes a magenta roll 12 having a plurality of magnetic poles arranged therein. The layer thickness of the developing agent 6 supplied and formed on the surface of the development sleeve 10 is regulated by the thin-layered blade 11. The development sleeve 10 is rotated in the D4 direction by a driving source (not shown), the developing agent 6 is supplied to the surface of the development sleeve 10 by the rotation of the development sleeve 10 and the action of the magnetic poles of the magnet roll 12, and the electrostatic latent image formed on the photosensitive member 8 is developed by an exposure device 13 to be described later. In this case, the developing agent 6 that is not transferred to the photosensitive member 8 is collected into the inside of the development station 2.

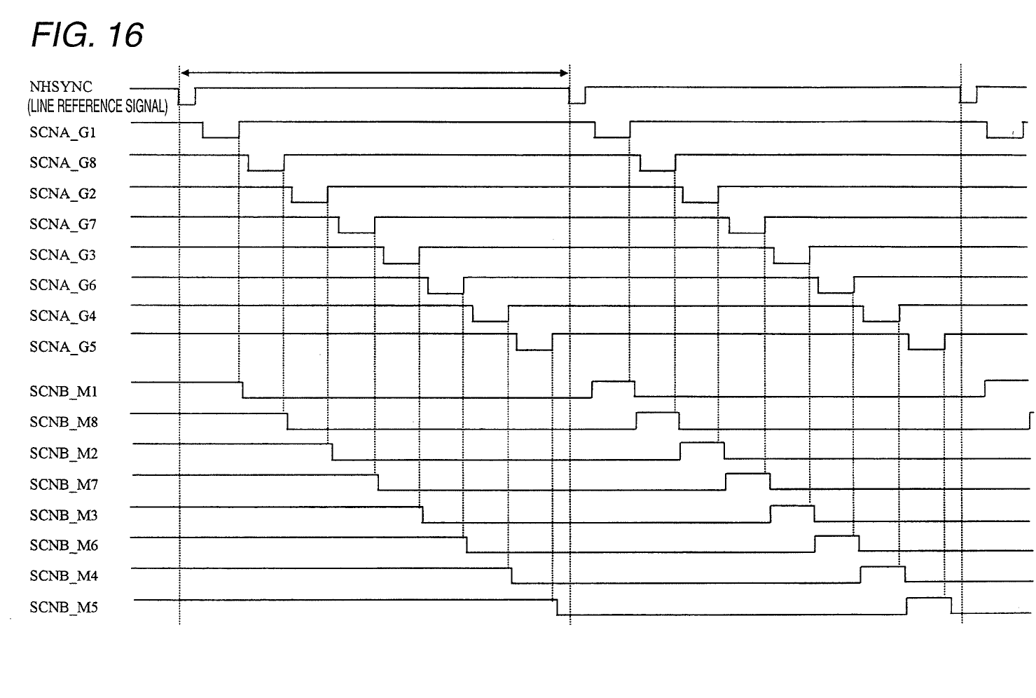

In the first embodiment, as will be described later, the development station 2 is configured to be movable in a horizontal direction in synchronization with a predetermined timing for correcting the light intensity of the light-emitting element (the organic EL element). Although components related to such a configuration are shown in FIG. 2, the related components shown in FIG. 16 include a cam 210 abutting the development station, an extension spring 211, a development station-side spring locking boss 212, and a main body-side spring locking boss 213.

Reference numeral 13 denotes an exposure device which includes a light emitting element array constituted by aligning organic EL elements serving as an exposure light source in an array configuration with a resolution of 600 dpi (dots per inch). The exposure device 13 can form an electrostatic latent image of the maximum A4 size paper on the photosensitive member 8 charged with the predetermined electric potential by the charger 9 by selectively turning ON and OFF the organic EL elements in accordance with image data. When the predetermined electric potential (a development bias) is applied to the development sleeve 10, an electric potential gradient is formed between the electrostatic latent image portion and the development sleeve 10. A coulomb force is applied to the toner in the developing agent 6 that is supplied to the surface of the development sleeve 10 and charged with the predetermined electric potential, and only the toner in the developing agent 6 is adhered to the photosensitive member 8, whereby the electrostatic latent image is developed.

As will be described later in detail, the exposure device 13 is provided with a light intensity sensor serving as a light intensity measuring unit for measuring the light intensity of the organic EL elements.

Reference numeral 16 denotes a transfer roller that is disposed at a position opposite to the photosensitive member 8 with the recording paper 5 interposed therebetween and is rotated in the D5 direction by a driving source (not shown). The transfer roller 16 is applied with a predetermined transfer bias and transfers the toner image formed on the photosensitive member 8 onto the recording paper 3 conveyed through the recording paper conveyance path 5.

Next, the description will be continued with reference to FIG. 1.

Reference numeral 17 denotes a toner bottle in which toners of yellow, magenta, cyan, and black are contained. A toner conveyance pipe (not shown) extends from the toner bottle 17 to each of the development stations 2Y to 2K, and the toner is supplied to each of the development stations 2Y to 2K through the toner conveyance pipe.

Reference numeral 18 denotes a paper feeding roller that is rotated in the D1 direction by the control of an electromagnetic clutch (not shown) and feeds the recording paper 3 stacked in the paper feeding tray 4 to the recording paper conveyance path 5.

In the uppermost stream of the recording conveyance path 5 disposed between the paper feeding roller 18 and the transfer portion of the yellow development station 2Y, there are provided a pair of rollers serving as a nip conveyance unit in the inlet side, i.e., a registration roller 19 and a pinch roller 20. The pair of the registration roller 19 and the pinch roller 20 temporarily stops the recording paper 3 conveyed by the paper feeding roller 18 and then conveys the recording paper 3 in the direction of the yellow development station 2Y at a predetermined timing. With the temporal stop, the front end of the recording paper 3 is squeezed in a direction parallel to the axial direction of the pair of the registration roller 19 and the pinch roller 20, thereby preventing inclination of the recording paper 3.

Reference numeral 21 denotes a recording paper pass detection sensor that is constituted by a reflection type sensor (a photo reflector) and detects front and rear ends of the recording paper 3 by the presence and absence of the reflected light.

When the rotation of the registration roller 19 is started with the control of the power transfer using an electromagnetic clutch (not shown), the recording paper 3 is conveyed along the recording paper conveyance path 5 in a direction toward the yellow development station 2Y. However, writing timings of the exposure devices 13Y to 13K disposed in the vicinity of the development stations 2Y to 2K to form the electrostatic latent images, ON/OFF timings of the development bias, ON/OFF timings of the transfer bias and the like are individually controlled at the time of starting the rotation of the registration roller 19.

Next, the description will be continued with reference to FIG. 2. Since the distance between the exposure device 13 shown in FIG. 2 and a development area (vicinities of the narrowest portion between the photosensitive member 8 and the development sleeve 10) is a matter of design, the period for the latent image formed on the photosensitive member 8 to reach the development area after the exposure device 13 starts its exposing operation is also a matter of design.

In the first embodiment, at the time of starting the rotation of the registration roller 19, it is controlled that the organic EL elements constituting the exposure device 13 are lighted with set values of light intensity in a period between papers (i.e., an inter-paper period) which are successively conveyed through the recording paper conveyance path 5 at the time of successively forming an image on a plurality of papers and the development bias is turned OFF in a period corresponding to the location of the latent image formed on the photosensitive member 8.

Next, the description will be continued with reference to FIG. 1. In the lowermost stream of the recording conveyance path 5 disposed at a further downstream side of the black development station 2K, there is provided a fixing unit 23 serving as a nip conveyance unit in the outlet side. The fixing unit 23 is constituted by a heating roller 24 and a pressure roller 25.

Reference numeral 27 denotes a temperature sensor for detecting the temperature of the heating roller 24. The temperature sensor 27 is a ceramic semiconductor mainly composed of a metal oxide, obtained through a high-temperature sintering process. The temperature sensor 27 can measure the temperature of an object being in contact by utilizing the variation in load resistance with temperature. The output of the temperature sensor 27 is supplied to an engine control unit 42 to be described later, the engine control unit 42 controls electric power supplied to a heat source (not shown) installed in the heating roller 24 on the basis of the output of the temperature sensor 27 so that the surface temperature of the heating roller 24 becomes about 170° C.

When the recording paper 3 having the toner image formed thereon passes through the nip portion constituted by the temperature-controlled heating roller 24 and the pressure roller 25, the toner image formed on the recording paper 3 is heated and pressurized by the heating roller 24 and the pressure roller 25 so that the toner image is fixed onto the recording paper 3.

Reference numeral 28 denotes a recording paper rear-end detection sensor that monitors a discharge state of the recording paper 3. Reference numeral 32 denotes a toner image detection sensor which is a reflection type sensor unit constituted by a plurality of light emitting elements having light emission spectra different from each other (all of which are in a visible band) an a single light receiving element. The toner image detection sensor 32 detects an image density by utilizing a fact that the absorption spectrum at background portions of the recording paper 3 and the absorption spectrum at image forming portions the recording paper 3 are different from each other in accordance with image colors. Moreover, since the toner image detection sensor 32 can detect an image forming position in addition to the image density, in the image forming apparatus 1 of the first embodiment, two toner image detection sensor 32 are provided in the width direction of the image forming apparatus 1 so as to control an image forming timing on the basis of a detection position of the positional error detection pattern of the images formed on the recording paper 3.

Reference numeral 33 denotes a recording paper conveyance drum that is a metal roller coated with a rubber having a thickness of 200 μm. Fixed recording paper 3 is conveyed in the D2 direction along the recording paper conveyance roller 33. In this case, the recording paper 3 is cooled by the recording paper conveyance drum 33 and is conveyed along a curved surface in a direction opposite to the image forming direction. With this arrangement, it is possible to considerably reduce the curl of paper occurring when forming an image on the entire surface of the recording paper with a high density. Then, the recording paper 3 is conveyed in the D6 direction by an outfeed roller 35 and discharged to a paper discharging tray 39.

Reference numeral 34 denotes a face-down paper discharging unit which is pivotable forward and backward about a support member 36. When the face-down paper discharging unit 34 is in an open state, the recording paper 3 is discharged in the D7 direction. A rib 37 is provided along the conveyance path on a back surface of the face-down paper discharging unit 34 so that the rib 37 guides the conveyance of the recording paper 3 in cooperation with the recording paper conveyance drum 33 when the face-down paper discharging unit 34 is in a closed state.

Reference numeral 38 denotes a driving source which is embodied as a stepping motor in the first embodiment. The driving source 38 serves to drive the peripheral portions of the development stations 2Y to 2K including the paper feeding roller 18, the registration roller 19, the pinch roller 20, the photosensitive members 8Y to 8K, and the transfer roller 16 (see FIG. 2 for reference), the fixing unit 23, the recording paper conveyance drum 33, and the outfeed roller 35.

Reference numeral 41 denotes a controller which receives image data from a computer (not shown) or the like through an external network and develops and generates printable image data. As will be described later in detail, a controller CPU (not shown) installed in the controller 41 serves not only as a light intensity correcting unit that receives measurement data of the light intensity of the organic EL elements as a light emitting element from the exposure devices 13Y to 13K so as to generate light intensity correction data, but also as a light intensity setting unit that sets the light intensity of the organic EL elements on the basis of the light intensity correction data.

Reference numeral 42 denotes an engine control unit which controls hardware or mechanism of the image forming apparatus 1 so as to form color image on the recording paper 3 on the basis of the image data and the light intensity correction data transmitted from the controller 41. Moreover, the engine control unit 42 controls a general operation of the image forming apparatus 1 including a temperature control of the heating roller 24 of the fixing unit 23.

Reference numeral 43 denotes a power source unit which supplies an electric power of a predetermined voltage to the exposure devices 13Y to 13K, the driving source 38, the controller 41, and the engine control unit 42. The power source unit 43 also supplies an electric power to the heating roller 24 of the fixing unit 23. The power source unit 43 has a high voltage source system such as a charging potential for charging the surface of the photosensitive member 8, a development bias to be applied to the development sleeve 10 (see FIG. 2 for reference), and a transfer bias to be applied to the transfer roller 16. The engine control unit 42 regulates turning ON and OFF, an output voltage value, and an output current value of the high voltage source by controlling the power source unit 43.

Moreover, the power source unit 43 has a power source monitor unit 44 which allows monitoring of a power source voltage to be supplied to the engine control unit 42, the output voltage of the power source unit 43, and the like. The monitor signal is detected by the engine control unit 42 in which a voltage drop in the power source caused by a switching-off or a stoppage of power supply or the like or, particularly, an abnormal output of the high voltage source is detected.

Next, the operation of the image forming apparatus 2 having such an arrangement will be described with reference to FIGS. 1 and 2. In the following description, when describing the configuration and a general operation of the image forming apparatus 1, FIG. 1 is mainly referenced and the colors are distinguished like the development stations 2Y to 2K, the photosensitive members 8Y to 8K, and the exposure devices 13Y to 13K. However, in the descriptions related to a single color, such as an exposure process and a development process, FIG. 2 is mainly referenced and the colors are not distinguished like the development station 2, the photosensitive member 8, and the exposure device 13.

### <Initialization Operation>

First, an initialization operation at the time of supplying power to the image forming apparatus 1 will be described.

When power is supplied to the image forming apparatus 1, an engine control CPU (not shown) installed in the engine control unit 42 checks errors in electric resources constituting the image forming apparatus 1, i.e., registers and memories. When the error checking is completed, the engine control CPU (not shown) starts rotation of the driving source 38. As described above, the peripheral portions of the development stations 2Y to 2K including the paper feeding roller 18, the registration roller 19, the pinch roller 20, the photosensitive members 8Y to 8K, and the transfer roller 16 (see FIG. 2 for reference), the fixing unit 23, the recording paper conveyance drum 33, and the outfeed roller 35 are driven by the driving source 38. However, immediately after the supply of power, the electromagnetic clutch (not shown) transferring a driving force to the paper feeding roller 18 and the registration roller 19 related to the conveyance of the recording paper 3 is immediately set to an OFF state so that the paper feeding roller 18 and the registration roller 19 are controlled not to convey the recording paper 3.

Next, the description will be continued with reference to FIG. 2. The rotation of the stirring paddles 7a and 7b and the development sleeve 10 is started in accordance with the rotation of the driving source 38 (see FIG. 1 for reference). Accordingly, the developing agent 6 composed of a toner and a carrier filled in the development station 2 is circulated in the development station 2, and the toner is charged with minus charges by the friction with the carrier.

The engine control CPU (not shown) controls the power source unit 43 (see FIG. 1 for reference) so as to turn on the charger 9 when a predetermined period has passed after the time of starting the rotation of the driving source 38 (see FIG. 1 for reference). The surface of the photosensitive member 8 is charged with an electric potential of −650 V, for example. The photosensitive member 8 is rotated in the D3 direction, and the engine control CPU (not shown) applies a development bias of −250 V, for example, to the development sleeve 10 by controlling the power source unit 43 (see FIG. 1 for reference) after the charged area has reached the development area, i.e., the narrowest portion between the photosensitive member 8 and the development sleeve 10. In this case, since the surface of the photosensitive member 8 is charged with the electric potential of −650 V and the development sleeve 10 is applied with the development bias of −250 V, the coulomb force applied to the toner charged with minus charges is directed toward the photosensitive member 8 from the development sleeve 10 so that the electromagnetic force line is extended toward the photosensitive member 8 from the development sleeve 10. Therefore, the toner is not adhered to the photosensitive member 8.

As described above, the power source unit 43 (see FIG. 1 for reference) has a function of monitoring the abnormal output (for example, leakage) of the high voltage source, and the engine control CPU (not shown) has a function of checking errors caused at the time of applying the high voltage to the charger 9 or the development sleeve 10.

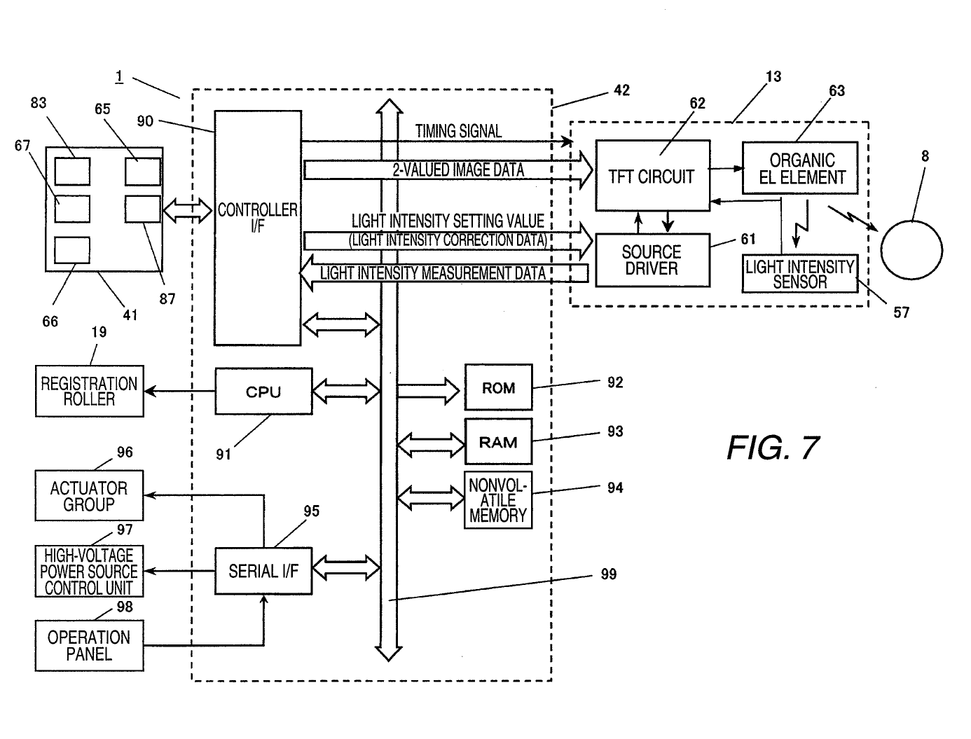

The engine control CPU 91 (see FIG. 7 for reference) corrects the light intensity of the exposure device 13 as a final step of these series of initialization operations or at a predetermined timing to be described later. The engine control CPU 91 installed in the engine control unit 42 (see FIG. 1 for reference) outputs a creation request of dummy image information for the light intensity correction to the controller 41 (see FIG. 1 for reference). Then, the controller 41 (see FIG. 1 for reference) generates the dummy image information for the light intensity correction in accordance with the creation request, and the organic EL elements constituting the exposure device 13 is actually controlled to be lighted or unlighted at the time of initialization on the basis of the dummy image information for the light intensity correction.

As will be described later in detail, the image forming apparatus 1 related to the invention includes the exposure device 13 having a light emitting element array constituted by aligning a plurality of light emitting elements (the organic EL elements) in an array configuration, in which the exposure device 13 exposes the photosensitive member 8 as an image bearing member so as to form an image. The image forming apparatus 1 has a light intensity setting unit (the above-described controller CPU installed in the controller 41) which sets the light intensity of the light emitting elements (the organic EL elements) and a light intensity measuring unit (the above-described light intensity sensor provided to the exposure device 13) which measures the light intensity of the light emitting elements (the organic EL elements).

In addition, the image forming apparatus 1 related to the invention includes the exposure device 13 having a light emitting element array constituted by aligning a plurality of light emitting elements (the organic EL elements) in an array configuration, the photosensitive member 8 having a latent image formed thereon by the exposure device 13, and the development unit (the development sleeve 10 constituting the development station 2) which develops the latent image formed on the photosensitive member 8 so as to generate a developed image. The image forming apparatus 1 has a light intensity setting unit (the above-described controller CPU installed in the controller 41) which sets the light intensity of the light emitting elements (the organic EL elements) and a light intensity measuring unit (the above-described light intensity sensor provided to the exposure device 13) which measures the light intensity of the light emitting elements (the organic EL elements), which will be described later in detail.

As will be described later in detail, the organic EL elements serving as an exposure light source constituting the exposure device 13 are lighted at a predetermined timing and the light intensity of the organic EL elements is measured. Therefore, even when the light intensity of the organic EL elements or the exposure light intensity to the photosensitive member 8 is corrected, the toner is not adhered to the photosensitive member 8, thereby preventing useless consumption of the toner. In addition, even in the image forming process subsequent to the initialization operation in which the toner is adhered to the transfer roller 16 rotating in contact with the photosensitive member 8, it is possible to prevent the toner adhered to the transfer roller 16 from adhering to the back surface of the recording paper 3 and thus contaminating the recording paper 3.

It is desirable that the development bias applied to the development sleeve 10 is set to an OFF state when the portion of the photosensitive member 8 exposed by the organic EL elements being lighted at the time of correcting the light intensity approaches the development sleeve 10 and passes through the development area. That is, it is desirable that the development bias applied to the development sleeve 10 corresponding to the portion of the photosensitive member 8 exposed at the time of measuring the light intensity of the organic EL elements is set to an OFF state. With this arrangement, it is possible to further effectively prevent the adhering of the toner to the photosensitive member 8.

### <Image Forming Operation>

Next, the image forming operation of the image forming apparatus 1 will be described with reference to FIGS. 1 and 2.

When image information is transmitted to the controller 41 from an external source, the controller 41 expands the image information into printable data, for example, as 2-valued image data and supplies the 2-valued image data to an image memory (not shown). After completing the expansion of the image information, the controller CPU (not shown) installed in the controller 41 outputs a start-up request to the engine control unit 42. The start-up request is received by the engine control CPU (not shown) installed in the engine control unit 42, and the engine control CPU (not shown) immediately starts the preparation of image forming operation by rotating the driving source 38.

After completing the preparation of the image forming operation through the above-described processes, the engine control CPU (not shown) installed in the engine control unit 42 controls the electromagnetic clutch (not shown) so as to rotate the paper feeding roller 18 and start the conveyance of the recording paper 3. The paper feeding roller 18 is a half-moon shaped roller in which a portion of the entire circumference is omitted. The paper feeding roller 18 conveys the recording paper 3 in the direction of the registration roller 19 and stops its rotation after one rotation. When the front end of the conveyed recording paper 3 is detected by the recording paper pass detection sensor 21, the engine control CPU (not shown) controls the electromagnetic clutch (not shown) so as to rotate the registration roller 19 after a predetermined delay period. The recording paper 3 is supplied to the recording paper conveyance path 5 in accordance with the rotation of the registration roller 19.

The engine control CPU (not shown) individually controls the wiring timing for each of the exposure devices 13Y to 13K to form the electrostatic latent image at the time of starting the rotation of the registration roller 19. Since the writing timing of the electrostatic latent image has a direct influence on the color error or the like of the image forming apparatus 1, the writing timing is not generated directly from the engine control CPU (not shown). Specifically, the engine control CPU (not shown) presets the writing timing for each of the exposure devices 13 to form the electrostatic latent image to timers as hardware (not shown) and activates the operations of the corresponding timers of the exposure devices 13Y to 13K at the time of starting the rotation of the above-described registration roller 19. Each of the timers outputs an image data transmit request to the controller 41 when a preset period has passed.

The controller CPU (not shown) of the controller 41 having received the image data transmit request transmits individual 2-valued image data to each of the exposure device 13Y to 13K in synchronization with a timing signal (such as a clock signal and a line sync signal) generated from a timing generation unit (not shown) of the controller 41. In this way, the 2-valued image data is sent to the exposure devices 13Y to 13K, and the lighting and non-lighting of the organic EL elements constituting the exposure devices 13Y to 13K is controlled on the basis of the 2-valued image data, thereby exposing the photosensitive members 8Y to 8K corresponding to each color.

The latent image formed by the exposure is developed with the toner contained in the developing agent 6 supplied onto the development sleeve 10, as shown in FIG. 2. The developed toner image corresponding to each color is sequentially transferred to the recording paper 3 conveyed through the recording paper conveyance path 5. The recording paper 3 having toner images corresponding to four colors transferred thereto is conveyed to the fixing unit 23 while being sandwiched between the over-heated roller 24 and the pressure roller 25 constituting the fixing unit 23, and the toner image is then fixed onto the recording paper 3 by the heat and pressure.

In a case where the image is to be formed on a plurality of pages, the engine control CPU (not shown) temporarily stops the rotation of the registration roller 19 when the rear end of the recording paper 3 corresponding to a first page is detected by the recording paper pass detection sensor 21. Thereafter, the engine control CPU starts the conveyance of a subsequent recording paper 3 after a predetermined period. Similarly, the engine control CPU starts again the rotation of the registration roller 19 after a predetermined period and then supplies the recording paper 3 corresponding to the next page to the recording paper conveyance path 5. In this way, by controlling the rotation ON and OFF timing of the registration roller 19, it is possible to set the period between recording papers 3 when forming the image on a plurality of pages. Although the period between the papers (hereinafter referred to as an inter-paper period) varies depending on the specification of the image forming apparatus 1, the inter-paper period is generally set to about 500 ms. It is noted that an ordinary image forming operation (i.e., an exposure operation of the exposure device 13 to the photosensitive member 8) is not performed in the inter-paper period.

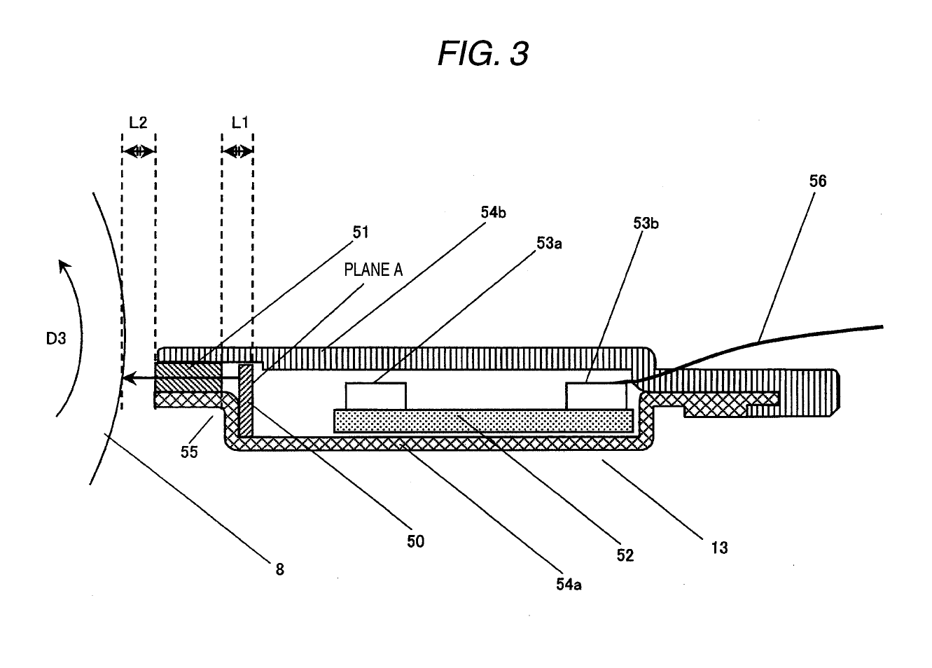

FIG. 3 is a diagram showing a configuration of the exposure device 13 of the image forming apparatus 1 in accordance with the first embodiment of the invention. Hereinafter, the configuration of the exposure device 13 will be described with reference to FIG. 3. In FIG. 3, reference numeral 50 denotes an achromatic transparent glass substrate. In the embodiment, the glass substrate 50 is made of a borosilicate glass that is advantageous in cost. However, when there is a need to more efficiently radiate heat generated from the light emitting elements, a control circuit, a driving circuit, or the like, those circuits being formed of thin-film transistors on the glass substrate 50, the glass substrate 50 may be made of glass or quartz containing a heat conductivity additive material such as MgO, Al₂O₃, CaO, and ZnO.

On a plane A of the glass substrate 50, the organic EL elements as the light emitting elements are formed in a direction (a primary scanning direction) perpendicular to the drawing with a resolution of 600 dpi (dots per inch). Reference numeral 51 denotes a lens array constituted by aligning rod shaped lenses made of plastic or glass in an array configuration. The lens array 51 introduces the output light beams from the organic EL elements formed on the plane A onto the surface of the photosensitive member 8 as an erected image of same magnification. The positional relation between the glass substrate 50, the lens array 51, and the photosensitive member 8 is adjusted such that one focal point of the lens array 51 is placed on the plane A of the glass substrate 50 and the other focal point of the lens array 51 is placed on the surface of the photosensitive member 8. That is, the distance L1 between the plane A and a plane closest to the lens array 51 and the distance L2 between a plane of the lens array 51 and the surface of the photosensitive member 8 are equal to each other, i.e., a relation of L1=L2.

Reference numeral 52 denotes a relay substrate having an electronic circuit formed on a glass epoxy substrate, for example. Reference numerals 53a and 53b denote a connector A and a connector B, respectively. At least the connector A 53a and the connector B 53b are mounted on the relay substrate 52. The relay substrate 52 relays the image data, the light intensity correction data and other control signals supplied through a cable 56 such as flexible flat cables from external source to the exposure device 13 through the connector B 53b and then transmits the signals to the glass substrate 50.

Since it is difficult to directly mount the connectors on the surface of the glass substrate 50 considering the bonding strength and reliability in various environment, in the first embodiment, it is constructed in a manner that an FPC (flexible printed circuit) is used as a connecting unit for connecting the connector A 53a of the relay substrate 52 and the glass substrate 50 to each other and the substrate 50 and the FPC are bonded with an ACF (anisotropic conductive film), for example, thereby connecting the FPC directly onto an ITO (indium tin oxide; indium oxide doped with indium) electrode, for example formed in advance on the glass substrate 50.

The connector B 53b is a connector for connecting the exposure device 13 to an external source. Generally, the ACF connection may cause a problem of bonding strength. However, by providing the connector B 53b for the connection of the exposure device 13 on the relay substrate 52, it is possible to secure sufficient strength on an interface to which a user directly makes an access.

Reference numeral 54a denotes a housing A molded by bending a metal plate, for example. An L-shaped portion 55 is formed on a side of the housing A 54a facing the photosensitive member 8, and the glass substrate 50 and the lens array 51 extend along the L-shaped portion 55. When it is constructed in a manner that an end face of the housing A 54a to the side of the photosensitive member 8 and an end face of the lens array 51 are positioned in the same plane and one end portion of the glass substrate 50 is supported by the housing A 54a, thereby securing molding precision of the L-shaped portion 55, it is possible to adjust the positional relation between the glass substrate 50 and the lens array 51 with high precision. Since the housing A 54a requires high dimensional precision, the housing A 54a is preferably made of metal. By making the housing A 54a from metal, it is possible to suppress the influence of noise to the electronic components such as the control circuit formed on the glass substrate 50 and IC chips mounted on the surface of the glass substrate 50.

Reference numeral 54b denotes a housing B by molding resins. A cutout portion (not shown) is formed on a portion of the housing B 54b in the vicinity of the connector B 53b. A user can access the connector B 53b through the cutout portion. The image data, the light intensity correction data, the control signals such as the clock signals and the line sync signals, the driving power of the control circuit, the driving power of the organic EL elements serving as the light emitting elements are supplied to the exposure device 13 from the above-described controller 41 (see FIG. 1 for reference) through the cable 56 connected to the connector B 53b.

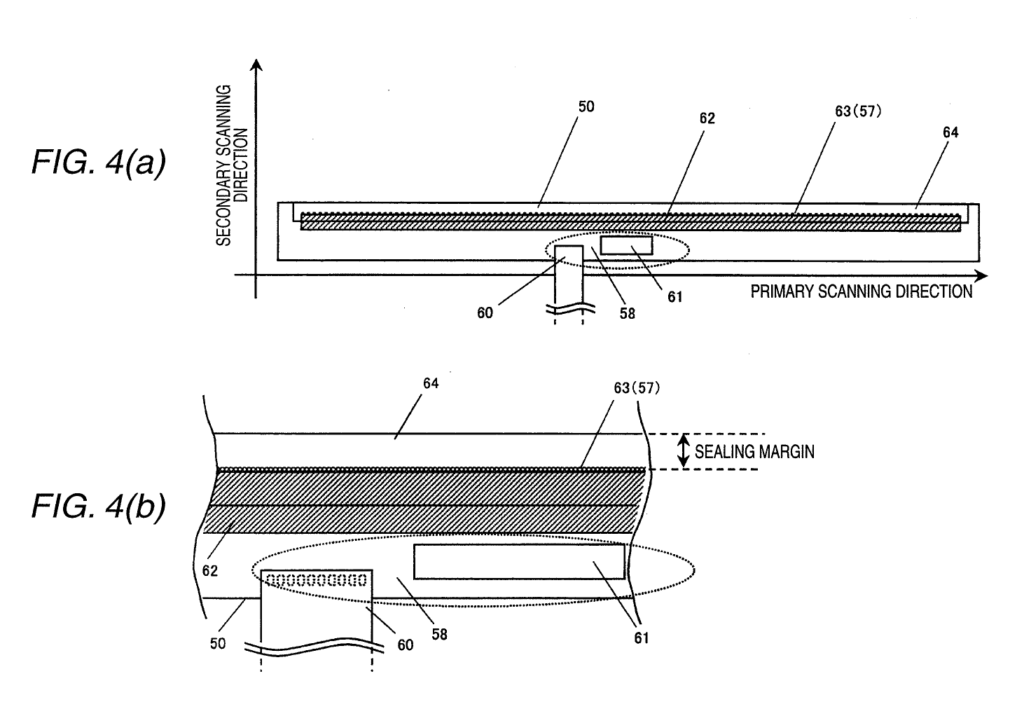

FIG. 4(a) is a top view of the glass substrate 50 related to the exposure device 13 of the image forming apparatus 1 in accordance with the first embodiment of the invention, and FIG. 4(b) is an enlarged view of a main part thereof. Hereinafter, the arrangement of the glass substrate 50 in accordance with the first embodiment of the invention will be described with reference to FIGS. 3 and 4.

In FIG. 4, the glass substrate 50 is a rectangular substrate with longitudinal and transversal sides and having a thickness of about 0.7 mm and a plurality of organic EL elements as the light emitting elements are aligned in an array configuration along a direction of the longitudinal side (a primary scanning direction). In the first embodiment, the organic EL elements 63 required for exposing at least A4 size paper (210 mm) are disposed in the longitudinal direction of the glass substrate 50, and the length of the longitudinal side of the glass substrate 50 is set to 250 mm including a layout space for a drive control unit 58 to be described later. Although in the embodiment, the glass substrate 50 having a rectangular shape is described to simplify the description, a modification may be applied to the glass substrate 50 in which a cutout portion for the positioning of the glass substrate 50 fitted to the housing A 54a is provided on a portion of the glass substrate 50.

Reference numeral 58 denotes a drive control unit which receives the 2-valued image data, the light intensity correction data, and the control signals such as the clock signals and the line sync signals, supplied from an external source. The drive control unit 58 includes an interface unit for receiving those signals from sources external to the glass substrate 50 and an IC chip (a source driver 61) for controlling the driving of the organic EL elements 63 on the basis of the received signals.

Reference numeral 60 denotes an FPC (flexible print circuit) as the interface unit for connecting the connector A 53a of the relay substrate 52 and the glass substrate 50 to each other. The FPC 60 is directly connected to a circuit pattern (not shown) provided on the glass substrate 50 without being connected through the connectors or the like. As described above, the 2-valued image data, the light intensity correction data, the control signals such as the clock signals and the line sync signals, the driving power of the control circuit, and the driving power of the organic EL elements 63 serving as the light emitting elements, supplied to the exposure device 13 from an external source are relayed to the relay substrate 52 shown in FIG. 3, and then supplied to the glass substrate 50 through the FPC 60.

Reference numeral 63 denotes organic EL elements serving as an exposure light source of the exposure device 13. In the first embodiment, a number (5120) of organic EL elements 63 are aligned in an array configuration in the primary scanning direction with a resolution of 600 dpi, and the lighting and non-lighting of the individual organic EL element 63 is individually controlled by a TFT circuit to be described later.

Reference numeral 61 denotes a source driver supplied as an IC chip which controls the driving of the organic EL elements 63 and is flip-chip mounted on the glass substrate 50. A bare chip component is used as the source driver 61 considering a surface mounting on the glass. The source driver 61 is supplied with power, the control-related signals such as the clock signals and the line sync signals, and 8-bit light intensity correction data from a source external to the exposure device 13 through the FPC 62. The source driver 61 serves as a driving current setting unit of the organic EL elements 63. Specifically, on the basis of the light intensity correction data generated from the controller CPU (not shown) installed in the controller 41 (see FIG. 1 for reference), the source driver 61 serving as the light intensity correcting unit and the light intensity setting unit of the organic EL elements 63 sets the driving current for driving the individual organic EL elements 63. The operation of the source driver 61 based on the light intensity correction data will be described later in detail.

In the glass substrate 50, the source driver 61 is connected to the bonding portion of the FPC 60 through a circuit pattern (not shown) made of an ITO formed with a metal on the surface, for example. The light intensity correction data and the control signals such as the clock signals and the line sync signals are input to the source driver 61 as the driving current setting unit through the FPC 60. In this way, the FPC 60 serving as the interface unit and the source driver 61 serving as the driving parameter setting unit constitute the drive control unit 58.

Reference numeral 62 denotes a TFT circuit formed on the glass substrate 50. The TFT circuit 62 includes a gate controller (not shown) for controlling the lighting and non-lighting timing of the organic EL elements 63, such as shift registers and data latch units, a driving circuit (not shown) (hereinafter referred to as a pixel circuit) for supplying driving current to the individual organic EL elements 63, and a switching circuit (a selection signal generation circuit 140) for turning ON and OFF a light intensity sensor 57 to be described later. The pixel circuits are provided to each of the organic EL elements 63 and are disposed in parallel with the light emitting element array formed by the organic EL elements 63. The values of the driving current for driving the individual organic EL elements 63 are set to the pixel circuit by the source driver 61 serving as the driving parameter setting unit.

The gate controller (not shown) constituting the TFT circuit 62 is supplied with power, the control signal such as the clock signals and the line sync signals, and the 2-valued image data, from a source external to the exposure device 13 through the FPC 60, and controls the lighting and non-lighting of the individual light emitting elements on the basis of the power and the signals. The operations of the gate controller (not shown) and the pixel circuit (not shown) will be described later in detail. Moreover, the configuration of sensors in the TFT circuit 62 will be described later in detail.

Reference numeral 64 denotes a sealed glass. Since the light emission characteristic of the organic EL elements 63 deteriorates drastically due to the influence of moisture such as shrinking of the light emission area with time and generation of unlighted portions (dark spot) in the light emission area, it is necessary to seal the organic EL elements 63 for blocking the moisture. In the first embodiment, since a beta sealing method in which the sealed glass 64 is attached to the glass substrate 50 using an adhesive agent and the sealing area is generally separated by 2000 μm in the secondary scanning direction from the light emitting element array constituted by the organic EL elements 63, a sealing margin of 2000 μm is secured in the first embodiment.

Reference numeral 57 denotes a light intensity sensor formed on a top surface of the organic EL elements 63 shown in FIG. 4(b). The light intensity of the individual organic EL elements 63 is measured by the light intensity sensor 57. As a rule, it is necessary to measure the light intensity of each of the organic EL elements 63 by individually lighting the organic EL elements one by one. However, since the light intensity sensor 57 is sufficiently separated from the organic EL elements 63 serving as an object to be measured, the light intensity sensor 57 is rarely influenced by the individual lighting (i.e., the output light from the organic EL elements 63 is attenuated). Therefore, in the first embodiment, by providing a plurality of light intensity sensors 57, it is possible to measure the light intensity of a plurality of organic EL elements 63 at the same time.

In the first embodiment, the organic EL elements 63, the TFT circuit 62, and the light intensity sensor 57 are integrated as a monolithic device made of poly-silicon. That is, since the light transmittance of low-temperature poly-silicon constituting the TFT circuit 62 is relatively high, it is possible to bury the light intensity sensor 57 corresponding to the individual organic EL elements 63 at a portion adjacent to the TFT circuit 62 even in a so-called bottom emission type organic EL element in which the exposure light is extracted from the glass substrate 50 side. In this case, the light intensity sensor is generally formed on the entire surface immediately below the light emission plane of the organic EL elements 63, but may be formed at a portion of the surface corresponding to the location of the organic EL elements 63. The outputs of the plurality of the light intensity sensors 57 are input to the above-described source driver 61 through wires (not shown). The outputs of the light intensity sensors (light intensity sensor output) are converted to a voltage value by the source driver 61 using a charge accumulation method, amplified with a predetermined amplification factor, and then subjected to an analog-to-digital conversion. The digital data (hereinafter referred to as light intensity measurement data) is output to a destination external to the exposure device 13 through the FPC 60, the relay substrate 52, and the cable 56, which are depicted in FIG. 3. As will be described later in detail, the light intensity measurement data is received and processed by the controller CPU (not shown) installed in the controller 41 (see FIG. 1 for reference), thereby outputting 8-bit light intensity correction data.

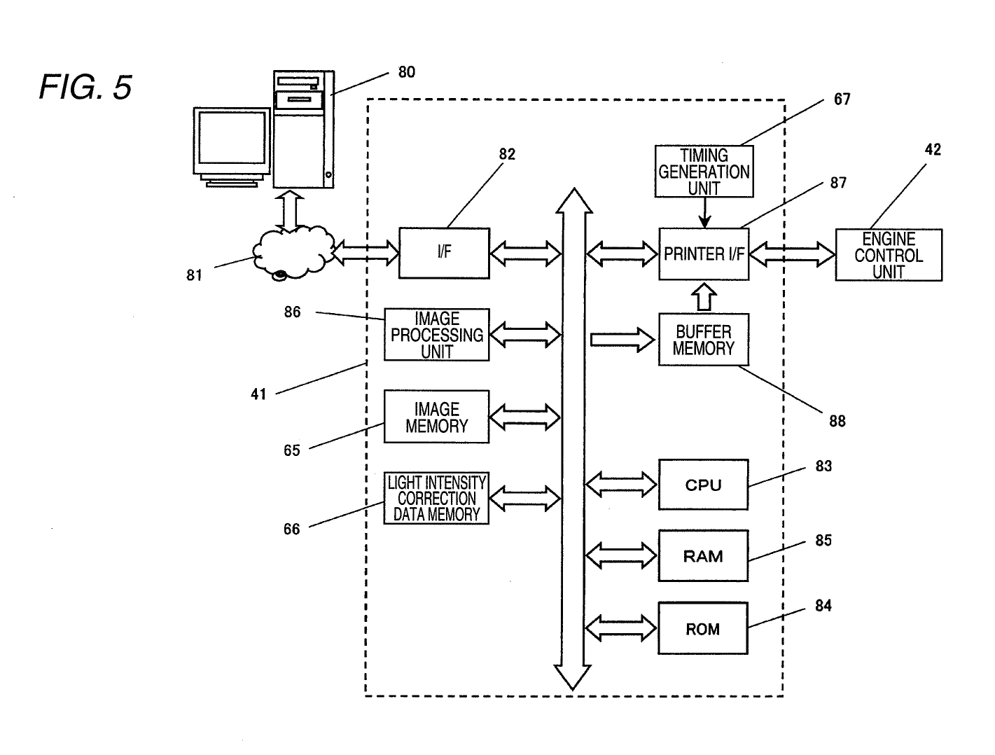

FIG. 5 is a block diagram showing a configuration of the controller 41 of the image forming apparatus 1 in accordance with the first embodiment of the invention. Hereinafter, the operation of the controller 41 and the light intensity correction will be described with reference to FIG. 5.

Reference numeral 80 in FIG. 5 denotes a computer. The computer 80 is connected to a network 81 through which image information and print job information such as the number of pages to be printed and printing modes (for example, color or monochrome) are transmitted to the controller 41. Reference numeral 82 denotes a network interface through which the controller 41 receives the image information or the print job information so as to expand the image information into printable 2-valued image data. Moreover, the controller 41 transmits error information detected by the image forming apparatus as so-called status information to the computer 80 through the network 81.

Reference numeral 83 denotes a controller CPU which controls the operation of the controller 41 in accordance with a program stored in an ROM 84. Reference numeral 85 denotes an RAM which is used as a work area of the controller CPU 83 and in which the image information, the print job information, or the like received through the network interface 82 are temporarily stored.

Reference numeral 86 denotes an image processing unit in which an image processing operation (for example, an image expanding process based on a printer language, a color correction, an edge correction, a screen generation or the like) is performed in units of a page on the basis of the image information and the print job information transmitted from the computer 80 and the printable 2-valued image data is generated. Then, the generated 2-valued image data is stored in the image memory 65 in units of a page.

Reference numeral 66 denotes a light intensity correction data memory constituted by a rewritable nonvolatile memory such as an EEPROM.

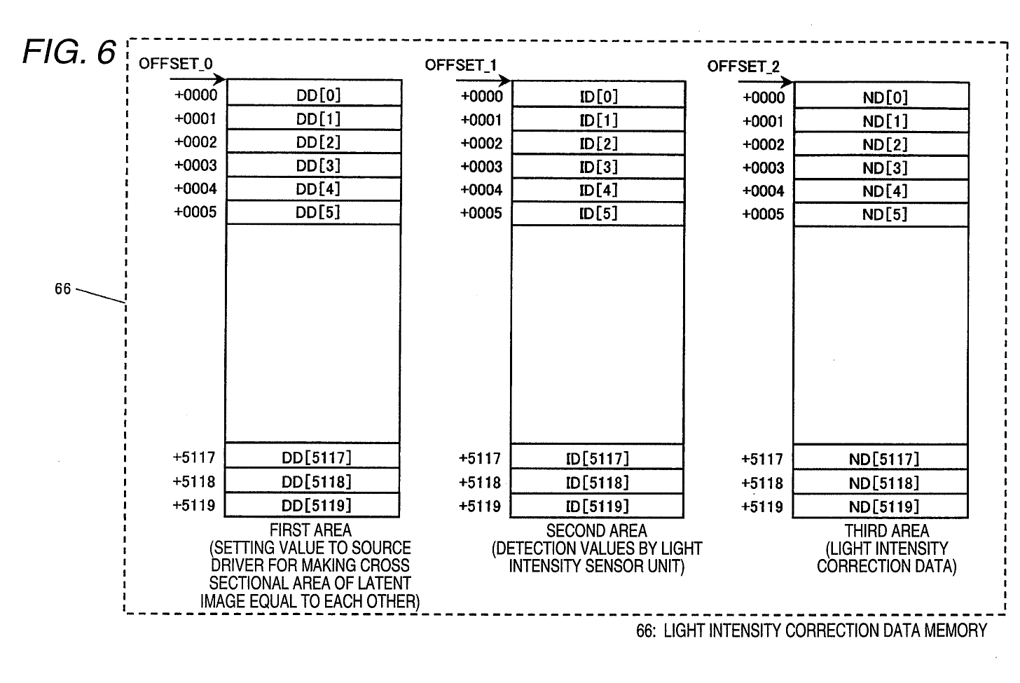

FIG. 6 is an explanatory diagram showing a content of a light intensity data memory of the image forming apparatus 1 in accordance with the first embodiment of the invention.

Next, the structure and content of data stored in the light intensity correction data memory will be described with reference to FIG. 6.

As shown in FIG. 6, the light intensity correction data memory 66 has three areas, i.e., including first to third areas. Each area includes a number (5120) of 8-bit data corresponding the number of organic EL elements 63 (see FIG. 4 for reference) constituting the exposure device 13 (see FIG. 3 for reference) and occupies a total of 15360 bytes.

First, data DD [0] to DD [5119] stored in the first area will be described with reference to FIGS. 3, 4 and 6.

The manufacturing process of the above-described exposure device 13 (see FIG. 3 for reference) includes a process of adjusting the light intensity of the individual organic EL elements 63 (see FIG. 4 for reference) constituting the exposure device 13. In this case, the exposure device 13 is fitted to a certain jig (not shown), and the lighting and non-lighting of the organic EL elements 63 is individually controlled on the basis of the control signals supplied from a source external to the exposure device 13.

Two-dimensional light intensity distribution of the individual organic EL elements 63 is measured at an image forming plane of the photosensitive member 8 (see FIG. 3 for reference) by a CCD camera provided in the jig (not shown). The jig (not shown) calculates the electric potential distribution of the latent image formed on the photosensitive member 8 on the basis of the light intensity distribution and calculates the cross sectional area of the latent image having high correlation with the toner adhering amount on the basis of the actual development condition (the development bias value). The jig (not shown) changes the driving current value for driving the organic EL elements 63 (as described above, the current value for driving the organic EL elements 63 can be set by programming an analog value to the pixel circuit constituting the TFT circuit 62 (see FIG. 4 for reference) using the source driver 61 (see FIG. 4 for reference)) so as to extract the driving current value, i.e., a setting value to the pixel circuit, such that each of the cross sectional areas of the latent images formed by the individual organic EL elements 63 become substantially the same.

When assuming that both the size of the light emission areas of the organic EL elements 63 and the light intensity distributions in the light emission plane are equal to each other and the measurement were performed at a general development condition, the cross sectional area of the latent image is almost proportional to the exposure light intensity. In addition, since “the light intensity at a constant exposure period” and “the exposure light intensity” have the same meaning and the light intensity of the organic EL elements 63 is generally proportional to the driving current value (i.e., the setting value to the pixel circuit), it may be possible to obtain the setting value to the pixel circuit (i.e., the setting data to the source driver 61), making each of the cross sectional areas of the latent images formed by the individual organic EL elements 63 to be equal to each other by a single measurement of the cross sectional area of the individual organic EL elements 63 in a state that the driving current to the entire pixel circuit is set to the same value.

The setting data to the source driver 61 thus obtained is stored in the first area of the light intensity correction data memory 66. As described above, the number of setting data is 5120 equal to the number of organic EL elements 63 constituting the exposure device 13 (i.e., equal to the number of pixel circuits). In this way, “the setting value to the source driver 61 making each of the cross sectional areas of the latent images formed by the individual organic EL elements 63 to be equal to each other in the initial state” is stored in the first area of the light intensity correction data memory 66.

Next, the data ID [0] to ID [5119] stored in the second area will be described with reference to FIGS. 3, 4, and 6.

The jig acquires not only the data stored in the first area, but also acquires the 8-bit light intensity measurement data based on the output of the light intensity sensor 57 (see FIG. 4 for reference) through the source driver 61 (see FIG. 4 for reference) of the exposure device 13. Accordingly, it is possible to acquire “the light intensity measurement data when each of the cross sectional areas of the latent images formed by the individual organic EL elements is made equal to each other in the initial state.” The 8-bit light intensity measurement data ID [n] is stored in the second area.

Here, it is necessary that the driving condition of the organic EL elements 63 when the light intensity measurement data ID [n] is acquired by the jig is equal to that of at the time of measuring the light intensity. Therefore, in the first embodiment, a total of about 30 ms of the lighting and non-lighting period is provided by applying multiple times of 350 μs period corresponding to 1 line period (a raster period) of the image forming apparatus 1.

In this way, in the manufacturing process of the exposure device 13, the data stored in the first and second areas is acquired, and the data is written to the light intensity correction data memory 66 from the jig through an electric communication unit (not shown).

Next, the data ND [0] to ND [5119] stored in the third area will be described with reference to FIGS. 3, 4, 5, and 6.

The image forming apparatus 1 in accordance with the first embodiment of the invention includes a light intensity correction unit (a light intensity correcting unit or the controller CPU 83 (see FIG. 5 for reference)) correcting the light intensity of the organic EL elements 63 to be equal to each other on the basis of the measurement result of the light intensity sensor 57 serving as the light intensity measuring unit, in which the light intensity setting unit (or the controller CPU 83) sets the light intensity of each of the organic EL elements 63 at the time of forming the image on the basis of the output of the light intensity correction unit. The light intensity setting value (i.e., light intensity correction data) of each of the organic EL elements 63 when the image is formed by the controller CPU 83 serving as the light intensity correction unit is stored in the third area.

As described above, in the image forming apparatus 1 of the first embodiment, the light intensity of the organic EL elements 63 constituting the exposure device 13 is measured at a predetermined timing to be described later, such as in the initialization period of the image forming apparatus 1, in a start-up period of the image forming operation, in the inter-paper period, and at the time of completing the image forming operation. The controller CPU 83 generates the light intensity correction data on the basis of the light intensity measurement data measured at these timings, “the setting value to the source driver 61 making each of the cross sectional areas of the latent images formed by the individual organic EL elements 63 to be equal to each other in the initial state” stored in the first area in the manufacturing process of the exposure device 13, and similarly “the light intensity measurement data when each of the cross sectional areas of the latent images formed by the individual organic EL elements 63 is made equal to each other in the initial state” stored in the second area in the manufacturing process of the exposure device 13. That is, the controller CPU 83 functions as the light intensity correcting unit for correcting the light intensity of the organic EL elements 63 with reference to the light intensity of the organic EL elements 63 detected by the light intensity sensor 57.

Hereinafter, the details of computation of the light intensity correction data by the controller CPU 83 will be described, in which it is considered that the light intensity at the time of measuring the light intensity is made equal to that of at the time of forming the image in order to clarify the point of the invention.

Assuming that “the setting value to the source driver 61 making each of the cross sectional areas of the latent images formed by the individual organic EL elements 63 to be equal to each other in the initial state” stored in the first area is DD [n] (wherein, n represent an organic EL element number in the primary scanning direction), “the light intensity measurement data when each of the cross sectional areas of the latent images formed by the individual organic EL elements 63 is made equal to each other in the initial state” stored in the second area is ID [n], and a new light intensity measurement data measured in the initialization operation or the like is PD [n], a new light intensity correction data ND [n] to be written in the third area can be measured by the controller CPU 83 on the basis of Equation 1. Here, the light intensity measurement data ID [n] corresponds to the measured light intensity of the organic EL elements, and the light intensity correction data ND [n] corresponds to the current value flowing through the individual elements, which is set by the source driver 61.

ND [n]=DD [n]×ID [n]/PD [n] [Equation 1]

(where n represents an organic EL element number in the primary scanning direction)

In this way, the generated light intensity correction data ND [n] is written to the third area of the light intensity correction data memory 66 (see FIG. 5 for reference). Thereafter, the light intensity correction data ND [n] is copied from the light intensity correction data memory 66 to a predetermined area of the image memory 65 (see FIG. 5 for reference) prior to the image forming operation. In the image forming operation, the light intensity correction data ND [n] copied to the image memory 65 is temporarily stored in a buffer memory 88 (see FIG. 5 for reference) to be described later together with the 2-valued image data and then output to the engine control unit 43 (see FIG. 5 for reference) through a printer interface 87 (see FIG. 5 for reference).

The light intensity measurement data is converted to a voltage value by the source driver 61 using a charge accumulation method. Although the charge accumulation method is effective in improving an SN ratio, the charge accumulation requires some extent of accumulation period since the magnitude of the output (current value) of the light intensity sensor 57 (see FIG. 4 for reference) is very small, which will be described later.

Next, the description will be continued with reference to FIG. 5.

Reference numeral 88 denotes a buffer memory in which the 2-valued image data stored in the image memory 65 and the above-described light intensity correction data is stored before being transmitted to the engine control unit 42. The buffer memory 88 is composed of a so-called dual port RAM in order to absorb the difference between the transmission speed from the image memory 65 to the buffer memory 88 and the data transmission speed from the buffer memory 88 to the engine control unit 42.

Reference numeral 87 denotes a printer interface through which the 2-valued image data stored to the image memory 65 in units of a page and the light intensity correction data are transmitted to the engine control unit 42 in synchronism with the clock signals and the line sync signals generated by the timing generation unit 67.

FIG. 7 is a block diagram showing a configuration of the engine control unit 42 of the image forming apparatus 1 in accordance with the first embodiment of the invention. Hereinafter, the operation of the engine control unit 42 will be described with reference to FIGS. 1 and 7.

In FIG. 7, reference numeral 90 denotes a controller interface to which the light intensity correction data and the 2-valued image data in units of a page are transmitted from the controller 41.

Reference numeral 91 denotes an engine control CPU which controls the image forming operation of the image forming apparatus 1 on the basis of the program stored in the ROM 92. Reference numeral 93 denotes an RAM which is used as a work area at the time of operating the engine control CPU 91. Reference numeral 94 denotes a rewritable nonvolatile memory such as an EEPROM. Information about lifetime of components such as the rotation period of the photosensitive member 8 of the image forming apparatus 1 and the operation period of the fixing unit 23 (see FIG. 1 for reference) is stored in the nonvolatile memory 94.

Reference numeral 95 denotes a serial interface. Information received from a sensor group such as the recording paper pass detection sensor 21 (see FIG. 1 for reference) and the recording paper rear-end detection sensor 28 (see FIG. 1 for reference) or the output of the power source monitor unit 44 (see FIG. 1 for reference) is converted to a serial signal having a predetermined period by a serial conversion unit (not shown) and then transmitted to the serial interface 95. The serial signal received by the serial interface 95 is converted to a parallel signal and then read to the engine control CPU 91 through a bus 99.

Meanwhile, control-related signals such as start-up and stop signals to the paper feeding roller 18 (see FIG. 1 for reference) and the driving source 38 (see FIG. 1 for reference), control signals to an actuator group 96 such as the electromagnetic clutch (not shown) controlling the transmission of driving force to the feeding roller 18 (see FIG. 1 for reference), and control signals to a high voltage source control unit 97 managing the electric potential settings of such as the development bias, the transfer bias, and the charging potential are transmitted to the serial interface 95 as a parallel signal. In the serial interface 95, the parallel signal is converted to a serial signal and transmitted to the actuator group 96 and the high voltage source control unit 97. In this way, in the first embodiment, the sensor input signals and the actuator control signals that are not required to be detected at high speed are output through the serial interface 95. Meanwhile, the control signals for driving and stopping the registration roller 19 requiring some extent of high-speed operation are directly connected to an output terminal of the engine control CPU 91.

Reference numeral 98 denotes an operation panel connected to the serial interface 95. A user command input to the operation panel 98 is recognized by the engine control CPU 91 through the serial interface 95. Alternatively, the operation panel serving as a command input unit allowing a user to input a command may be provided in the first embodiment, so that the light intensity of the organic EL elements 63 constituting the exposure device 13 is measured and corrected on the basis of the input to the operation panel. The command may be input from an external computer or the like through the controller 41. As a specific example, a case may be considered in which a large amount of images are to be formed on a paper, the user has found an uneven density distribution on the image forming paper, and the user forcibly correct the light intensity, thereby securing the image quality. When the image forming apparatus 1 is in a standby state, the user can instruct to forcibly perform the light intensity correcting operation at any time. Even in the image forming operation, the user can instruct to perform the light intensity correcting operation by putting the image forming apparatus 1 into an off-line mode so as to temporarily holding the image forming operation.

In the end, when a request for correcting the light intensity is input from the operation panel 98 serving as the command input unit or the like, as described above in <Initialization Operation>, the engine control CPU 91 starts driving of components of the image forming apparatus 1 and outputs a creation request of dummy image information for the light intensity correction to the controller 41. Then, the controller CPU 83 installed in the controller 41 generates the dummy image information for the light intensity correction in accordance with the creation request, and the organic EL elements 63 constituting the exposure device 13 is controlled to be lighted or unlighted on the basis of the dummy image information for the light intensity correction. In this case, the light intensity of the individual organic EL elements 63 is detected by the light intensity sensor 57 provided to the exposure device 13, and the light intensity correcting operation is performed on the basis of the light intensity detection result such that the light intensity of the individual organic EL elements 63 becomes equal to each other.

Next, the operation of measuring the light intensity of the organic EL elements 63 will be described with reference to FIGS. 1, 5, 6, and 7.

As described later, although the light intensity correcting operation is performed at various timings such as in the initialization period immediately after the start-up of the image forming apparatus 1, prior to the start of image forming operation, in the inter-paper period, after the start of the image forming operation, and at a user designation timing through the operation panel 98, description will be made only to a case where the light intensity measurement operation is performed at the time of initializing the image forming apparatus 1. Moreover, although the image forming apparatus 1 in accordance with the first embodiment is configured to be able to form a full-color image and has four exposure devices 13Y to 13 K (see FIG. 1 for reference) corresponding to four colors, description will be made only to the operation regarding only one color and the exposure devices will be denoted by the exposure device 13. Moreover, in the following situation, it is assumed that the driving source 38 (see FIG. 1 for reference) and the development station 2 (see FIG. 2 for reference) are already in an activated state as described above in detail in <Initialization Operation>.

In the image forming apparatus 1, since the image forming operation is managed by the engine control unit 42, the light intensity correction operation is activated by the engine control CPU 91 of the engine control unit 42. First, the engine control CPU 91 outputs a creation request of dummy image information different from normal 2-valued image data related to the image formation to the controller 41.

The engine control unit 42 and the controller 41 are connected to each other through a bidirectional serial interface (not shown), and a request command and an acknowledge signal to the request command (response information) are communicated to each other. The creation request of the dummy image information issued by the engine control CPU 91 is output to the controller 41 from the controller interface 90 through the bus 99 using the bidirectional serial interface (not shown).

The controller CPU 83 installed in the controller 41 creates the dummy image information, i.e., the 2-valued image data used in measuring the light intensity and write the information to the image memory 65. The controller CPU 83 reads out “the setting value to the source driver 61 making each of the cross sectional areas of the latent images formed by the individual organic EL elements 63 to be equal to each other in the initial state” DD [n] (n: 0 to 5119) stored in the first area (see FIG. 6 for reference) of the light intensity correction data memory 66 and writes the value to a predetermined area of the image memory 65. After completing these processes, the controller CPU 83 outputs response information to the engine control unit 42 through the printer interface 87.

In this case, the engine control CPU 91 of the engine control unit 42 having received the above-described response information immediately sets a writing timing to the exposure device 13. That is, the engine control CPU 91 sets a writing timing for the exposure device 13 to form the electrostatic latent image to timers as hardware (not shown) and immediately starts the operation of the timer when receiving the response information. This function is provided to determine the start timings of the plurality of exposure devices 13 corresponding to each color. Such a strict timing setting may not be required in the light intensity measuring operation and zero value (0) may be set to each of the timers, for example. The timer outputs an image data transmission request to the controller 41 after a predetermined period. The controller 41 having received the image data transmission request transmits the 2-valued image data to the exposure device 13 through the controller interface 90 in synchronization with the timing signals (clock signals, line sync signals, or the like) generated from the timing generation unit 67. At the same time, the light intensity setting value written to the image memory 65 is transmitted to the exposure device 13 in synchronization with the above-described timing signals.

In this way, the 2-valued image data transmitted in synchronization with the timing signals is input to the TFT circuit 62 of the exposure device 13, and the light intensity setting value is input to the source driver 61 of the exposure device 13. In the exposure device 13, the lighting and non-lighting of the corresponding organic EL element 63 is controlled on the basis of the 2-valued image data, i.e., ON/OFF information. The light intensity of the individual organic EL elements 63 at that moment is measured by the light intensity sensor 57.

In this way, the lighting and non-lighting of the organic EL elements 63 is controlled and the light intensity is measured by the light intensity sensor 57. The output (analog current value) of the light intensity sensor 57 is converted to a voltage value by the source driver 61 using the charge accumulation method, amplified with a predetermined amplification factor, and then subjected to an analog-to-digital conversion. Thereafter, the data is output from the source driver 61 as an 8-bit light intensity measurement data (digital data).

The light intensity measurement data output from the source driver 61 is transmitted to the controller 41 from the engine control unit 42 through the controller interface 90, and received by the controller CPU 83 of the controller 41.

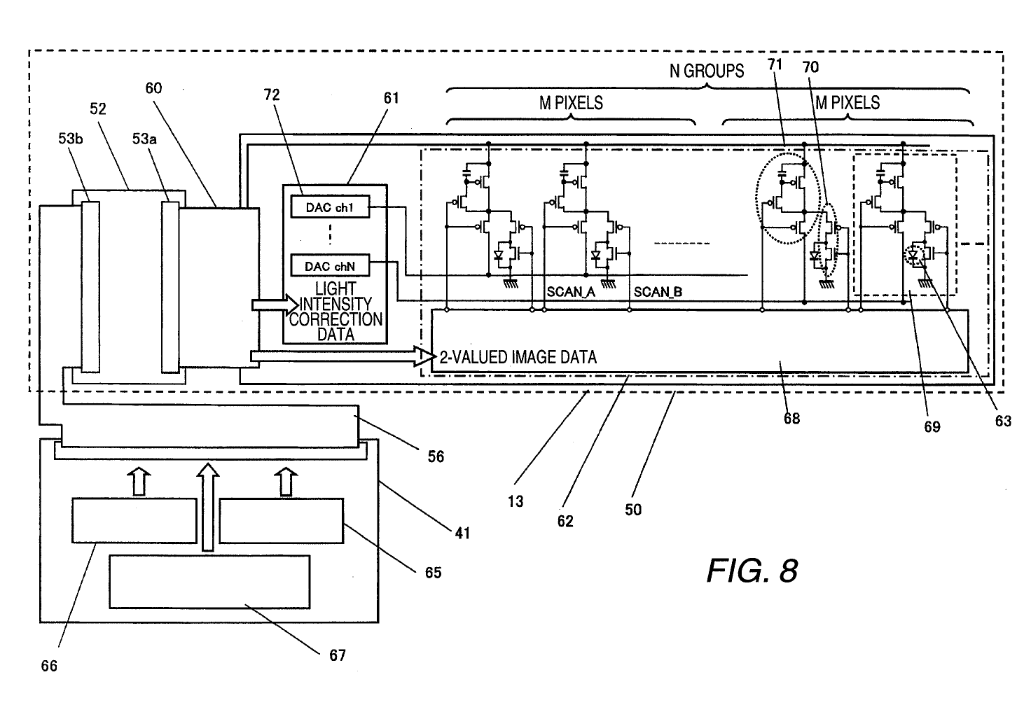

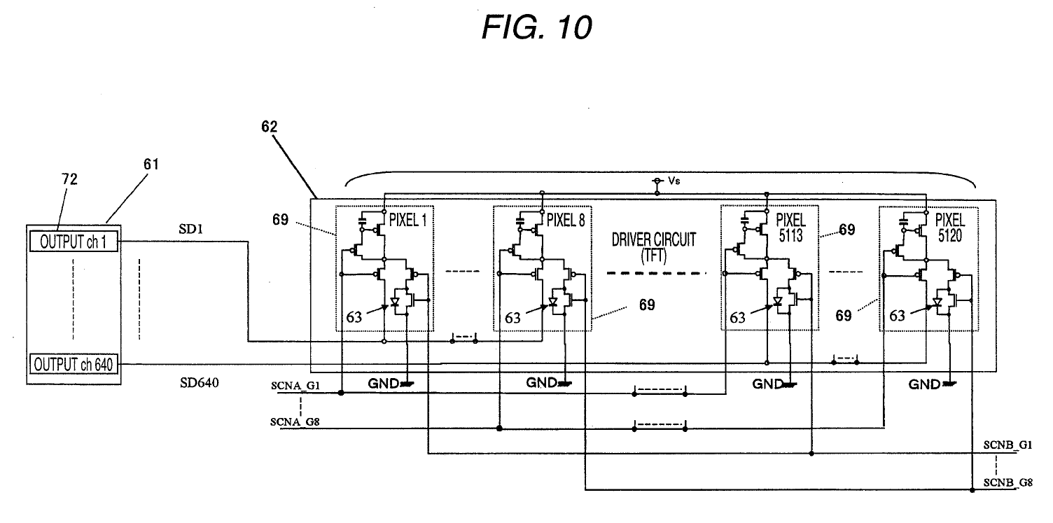

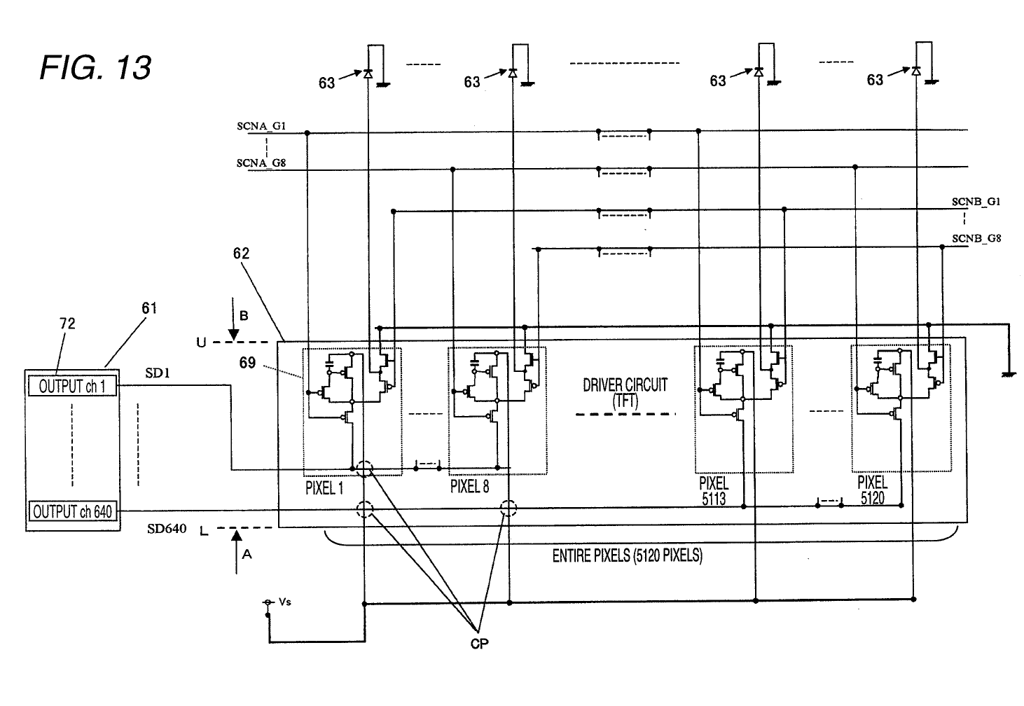

FIG. 8 is a circuit diagram showing the exposure device 13 of the image forming apparatus 1 in accordance with the first embodiment of the invention. Hereinafter, the lighting and non-lighting control using the TFT circuit 62 and the source driver 61 will be described with reference to FIG. 8. In the drawing, the source driver 61 is depicted so as to be disposed at one end in the longitudinal direction (the primary scanning direction) of the TFT circuit 62 in order to simplify the descriptions. However, as shown in FIG. 4, the source driver 61 is actually (physically) disposed substantially at the central portion in the primary scanning direction of the bottom surface of the TFT circuit 62. A similar statement can be applicable to those shown FIGS. 10 and 13, which will be described later.

The TFT circuit 62 is mainly divided into the pixel circuit 69 and the gate controller 68. The pixel circuit 69 is provided to each of the organic EL elements 63, and N groups of the organic EL elements 63 corresponding to M pixels are arranged on the glass substrate 50.

In the first embodiment, a number of organic EL elements 63 corresponding to 8 pixels are provided in one group (i.e., M=8) and the number of groups is 640. Accordingly, the total number of pixels is 5120 (8×640=5120). Each of the pixel circuits 69 includes a driver unit 70 supplying an current to the organic EL elements 63 so as to drive the organic EL elements 63 and a so-called current programming unit 71 for storing the current value (i.e., the driving current value of the organic EL elements 63) supplied from drivers for controlling the lighting and non-lighting of the organic EL elements 63 to a capacitor included therein. The pixel circuit 69 can drive the organic EL elements 63 with a constant current in accordance with the driving current value programmed at a predetermined timing.

FIG. 16 is a timing chart showing an example of a lighting and non-lighting control of the organic EL element 63 in accordance with the first embodiment of the invention.

The gate controller 68 outputs a SCAN_A signal for controlling timings of a current programming period for setting a driving current of the organic EL element 63 and a SCAN_A signal for controlling lighting and non-lighting of the organic EL element 63, on the basis of received signals such as clock signals (not shown).

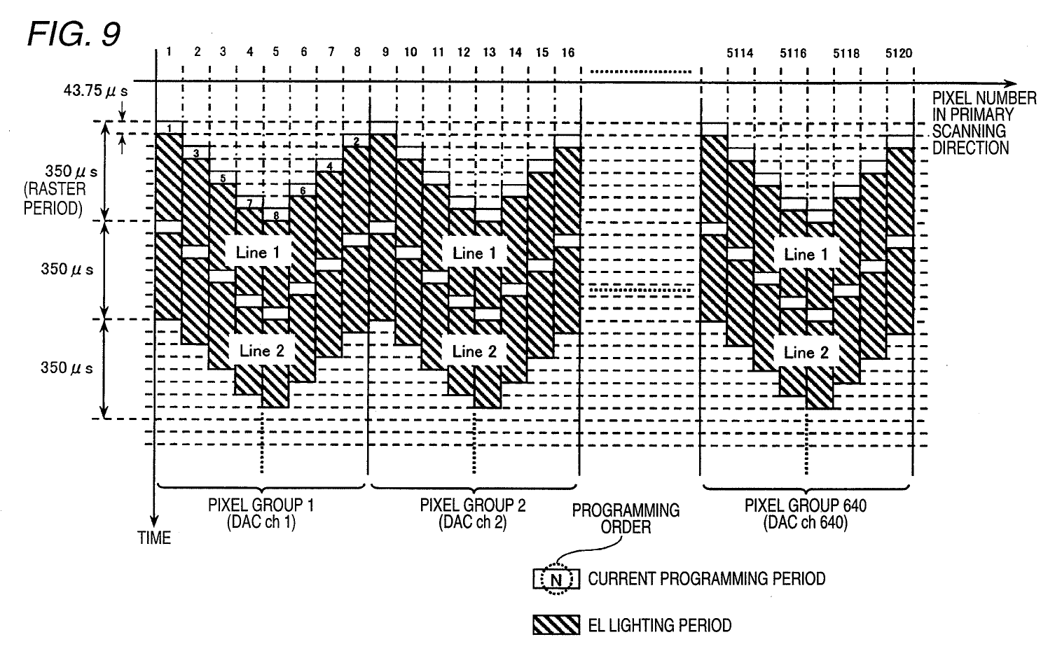

Reference numeral NHSYNC denotes a reference signal representing one line period. As described above, since one group is configured to contain 8 pixels in the first embodiment, in order to perform a programming operation with respect to the 8 pixels in a selective and sequential manner in the one line period using a single output of the source driver 61, the SCAN_A signal is configured to include a total of 8 signals SCNA_G1 to SCNA_G8, and the respective ON timings of the 8 signals are configured not to overlap each other, as shown in FIG. 16. Similar to the case of the SCAN_A signal, the SCAN_B signal is configured to include a total of 8 signals SCNB_M1 to SCNB_M8, and the SCNB_M1 signal is in its ON state during the OFF period of the SCNA_G1 signal (i.e., in periods other than the programming period). Similarly, the signals SCNB_M2 to SCNB_M8 are in their ON states during the OFF period of the SCAN_A signal (i.e., in periods other than the programming period). As will be described later with reference to FIG. 9, the entire light-emitting elements in the exposure device 13 are controlled to be lighted or unlighted by performing the programming operation and the light emission control operation for a predetermined period on the basis of the SCAN_A signal and the SCAN_B signal.

The source driver 61 includes a number of D/A converter 72 corresponding to the number N (640 in the first embodiment) of groups in the organic EL elements 63. The source driver 61 sets the driving current of the individual organic EL elements 63 on the basis of the 8-bit light intensity correction data supplied through the FPC 60.

FIG. 9 is an explanatory diagram showing a current programming period related to the exposure device 13 of the image forming apparatus 1 related to the first embodiment of the invention and a lighting and non-lighting period of the organic EL elements 63. Hereinafter, the lighting and non-lighting control in accordance with the first embodiment will be described in detail with reference to FIGS. 8 and 9. In the following description, a single pixel group composed of 8 pixels (for example, “the pixel number in the primary scanning direction” is 1 to 8 in FIG. 9) will be described in order to simplify the description.

In the first embodiment, one line period (raster period) of the exposure device 13 is set to 350 μs, and ⅛ (43.77 μs) of the one line period is used as the programming period for setting the driving current value to the capacitor provided in the current programming unit 71.

First, the gate controller 68 (see FIG. 8 for reference) sets the SCAN_A signal and the SCAN_B signal for the number 1 pixel to ON and OFF, respectively, so as to set the programming period. In the programming period, the D/A converter 72 installed in the source driver 61 (see FIG. 8 for reference) is supplied with 8-bit light intensity correction data, and the capacitor in the current programming unit 71 (see FIG. 8 for reference) is charged by the analog level signal obtained by D/A converting the digital data. In this way, the analog value of the electric current to be supplied to the organic EL element 63 in accordance with the image data is written to the capacitor formed in the current programming unit 71 at every one line period.

When the programming period expires, the gate controller 68 (see FIG. 8 for reference) immediately switches the SCAN_A signal and the SCAN_B signal to OFF and ON states, respectively, so as to set the lighting and non-lighting period. When the image data is in its OFF state, in order to put the organic EL element 63 in its unlighted state, data supplied to the D/A converter 72 is set so that the output current of the source driver 61 becomes zero (0), and the current programming operation is performed in this state. Since the value of the current supplied to the organic EL element 63 can be controlled to be zero (0) by the programming operation, current does not flow through the organic EL element 63 even in the ON state of the SCAN_B signal. Therefore, the organic EL element 63 does not emit light.

Meanwhile, when the image data is in the ON state, an analog value based on 8-bit light intensity correction data is set to the D/A converter 72, and the current programming operation of supplying the output current of the source driver 61 to the organic EL element 63 is performed. Thereafter, when the SCAN_A signal and the SCAN_B signal are respectively switched to OFF and ON states, the organic EL element 63 is lighted for the remaining period 306.25 μs (306.25=350−43.75). However, since it takes a little time to switch the control signals, the lighted period is a little decreased. As described above, in the first embodiment, since it is assumed that it takes 30 ms to measure the light intensity of the organic EL elements 63, the controller 41 generates the dummy image information so that the number of lightings in the light intensity measuring operation becomes 100 (i.e., 100 lines), for example.

Meanwhile, in FIG. 9, when the programming period for the pixel circuit 69 (see FIG. 8 for reference) corresponding the number 1 pixel expires, the gate controller 68 (see FIG. 8 for reference) immediately sets the current programming period for the pixel circuit 69 (see FIG. 8 for reference) corresponding to the number 8 pixel. In a similar sequence to that of the pixel circuit corresponding to the number 1 pixel, when the programming period for the pixel circuit corresponding to the number 8 pixel expires, an operation of setting the lighting period of the organic EL elements 63 (see FIG. 8 for reference) corresponding to the pixel number is performed.

In this way, the gate controller 68 (see FIG. 8 for reference) sets the programming period and the lighting period in the order of the pixel number in the primary scanning direction, i.e., “1→8→2→7→3→6→4→5→1 . . . .” By setting the lighting order in such a manner, the lighting timings of pixels disposed adjacent to each other in pixel groups adjacent to each other become close to each other in time and it is thus possible to make uneven display of image less prominent at the time of forming one line of image.

In the current programming period which is controllable by the gate controller 68 (see FIG. 8 for reference), an electric current value corresponding to the light intensity data is supplied to the pixel circuit 69 (see FIG. 8 for reference), and a capacitor in the pixel circuit 69 (see FIG. 9 for reference) is charged by a so-called constant current source. In this case, the time required for the charging can be calculated from Equation 2.

t=C×V/i [Equation 2]

(C represents an electrostatic capacitance, V represents an electric potential, and i represents a supplied current)

According to Equation 2, the charging time is proportional to the electrostatic capacitance and increases as the electrostatic capacitance C increases with an increase in the wire capacitance accompanied by a wire drawing operation. Actually, a waveform of the charging voltage at which the charging time is determined has a dull component depending on the time constant due to the wire resistance. Therefore, the charging waveform becomes a summation of a substantially straight line portion where the waveform changes in a constant current manner and a first-order curve portion where the waveform changes in a constant voltage manner. That is, although such a charging delay is not directly expressed in Equation 2, in fact, the charging dealy is also influenced by the wire resistance.

<Configuration of EL Element Driving Circuit>

Next, a configuration of an EL element driving circuit which is the subject matter of the invention will be described in detail. The invention has been made to decrease the wire capacitance of programming signal lines by investigating into the configuration of the EL element driving device including the EL element driving circuit, and more particularly, into the structure of the signal lines as a part of the driving circuit. With such an investigation, it is possible to decrease the programming period and realize a further increase in an image forming speed and a printing speed of the image forming apparatus.

FIG. 10 is an explanatory diagram showing a connection relationship between the source driver 61 and the TFT circuit 62 in accordance with the first embodiment of the invention.

In FIG. 10, the TFT circuit 62 (excluding the gate controller 68) and the source driver 61 shown in FIG. 8 are depicted in more detail. In the invention, the whole TFT circuit 62 is referred to as the “driver circuit,” and the pixel circuit 69 which is a minimum circuit unit for driving the EL elements 63 is also referred to as the “driver circuit”. As a matter of convenience, the pixel circuits 69 may be referred to as “driving elements 69,” and will be referred by the name of the “driving elements” hereinafter. The driving elements 69 are aligned substantially in a straight line in the TFT circuit 62.

One output of the source driver 61 is responsible for programming 8 pixels. The light emission control signal line (SCNB_G*) output from the gate controller 68 shown in FIG. 8 is configurd to input a total of 8 signals to the driving elements of each pixel so as to turn ON and OFF the driving elements with a predetermined timing in accordance with image data of each pixel. In this manner, the programming is performed to the entire pixels on a line-by-line basis so that the pixels are controlled to be lighted or unlighted. In this case, the SCNB_G* shown in FIG. 10 is related to the SCAN_B show in FIG. 8. Meanwhile, the SCNA_G* shown in FIG. 10 is a programming control signal line and is related to the SCAN_A shown in FIG. 8. The source driver 61 is mounted with a number (640) of D/A converters 72, and a total of 640 source driver signal lines are connected to the TFT circuit 62. That is, the SCNB_G* and SCNA_G* lines are formed into an electrically active matrix structure, and the EL element driving circuit is also formed into an active matrix-type driving circuit.

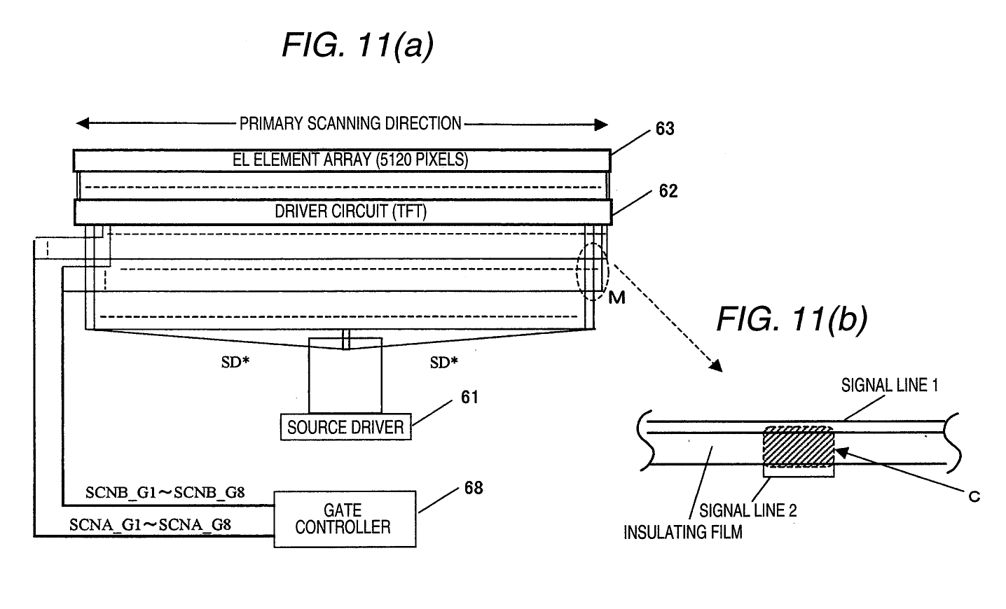

FIG. 11 is a schematic diagram for explaining a problem that may be caused at the time of laying out various signal lines of the driver circuit in accordance with the first embodiment of the invention.

As shown in FIGS. 10 and 11(a), the source driver signal line SD*, the light emission control signal line SCNB_G*, and the programming control signal line SCNA_G* are respectively arranged in the main scanning direction of the exposure device (i.e., in the arrangement direction of the organic EL element 63). The driver signal line SD* is connected to the source driver (external IC circuit) 61 and serves to input a driving current for driving the organic EL element 63 to the source driver 61. The light emission control signal line SCNB_G* is used to control an ON and OFF of the organic EL element 63. Specifically, the light emission control signal line is used to control the operation of the driving element 69 in order to control the organic EL element 63. The programming control signal line SCNA_G* is used to set the driving current. Specifically, the programming control signal line is used to set the driving current of the driving element 69 as a driving condition of the organic EL element 63.

In such a configuration, as shown in FIG. 11(b) which is an enlarged view of the M part shown in FIG. 11(a), at least two of the above-mentioned three signal lines may inevitably cross each other and thus generate a crosspoint. FIG. 11(b) shown a state where a signal line 1 (for example, the source driver signal line) extends in a lateral direction and a signal line 2 (for example, the light emission control signal line) extends in a depth direction. To prevent electrical connection between both signal lines, an insulating film is formed between both signal lines. At such a crosspoint, a pseudo-capacitance component (a pseudo-capacitor) may be generated in an area such as a shadowed portion C. An increase in the pseudo-capacitance component may cause an increase in the programming period of individual driver circuits.

In addition to such a problem, it is a well-known fact that the wire resistance of the signal lines depends on the length, width, or the like of the wire. Such an increase in the wire resistance may also cause an increase in the programming period.

The invention aims to decrease a programming period and realize a further increase in an image forming speed and a printing speed of an image forming apparatus by decreasing the above-described capacitance component and wire resistance. Hereinafter, various examples to which the invention is applied will be described. A light-emitting element driving device for driving light-emitting elements is obtained by forming the TFT circuit 62 and various signal lines on the glass substrate 50.

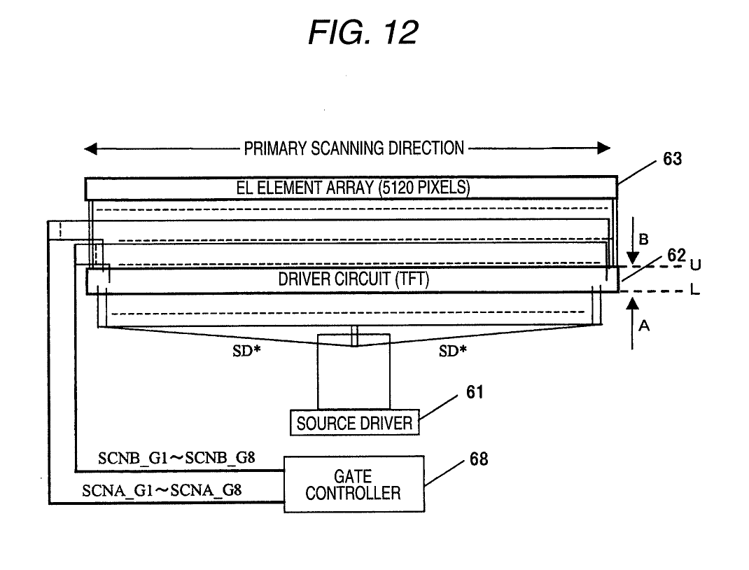

FIG. 12 is a diagram showing a layout of signal lines in the light-emitting element driving device in accordance with the first embodiment of the invention.

FIG. 13 is an explanatory diagram showing a relationship between the TFT circuit and the source driver 61 in accordance with the first embodiment of the invention.

In FIGS. 12 and 13, the signal line (the source driver signal line SD*) of the source driver 61 and the signal line (the light emission control signal line SCNB_G* and the programming control signal line SCNA_G*) connected from the gate controller 68 are connected from different directions to the TFT circuit 62. The source driver signal line SD*, the light emission control signal line SCNB_G*, and the programming control signal line SCNA_G* constitute a first to third signal line group, respectively.

As shown in the drawing, the source driver signal line SD* is connected to the TFT circuit 62 from the lower end portion L of the TFT circuit 62 (in the A direction). Meanwhile, the light emission control signal line SCNB_G* and the programming control signal line SCNA_G* are connected to the TFT circuit 62 from the upper end portion U of the TFT circuit 62 (in the B direction). With such a configuration, it is possible to decrease the number of crosspoints of the source driver signal line SD* and the light emission control signal line SCNB_G* and the number of crosspoints of source driver signal line SD* and the programming control signal line SCNA_G*, thereby decreasing the entire capacitance components in the driver circuit.

Particularly in the first embodiment, two signal line, i.e., the source driver signal line SD* (a first signal line) and the light emission control signal line SCNB_G* (a second signal line) or the programming control signal line SCNA_G* (a third signal line) are connected to each driving element 69 from two end portions (i.e., the upper and lower end portions opposing to each other) of the TFT circuit 62. That is, since two signal lines are connected to the driver circuit from opposite directions, it is possible to prevent generation of the capacitance component in a more secured manner.

The signal supplied to the driving element 69 through the source driver signal line SD* is an analog level signal that is converted from the light intensity data or the gradation data, and it is thus necessary to reflect original bit resolution precisely on the analog level signal. Therefore, it is necessary to perform the wire drawing operation in consideration of an influence of extraneous noise and electrostatic capacitance. In the above-described configuration, since the source driver signal line SD* does not have its crosspoints between the light emission control signal line SCNB_G* and the programming control signal line SCNA_G*, the analog level signal supplied through the source driver signal line SD* is not influenced by the extraneous noise and electrostatic capacitance.

Meanwhile, the light emission control signal line SCNB_G* and the programming control signal line SCNA_G* cross each other to form a crosspoint (see FIG. 13 for reference). However, since these signal lines are used to transmit a digital signal, the influence of the electrostatic capacitance at the crosspoint is very little.

The light emission control signal line SCNB_G* and the programming control signal line SCNA_G* cross the wire (an ITO) connecting the driving element 69 and the organic EL element 63 with each other (see FIG. 13 for reference). Although the signal (driving current) for driving the organic EL element 63 is the analog level signal, the driving current is remarkably greater than the current flowing through the light emission control signal line SCNB_G* and the programming control signal line SCNA_G*. Even when the light emission control signal line SCNB_G* and the programming control signal line SCNA_G* have their crosspoint, the driving current for driving the organic EL element 63 is rarely influenced by the crosspoint.

As can be seen from FIGS. 12 and 13, the light-emitting element driving device in accordance with the first embodiment includes a light-emitting element array including a plurality of light-emitting elements (the organic EL elements 63), a driver circuit (the TFT circuit 62) including driving elements 69 aligned along the light-emitting element array and provided in one-to-one correspondence to the plurality of light-emitting elements, signal lines (SCNA_G* and SCNB_G*) connected to the driving elements 69 so as to control operations of the driving elements 69, in which the signal lines are disposed between the light-emitting element array and the driver circuit.

When such a configuration is viewed from a single organic EL element 63, the light-emitting element driving device in accordance with the first embodiment may be expressed as a light-emitting element driving device which include a light-emitting element (the organic EL element 63), a driving element 69 for driving the light-emitting element, and a signal line for controlling an operation of the driving element, in which the signal line is disposed between the light-emitting element and the driving element.

As a result, the source driver signal line SD* extending from the source driver 61 is separated from the organic EL element 63 with the TFT circuit 62 being disposed therebetween. With such a configuration, it is possible to prevent interference between the driving current of the organic EL element 63 and the current flowing through the source driver signal line SD* in an efficient manner.

In the first embodiment, as can be seen from FIGS. 12 and 13, the organic EL elements 63 are separated from each other in a direction away from the TFT circuit 62, rather than toward the TFT circuit 62 (in a direction crossing the arrangement direction (the main scanning direction) of the elements, i.e., in the secondary scanning direction). That is, the light emission control signal line SCNB_G* (the second signal line) or the programming control signal line SCNA_G* (the third signal line) is disposed between the organic EL element array including a plurality of organic EL elements 63 and the TFT circuit 62. With such an arrangement, it is possible to prevent both signal lines from crossing each other. Such an arrangement may be realized by forming the organic EL element 63 on a substrate (not shown)separated from the substrate of the TFT circuit 62.

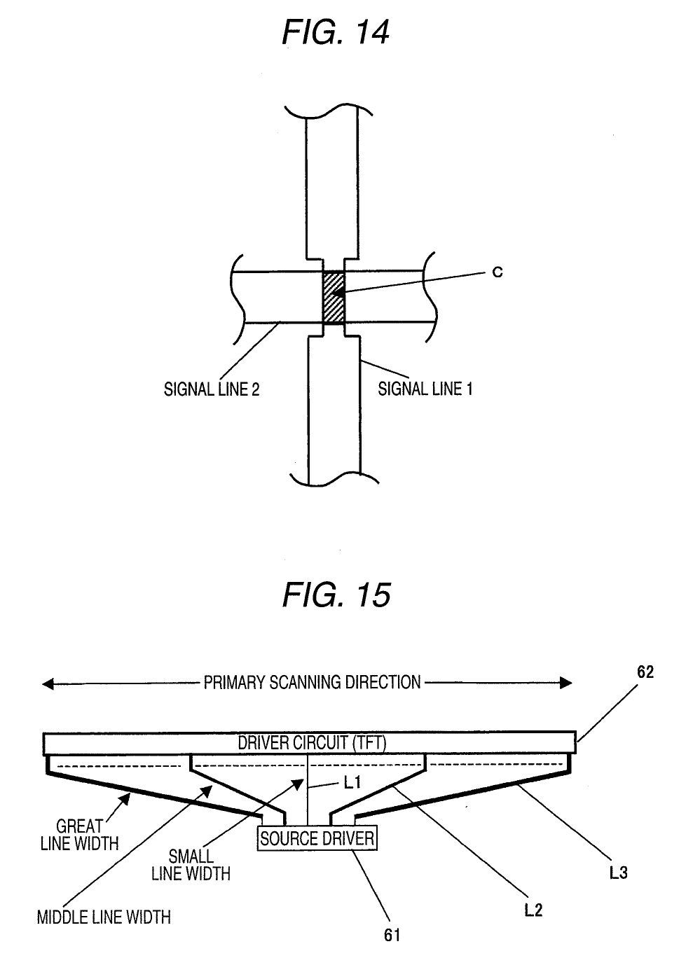

FIG. 14 is a top plan view of a peripheral configuration at a crosspoint of the signal lines in accordance with the first embodiment of the invention.

FIG. 14 shows a peripheral configuration at a crosspoint of a signal line 1 and a signal line 2, in which the wire width (line width) of the signal line 1 is set to be smaller than that of other portions (excluding the crosspoint portion) of the signal line 1. In other words, the line width of at least one signal line at the crosspoint is set to be smaller than that of other portions before and after the crosspoint. Accordingly, in the wiring method shown in FIG. 11(a), it is possible to decrease the size of the crosspoint of two signal lines, thereby decreasing the capacitance component.

In this case, the two signal lines may be arbitrarily selected from the source driver signal line SD*, the light emission control signal line SCNB_G*, and the programming control signal line SCNA_G*. At the crosspoint, the line width (wire width) of both the signal line 1 and the signal line 2 may be set to be smaller than that of at other portions. In this case, the capacitance component may be further decreased.

However, when the line width of the signal line is excessively decreased, the wire resistance and the programming period may increase. Therefore, it is desirable to determine the line width of the signal line at the crosspoint from the viewpoint of decreasing both the capacitance component and the wire resistance.

In addition, such a method of decreasing the line width at the crosspoint may be applied to the wiring method described with reference to FIG. 12. As described above, in the configuration shown in FIG. 12, since the source driver signal line SD* does not cross the light emission control signal line SCNB_G* or the programming control signal line SCNA_G*, they do not generate any crosspoint. However, in addition to the above-described signal lines, other types of lines (not shown) such as a power supply line or a ground line are also laied out on the driver circuit 62. For example, as shown in FIG. 13, a crosspoint CP may be generated between the power supply line Vs and the source driver signal line SD*. By applying the configuration shown in FIG. 14 to the crosspoint of the source driver signal line SD* and the other types of lines, it is possible to decrease the capacitance component.

FIG. 15 is an explanatory diagram showing a configuration of the source driver signal line SD* in accordance with the first embodiment of the invention.

In general, the wire resistance of a signal line increases as the distance thereof (wire length) from a signal source, i.e., from the source driver 61 increases. For example, as shown in FIG. 15, when the source driver 61 is positioned at the central portion in the primary scanning direction of the TFT circuit 62, the wire length and wire resistance of the signal line (the source driver signal line) at the end portion in the primary scanning direction of the TFT circuit 62 is greater than that of at the central portion. Therefore, the programming period of pixels at the end portion is greater than that of at the central portion. That is, the maximum value of the programming period determines the overall performance (an image forming speed) of a print head.

As shown in FIG. 15, the first embodiment is configured such that the line width of the signal line having a greater wire length (i.e., the line width of the signal line for pixels at the end portion) is set to be greater than that of having a smaller wire length (i.e., that of at the central portion) (line width: L1<L2<L3). With such a configuration, it is possible to further uniformize the wire resistance of the source driver signal line SD* in the print head, thereby realizing a decrease in the programming period.

In the drawing, for example, FIG. 8, the source driver 61 is positioned at the side portion (left side) in the primary scanning direction of the TFT circuit 62, rather than at the central portion thereof. In this case, the line width of the signal line for the driving element 69 having a greater distance from the source driver 61 is set to be greater than that for the driving element 69 having a smaller distance.

As described above, according to the invention, it is possible to cope up with a further increase in an image forming speed and a printing speed.

In particular, in the configuration shown in FIG. 13, the light emission control signal line SCNB_G* output from the gate controller 68 is configurd to input a total of 8 signals to the driving elements of each pixel so that the same light emission control signal is input to the driving elements for each 8 pixels, and to turn ON and OFF the driving elements with a predetermined timing regardless of the image data of each pixel. In this manner, the programming is performed to the entire pixels on a line-by-line basis so that the pixels are controlled to be lighted or unlighted.

When the same SCAN_B signal (SCNB_G*) is used in each of a predetermined group, it is necessary to perform a charging and discharging operation of a programming electric potential V in accordance with ON and OFF of the image data. Therefore, it is considered that the charging time is greatly influenced by the paracitic capacitance between source signal lines and the wire length from the source driver. Accordingly, it is considered that the first embodiment is advantageously applicable to such a driving control. The above-described technical aspects such as the wire drawing operation, the line width setting at the crosspoint, the line width determination based on the wire length may be solely applied to the invention, or two or more technical aspects are combined and applied to the invention.

In the first embodiment, a so-called current-controlled method in which a current value for driving the light-emitting element is set (current-programmed) to the capacitor of the driving element 69 has been exemplified. However, the invention may be applied to a so-called voltage-controlled method in which the circuit configuration of the driving element 69 is modified so as to set (voltage-program) a voltage value for driving the light-emitting element.

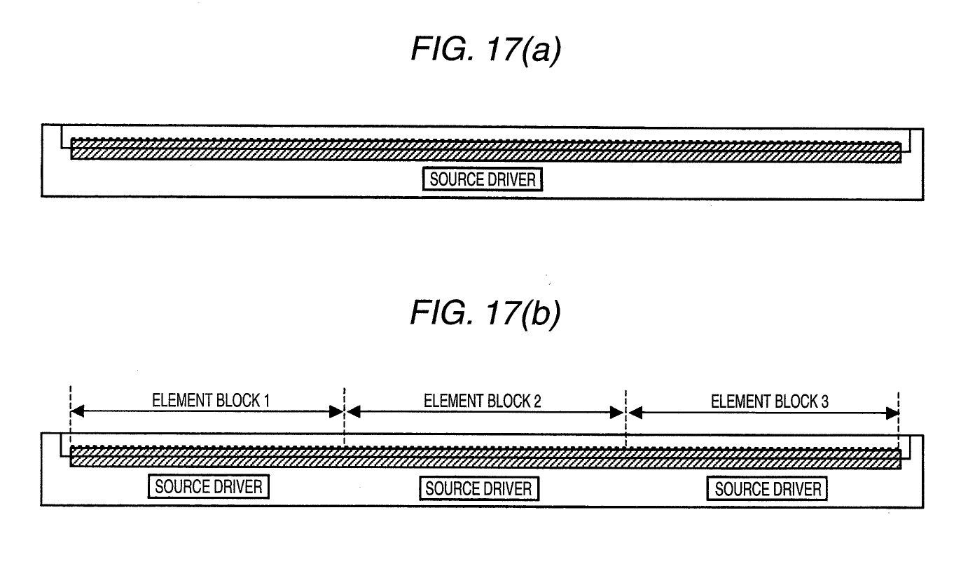

FIG. 17 is an explanatory diagram showing a layout example of the source driver in accordance with the first embodiment of the invention.

In the first embodiment, as described above with reference to FIG. 4, the source driver 61 is disposed at a lower portion (or an upper portion when viewed from different angle) of the TFT circuit and the EL element for convenience of wiring.

In FIG. 17(a) which shows a schematic view of the same example as that shown in FIG. 4, the source driver 61 is positioned substantially at the central portion (substantially at the central portion of the EL element array) in the primary scanning direction of the lower portion of the TFT circuit 62. In other words, it is desirable to dispose the source driver with such a relative positional relationship with the TFT circuit 61 that the source driver 61 is positioned substantially at the central portion of the EL element array.

The above example corresponds to a case where there is one source driver 61. The example shown in FIG. 17(b) corresponds to a case where there are a plurality of source drivers 61. In this case, it is desirable to dispose each of the source drivers so as to be positioned substantially at the central portion of each element block obtained by dividing the EL element array into element blocks corresponding to the number of source drivers. In the example shown in FIG. 17(b), three source drivers 61 are disposed so that each of the source drivers is positioned substantially at the central portion of each of three element blocks 1 to 3.

The first embodiment includes the following aspects.

A light-emitting element driving device in accordance with an aspect of the first embodiment includes a light-emitting element array including a plurality of light-emitting elements, a driver circuit including a plurality of driving elements aligned along the light-emitting element array so as to drive the plurality of light-emitting elements, and signal lines connected to the driving elements so as to control operations of the driving elements, in which the signal lines are disposed between the light-emitting element array and the driver circuit. With such a configuration, it is possible to decrease the number of crosspoints between a plurality kinds of signal lines and eliminate the effect of electrostatic capacitance at the crosspoints. Accordingly, it is possible to decrease the time required for a programming operation of programming a driving condition of a light-emitting element on the basis of an analog level signal, thereby enabling to control the light-emitting element at a high speed.

A light-emitting element driving device in accordance with another aspect of the first embodiment includes a light-emitting element, a driving element for driving the light-emitting element, and a signal line connected to the driving element so as to control an operation of the driving element, in which the signal line is disposed between the light-emitting element and the driving element. With such a configuration, it is possible to decrease the number of crosspoints between a plurality kinds of signal lines and eliminate the effect of electrostatic capacitance at the crosspoints. Accordingly, it is possible to decrease the time required for a programming operation of programming a driving condition of a light-emitting element on the basis of an analog level signal, thereby enabling to control the light-emitting element at a high speed.

In the light-emitting element driving device in accordance with the above aspects of the first embodiment, at a crosspoint of the signal lines and at least one of the power supply line and the ground line, it is desirable that a line width of at least one of the signal lines and the power supply line, or a line width of at least one of the signal lines and the ground line be set to be smaller than that of at the other portions other than the crosspoint. Accordingly, it is possible to further eliminate the effect of electrostatic capacitance at the crosspoints.

In the light-emitting element driving device in accordance with the above aspects of the first embodiment, it is desirable that the signal lines be set to a greater line width as the distance thereof from a signal source increases. With such a configuration, it is possible to uniformize the wire resistance and substantially speed up the driving speed of the light-emitting element.

A light-emitting element driving device in accordance with a further aspect of the first embodiment is a light-emitting element driving device which drives a plurality of light-emitting elements. The light-emitting element driving device includes a driving circuit board on which a driver circuit including a plurality of driving element including the light-emitting elements, a plurality of first signal lines connected to the driving elements so as to input a first signal to the driving elements, and a plurality of second signal lines connected to the driving elements so as to input a second signal to the driving elements, in which the first signal lines and the second signal lines are connected to the driver circuit from different directions when viewed from the driver circuit.

In the light-emitting element driving device in accordance with the above aspects of the first embodiment, two signal lines are connected to the driver circuit from different directions when viewed from the driver circuit. Therefore, such signal lines do not cross each other. Accordingly, it is possible to reduce a capacitance component that may be generated between the signal lines and decrease the programming period, thereby realizing a high-speed operation of an image forming apparatus.

In addition, it is possible to configure the light-emitting element driving device such that the first signal lines and the second signal lines are connected to the driving elements from end portions in opposite directions of the driver circuit. Since, the two signal lines are connected to the driver circuit from opposite directions, it is possible to suppress generation of the capacitance component in a more secured manner.

In the light-emitting element driving device in accordance with the above aspects of the first embodiment, it is desirable that the light-emitting element driving device further includes a power supply line and a ground line connected to the driver circuit so as to supply current from a power source to the driver circuit, and that at a crosspoint of the first signal lines and at least one of the power supply line and the ground line, a line width of at least one of the first signal lines and the power supply line, or a line width of at least one of the first signal lines and the ground line be set to be smaller than that of at the other portions other than the crosspoint. With such a configuration, it is possible to achieve the same advantage as those obtainable from the above-described configuration.

In addition, at least one of the plurality of first signal lines and the plurality of second signal lines may be set to a greater line width as the distance thereof from a signal source increases. In this case, the wire resistance in unit length of the signal lines decreases as the length of the signal lines increases. Even when the length of the signal lines is different from each other, it is possible to uniformize the wire resistance of the entire signal lines, thereby decreasing the programming period.

In addition, the light-emitting element driving device may further include a plurality of third signal lines connected to the driving elements so as to input a third signal to the driving elements, and the third signal lines may be connected to the driver circuit from the same direction as the connection direction of the first or second signal lines. For example, in this case, the first signal lines may be driver signal lines connected to an external IC circuit so as to input a driving current or a driving voltage to the light-emitting elements, and either one of the second and third signal lines may be used as light emission control signal lines for controlling ON and OFF of the light-emitting elements or as programming control lines for setting the driving current or the driving voltage.

In addition, it is desirable that the IC circuit is provided to the driver circuit with a relative positional relationship that the IC circuit is positioned substantially at the central portion of the light-emitting element array including the plurality of light-emitting elements. In addition, when a plurality of the IC circuits are provided, it is desirable that the plurality of IC circuits are provided with such a relative positional relationship with the driver circuit that each of the plurality of IC circuits is positioned substantially at the central portion of each element block obtained by dividing the light-emitting element array including the plurality of light-emitting elements into element blocks corresponding to the number of IC circuits.

In addition, it is desirable that the driving circuit board is configured with a glass substrate and the driver circuit is configured as a TFT circuit formed on the glass substrate. Since the TFT circuit can be manufactured by mass production at a low cost, it is possible to provide the light-emitting element driving device at a low cost in applications such as an exposure device which has an elongated substrate.

When the driving elements are aligned substantially in a straight line on the driving circuit board, a probability of the signal lines crossing each other is decreased. Accordingly, the first embodiment becomes more advantageous.

A light-emitting element driving device in accordance with a still further aspect of the first embodiment is a light-emitting element driving device which drives a plurality of light-emitting elements. The light-emitting element driving device includes a plurality of light-emitting elements, a driving circuit board on which a driver circuit including a plurality of driving element including the light-emitting elements, a plurality of first signal lines connected to the driving elements so as to input a first signal to the driving elements, and a plurality of second signal lines connected to the driving elements so as to input a second signal to the driving elements, in which at a crosspoint of the first signal lines and the second signal lines, a line width of at least one of the first signal lines and the second signal lines is set to be smaller than that of at the other portions other than the crosspoint.

In the light-emitting element driving device in accordance with the above aspects of the first embodiment, at a crosspoint of two signal lines, the line width of at least one of the two signal lines is set to be smaller than that of at the other portions other than the crosspoint. Accordingly, it is possible to reduce a capacitance component that may be generated between the signal lines and decrease the programming period, thereby realizing a high-speed operation of an image forming apparatus.

A light-emitting element driving device in accordance with another still further aspect of the first embodiment is a light-emitting element driving device with an electrically active matrix structure. The light-emitting element driving device includes a plurality of light-emitting elements, driving elements provided in correspondence to the light-emitting elements so as to drive the light-emitting elements, first signal lines for setting driving conditions of the light-emitting elements to the driving elements, and second signal lines for controlling operations of the driving elements, in which the first and second signal lines are configured not to cross each other.

In the light-emitting element driving device in accordance with the entire aspects of the first embodiment, an organic EL element may be used as the light-emitting element. In addition, the light-emitting element driving device in accordance with the first embodiment is desirably applicable to an image forming apparatus.

### Second Embodiment

Hereinafter, a light-emitting element driving device in accordance with a second embodiment of the invention will be described in detail.

The configuration of the image forming apparatus 1 to which the light-emitting element driving device in accordance with the second embodiment of the invention is applied and the configuration of the exposure devie 13 have beend described in detail in connection with the first embodiment, and thus descriptions thereof will be omitted.

The second embodiment of the invention has been made by investigating into the light emission control of the organic EL element 63 as the light-emitting element. With such an investigation, it is possible to decrease the programming period and realize a further increase in an image forming speed and a printing speed of the image forming apparatus 1.

The third embodiment of the invention can be applicable to other types of light-emitting elements as well as the organic EL element.

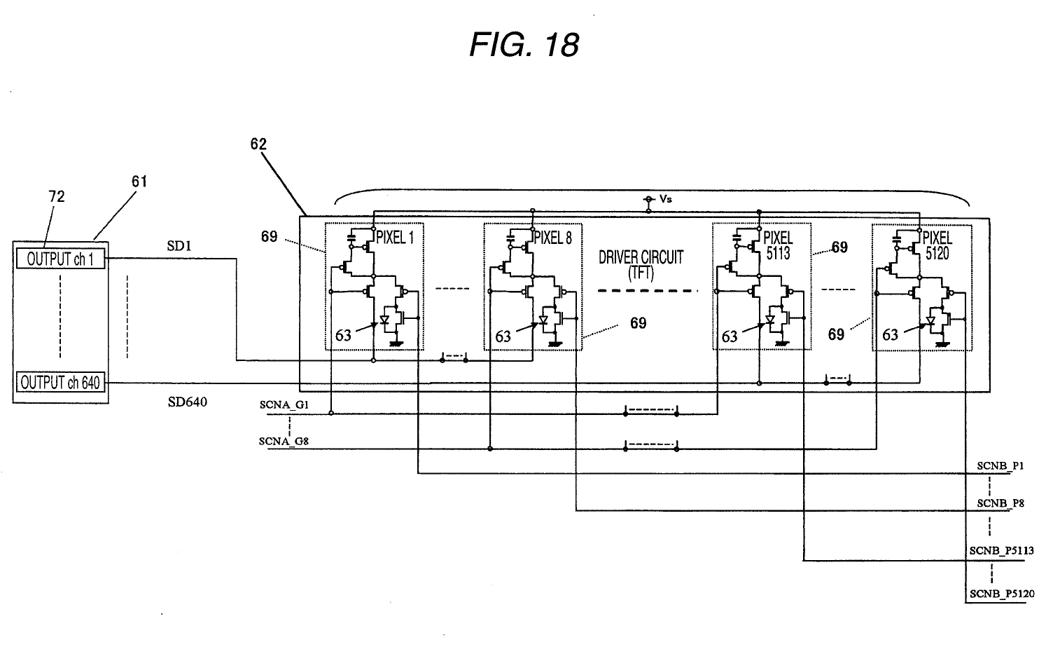

FIG. 18 is a diagram showing a configuration of the TFT circuit 62 and the source driver 61 in accordance with a second embodiment of the invention.

FIG. 18 shows a main part of FIG. 8 excluding the gate controller 68.

In the invention, the whole TFT circuit 62 is referred to as the “driver circuit,” and the pixel circuit 69 which is a minimum circuit unit for driving the EL elements 63 is also referred to as the “driver circuit”. As a matter of convenience, the pixel circuits 69 may be referred to as “driving elements 69” in order to distinguish between them. In the second embodiment, there is provided only one organic EL element 63 as the light-emitting element, and a unit pixel circuit responsible for a driving control of the one light-emitting element is referred to as a “pixel”. From a viewpoint of a function of driving the light-emitting element, the driver circuit functions as a light-emitting element driving device.

One output of the source driver 61 is responsible for programming 8 pixels (i.e., 8 pixel circuits). That is, the entire pixels are divided into groups, each containing 8 pixels, and a programming command is output from the source driver 61 toward respective light-emitting elements belonging to each group. That is, the number of groups becomes 640, a number (640) of D/A converters 72 are mounted on the source driver 61, and a total of 640 source driver signal lines are connected to the TFT circuit 62.

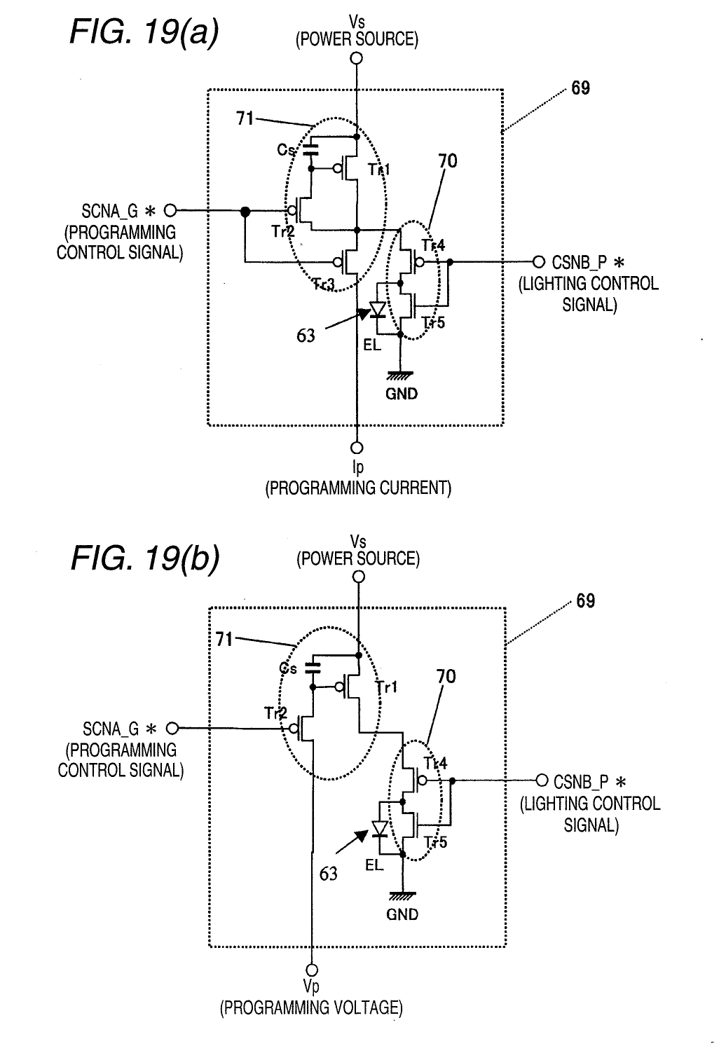

FIG. 19 is a diagram showing a configuration of a pixel circuit 69 in accordance with the second embodiment of the invention.

Hereinafter, the pixel circuit (sub driver circuit) will be described with reference to FIG. 19.

FIG. 19 is an enlarged view of the pixel circuit (sub driver circuit) 69 shown in FIG. 18. Here, the example shown in FIG. 19(a) corresponds to the pixel circuit 69 driven by the so-called “current programming method” and has the same configuration as that shown in FIGS. 8 and 18. Meanwhile, the example shown in FIG. 19(b) corresponds to the pixel circuit 69 driven by the so-called “voltage programming method” and has a configuration a little different from that shown in FIGS. 8 and 18. However, the control methods thereof are substantially equal to each other. In the description with reference to FIG. 19, the programming control signal line SCNA_G* and the light emission control signal line SCNB_G*, described in the first embodiment will be simply referred to as “SCNA signal” and “SCNB signal,” respectively. In the first embodiment, each group of a plurality (5120 in the example) of organic EL elements is controlled through the light emission control signal line SCNB_G* (see FIG. 10 for reference). However, in the second embodiment, the lighe emission control signal line SCNB_P* is provided to each of the pixel circuits 69 (see FIG. 18 for reference).

The pixel circuit shown in FIG. 19(a) includes a number (5) of transistors Tr1 to Tr5, a capacitance element Cs, and an organic EL element 63 (hereinafter, also simply referred to as “EL”). The Tr1 and the Cs connected in paralled to each other are connected to the power supply Vs. The Tr2 is connected in serial to the Tr1 and the Cs. The Tr3 is connected in serial to the Tr1 via a midway connecting point and connected to an upper end of the Tr2. The SCNA signal is input to the Tr2 and the Tr3. The Tr4 is connected to the midway connecting point of the Tr1 and Tr3, and is connected in serial to the parallelly connected Tr5 and EL. The SCNB signal is input to the Tr4 and the Tr5. The Tr5 and the EL are connected to the GND at a node other than the node connected to the Tr4. A programming current Ip output from the D/A converter 72 of the source driver 61 is input to the Tr3. The driver unit 70 shown in FIG. 8 is constitutd by the Tr4 (a first transistor) and the Tr5 (a second transistor), and the programming unit 71 is constituted by the Cs, Tr1, Tr2, and Tr3.

The SCNA_G* shown in FIG. 19 is the programming control signal line (a second signal line), corresponds to the SCAN_A shown in FIG. 8, and is used to output either ON or OFF as the programming control signal. The programming control signal is used to control the charging potential supplied to the capacitance element Cs to control the current value to be supplied to the EL (the organic EL element 63) by turning ON and OFF the transistors Tr2 and Tr3.

The SCNB_P* shown in FIG. 19 is the light emission control signal line (a first signal line) and is used to turn ON and OFF the current supply to the EL. Since the Tr4 is in its ON state when the SCNB_P* is in its ON state (i.e., at its low level), current flows from the power supply Vs through the Tr1 and finally into the EL, thereby lighting the EL. To the contrary, since the Tr4 is in its OFF state when the SCNB_P* is in its OFF state (i.e., at its high level), the current path to the EL is blocked and thus current does not flow into the EL, whereby the EL is unlighted.

In addition, the light emission control signal line SCNB_P* as the first signal line output from the gate controller 68 shown in FIG. 8 is configured to input a total of 5120 signals to the driving elements of each pixie and output either ON or OFF as the light emission control signal with a predetermined timing in accordance with image data of each pixel. That is, the light emission control signal is a signal representing the lighting or non-lighting of each EL (the organic EL elements 63).

That is, the light emission control signal SCNB_P* is independently set for each pixel and thus set to ON or OFF in accordance with the image data (data for forming an image to be formed by light emitted from the light-emitting element) of each pixel. In other words, the light emission control signal is switched to ON or OFF in accordance with the image data of each pixel in an independent manner for each pixel. Meanwhile, the programming control signal SCNA_G* is not set in an independent manner for each pixel, and thus is supplied to each of 640 groups constituting the entire pixels. As will be described later, the programming unit 71 functions as a driving condition setting unit for setting a driving condition (a driving current, a driving voltate, and the like) of the EL element 63, and the driver unit 70 functions as a driving control unit for controlling the lighting or non-lighting of the EL element 63 with a predetermined period.

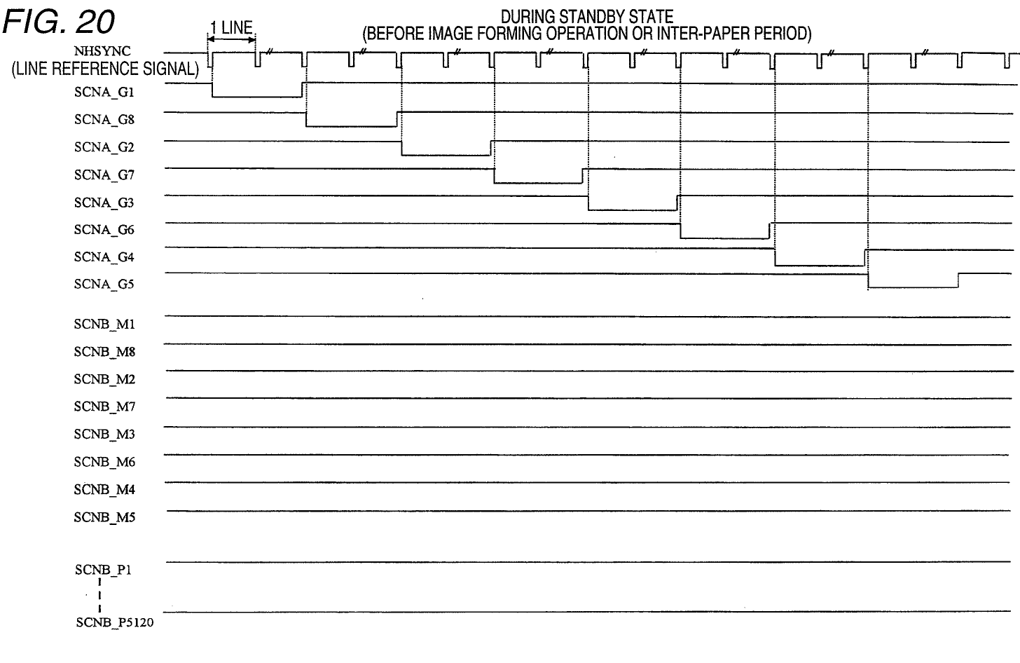

FIG. 20 is a timing chart showing an example of a current programming operation in accordance with the second embodiment of the invention.

FIG. 20 shows timings of the current programming operation. In the second embodiment, the current programming operation is performed in a standby state (for example, before an image forming operation or an inter-paper period in the course of a successive image forming operation). Reference numeral NHSYNC denotes a reference signal representing one line period. As described above, since one group is configured to contain 8 pixels in the second embodiment, in order to perform a programming operation with respect to the 8 pixels in a selective and sequential manner in the one line period using a single output of the source driver 61, the SCAN_A signal is configured to include a total of 8 signals SCNA_G1 to SCNA_G8, and the respective ON timings of the 8 signals are configured not to overlap each other, as shown in FIG. 20. In FIG. 20, in order to secure sufficient programming period, one SCAN_A signal is configured to be in its ON state for several line period defined as a first time length. Accordingly, it is possible to provide sufficient charging potential to the capacitance element Cs. In this case, it is necessary to increase the capacity of the capacitance element Cs so as to maintain the charging potential at a constant level at the time of an image forming operation even after the programming operation. In other words, since the required programming period may increase as the capacity of the capacitance element Cs increases, the programming period in a period other than the image forming operation is set sufficiently great, as shown in FIG. 20. As shown in FIG. 20, by sequentially putting the SCAN_A signals, i.e., SCNA_G1 to SCNA_G8 into their ON states, the programming operation for the entire 5120 pixels is finished. Since the image forming operation is not performed in the programming period, the signals SCNB_M1 to SCNB_M8 are in their OFF states, and the light emission control signals SCNB_P1 to SCNB_P5120 for the pixels are in their OFF states.

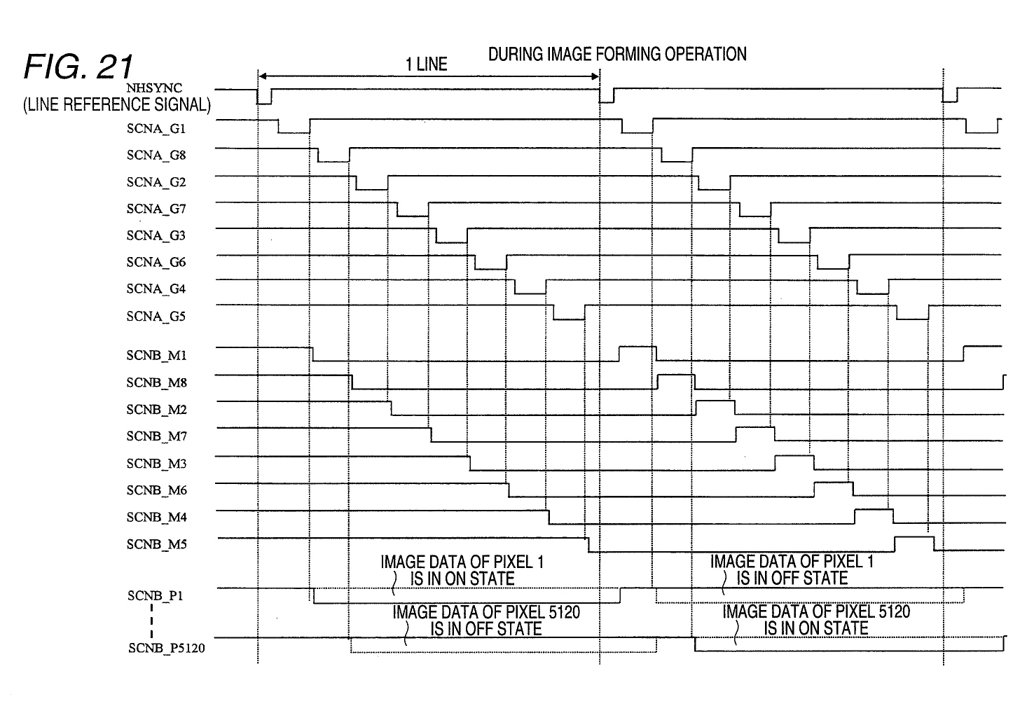

FIG. 21 is a timing chart showing timings of the lighting and non-lighting control in the course of an image forming operation in accordance with the second embodiment of the invention.

FIG. 21 shows timings in the course of the image forming operation. Similar to the case of the SCAN_A signal, the SCAN_B signal is configured to include a total of 8 signals SCNB_M1 to SCNB_M8 as its basic signal. However, since the SCAN_B signal is controlled to be ON and OFF in accordance with the image data of each pixel, it can be said in the second embodiment that the SCAN_B signal is configured to include a total of 5120 signals SCNB_P1 to SCNB_P5120. In FIG. 21, there are shown only two signals SCNB_P1 and SCNB_5120, the SCNB_P1 signal is based on the SCNB_M1 signal and is controlled to be ON and OFF in accordance with a pixel 1. Meanwhile, the SCNB_P5120 signal is based on the SCNB_M8 signal and is controlled to be ON and OFF in accordance with a pixel 5120. As shown in FIG. 21, during the image forming operation, the signals SCNB_M1 to SCNB_M8 are controlled to be ON and OFF with a predetermined timing in repetition, and the light emission control signals SCNB_P1 to SCNB_P5120 of each pixel are in their ON states on basis of the corresponding SCNB_M* signal of the image data of the pixel. When the image data is in the OFF state, the light emission control signals are in their OFF state as they are. When the the light emission control signals SCNB_P1 to SCNB_P5120 are in their ON states, current flows into the organic EL element in accordance with the charging potential being programmed in FIG. 21 and applied to the capacitance element Cs of the pixel. In FIG. 21, the SCAN_A signals SCNA_G1 to SCNA_G8 are in their ON states even in the OFF period of the corresponding SCAN_B signals SCNB_M1 to SCNB_M8. This is a countermeasure to prevent a change in the charging potential being programmed to the capacitance element Cs in the standby state (before the image forming operation or in the inter-paper period) due to an influence such as leakage current, and is an auxiliary programming operation (auxiliary charging operation) performed, every one line of the image forming operation, to the capacitance element Cs of each pixel. Such an auxiliary programming operation will be referred to as an auxiliary programming. With such an auxiliary programming, since the capacitance element Cs of each pixel can be refreshed every one line in the course of the image forming operation, it is possible to supply the current to the organic EL element in a more stable manner, thereby further stabilizing the image forming operation. When the ON period of the programming signal SCAN_A in the auxiliary programming is defined as a second time length, the second time length is smaller than the first time length that is the ON period of the programming period SCAN_A in the above-described standby state.

Next, the light emission control operation in accordance with the second embodiment will be described in detail with reference to FIGS. 9, 18, and 19. Hereinafter, a single pixel group (for example, those pixels having “pixel number in the primary scanning direction”=1 to 8) containing 8 pixels will be described to simplify the description. As described above, the programming operation for each pixel is already in a finished state at the timing shown in FIG. 20, before the execution of the light emission control operation (the image forming operation).

In the second embodiment, one line period (a raster period) of the exposure device 13 is set to 350 μs, and ⅛ of the one line period, i.e., 43.77 μs is prepared as a period (the second time length) for the auxiliary programming operation of refreshing the accumulation potential of the capacitor Cs provided in the programming unit 71.

(1) The gate controller 68 (see FIG. 8 for reference) sets the SCNA_G1 signal and the SCNB_P1 signal for pixels having pixel number of 1 to the ON and OFF states, respectively, thereby setting the auxiliary programming period. In this case, the transistors Tr2 and Tr3 (see FIG. 19 for reference) are turned ON by the SCNA_G1 signal.

(2) In the auxiliary programming period, similar to the case of the programming period in the standby state (before the image forming operation or during the inter-paper period), 8-bit light intensity correction data is already supplied to the D/A converter 72 incorporated into the source driver 61 (see FIG. 8 for reference), and the capacitor Cs (see FIG. 19 for reference) of the programming unit 71 is charged to a predetermed potential by the analog level signal obtained by D/A converting the supplied digital data, i.e., the programming current Ip shown in FIG. 19.

The auxiliary programming operation is performed regardless of the ON and OFF of the 2-valued image data input to the gate controller 68. With this configuration, the analog value based on the 8-bit light intensity correction data is written into the capacitor Cs formed in the programming unit 71 every one line period. That is, the accumulation charge in the capacitor formed in the programming unit 71 is refreshed every one line period, and the driving current of the EL (the organic EL element 63) determined on the basis of the accumulation charge is always maintained at a constant level.

(3) When the programming period expires, the gate controller 68 (see FIG. 8 for reference) immediately switches the SCNA_G1 signal to the OFF state. When the SCNA_G1 signal is in the OFF state, the transistors Tr2 and Tr3 (see FIG. 19 for reference) are turned OFF. Therefore, the charge cannot be discharged and thus the potential applied to the capacitor Cs is maintained.

(4) The gate controller 68 (see FIG. 8 for reference) immediately switches the SCNB_P1 signal to the ON state so as to set the light emission period (the lighting period). When the SCNB_P1 is in the ON state, the transistor Tr4 (see FIG. 19 for reference) is turned ON (however, only in the ON state of the image data). Accordingly, current (drain current) determined by the potential (gate potential) maintained at the capacitor Cs in the above operation (3) flows from the power supply Vs through the transistors Tr1 and Tr4 and finally into the EL (the organic EL element 63) (see FIG. 19 for reference), thereby lighting the EL.

As described above, the gate controller 68 (see FIG. 8 for reference) is supplied with the 2-valued image data at the time of the image forming operation and the light intensity measuring operation, and the organic EL element 63 does not emit light in the OFF state of the image data event in the light emission period. Meanwhile, when the image data is in the ON state, the organic EL element 63 continuously emits light for the remaining period 306.25 μs (306.25=350−43.75). However, since it takes a little time to switch the control signals, the lighted period is a little decreased. As described above in the first embodiment, since it is assumed that it takes 30 ms to measure the light intensity of the organic EL elements 63, the controller 41 generates the dummy image information so that the number of lightings in the light intensity measuring operation becomes 100 (i.e., 100 lines), for example.

(5) When the light emission period expires, the gate controller 68 (see FIG. 8 for reference) immediately switches the SCNB_P1 signal to the OFF state. In the second embodiment, the transistors Tr4 and Tr5 are configured respectively as a P-channel transistor and a N-channel transistor so that the respective ON and OFF conditions are opposite to each other. Therefore, when the SCNB_P1 signal is in the OFF state, the Tr4 is turned OFF and current does not flow into the EL. To the contrary, when the SCNB_P1 signal is in the OFF state, the Tr5 is turned ON and both nodes of the EL are substantially at the GND potential, whereby the EL is unlighted.

Meanwhile, in FIG. 18, when the programming period for the pixel circuit 69 corresponding the number 1 pixel expires, the gate controller 68 immediately sets the auxiliary programming period for the pixel circuit 69 corresponding to the number 8 pixel. In a similar sequence to that of the pixel circuit corresponding to the number 1 pixel, when the programming period for the pixel circuit corresponding to the number 8 pixel expires, an operation of setting the light emission period of the organic EL elements 63 corresponding to the pixel number is performed.

The operations (1) to (5) of the pixel circuit are performed on the entire pixel circuits in the one line period in repetition. The operation (4) is performed only in the ON state of the image data (in a state where the EL element is to be lighted). The SCNB signals of each pixel are determined to be ON and OFF in accordance with the image data of corresponding pixel circuit (pixel). In other words, the SCNB signal has unique pixel data (signal) different from pixel to pixel and serves to control the light emission (lighting and non-lighting) of pixels.

Meanwhile, in the pixel circuit driven by the voltage programming method shown in FIG. 19(b), unlike the pixie circuit shown in FIG. 19(a), the transistor Tr3 is not provided, and a programming voltage Vp output from the D/A converter 72 of the source driver 61 is input to the transistor Tr2. In the operation (1), the capacitor Cs is charged to a predetermined potential by the programming voltage Vp. In the operation (2), only the transistor T2 is turned OFF. Thereafter, throught the same operations as described above, the lighting and non-lighting of the EL element is controlled.

In this way, the gate controller 68 (see FIG. 8 for reference) sets the programming period and the lighting period in the order of the pixel number in the primary scanning direction, i.e., “1→8→2→7→3→6→4→5→1 . . . .” By setting the lighting order in such a manner, the lighting timings of pixels disposed adjacent to each other in pixel groups adjacent to each other become close to each other in time and it is thus possible to make uneven display of image less prominent at the time of forming one line of image.

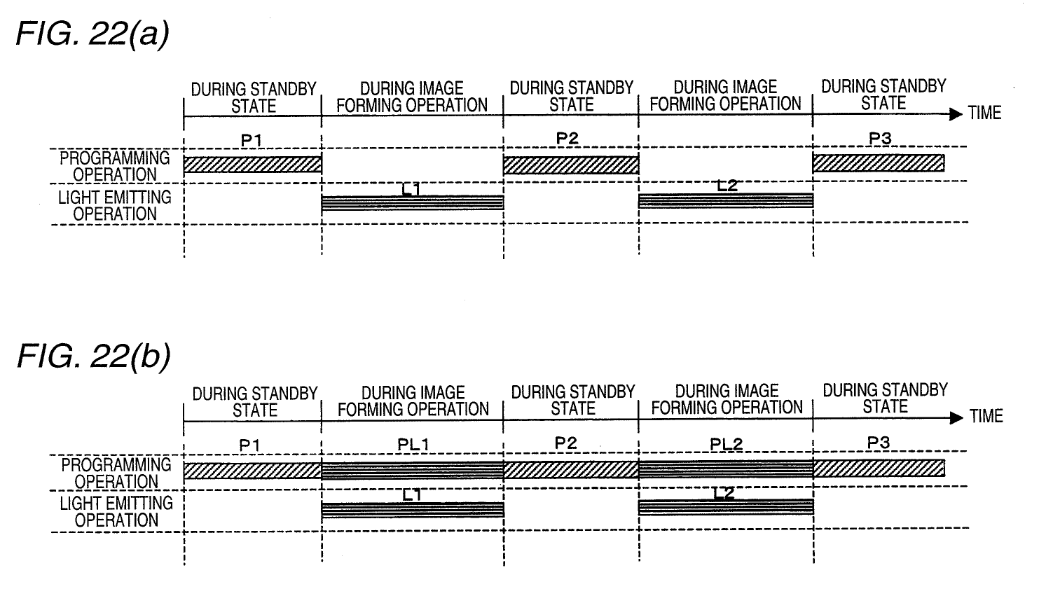

FIG. 22 is a timing chart for the case where a programming operation and a light emitting operation are performed to the pixel circuit 69 in accordance with the second embodiment of the invention.

In FIG. 22, two exemplary operations are illustrated. Here, the programming operation corresponds to the operations (1) to (3), and the light emission operation corresponds to the operations (4) and (5). More specifically, although the operations (1) to (3) have been described as the auxiliary programming since the operations in the course of the image forming operation have been described above, the operation of the pixel circuit 69 in the course of the programming operation during the standby state (before the image forming operation or during the inter-paper period) is basically the same as that described in the operations (1) to (3). That is, the programming operation corresponds to an operation of the pixel circuit 69 for accumulating (charging) charge in the capacitance element Cs, and the light emission operation corresponds to an operation of converting the accumulated charge into electric current so as to allow the EL element to emit light.

In the example shown in FIG. 22(a), in the course of the programming operation, operations of charging the capacitor Cs are performed at periods P1, P2, and P3. In this case, the periods P1, P2, and P3 are set at timings different from those of the light emission operations L1 and L2, i.e., in the standby state. The standby state is a period (before the image forming operation or during the inter-paper period) where the lighting of the EL element, the operation of forming an image on the recording paper 3, and the printing operation are not performed, and the operation of charging electric current to the capacitor Cs is in the above-mentioned period for the first time length.

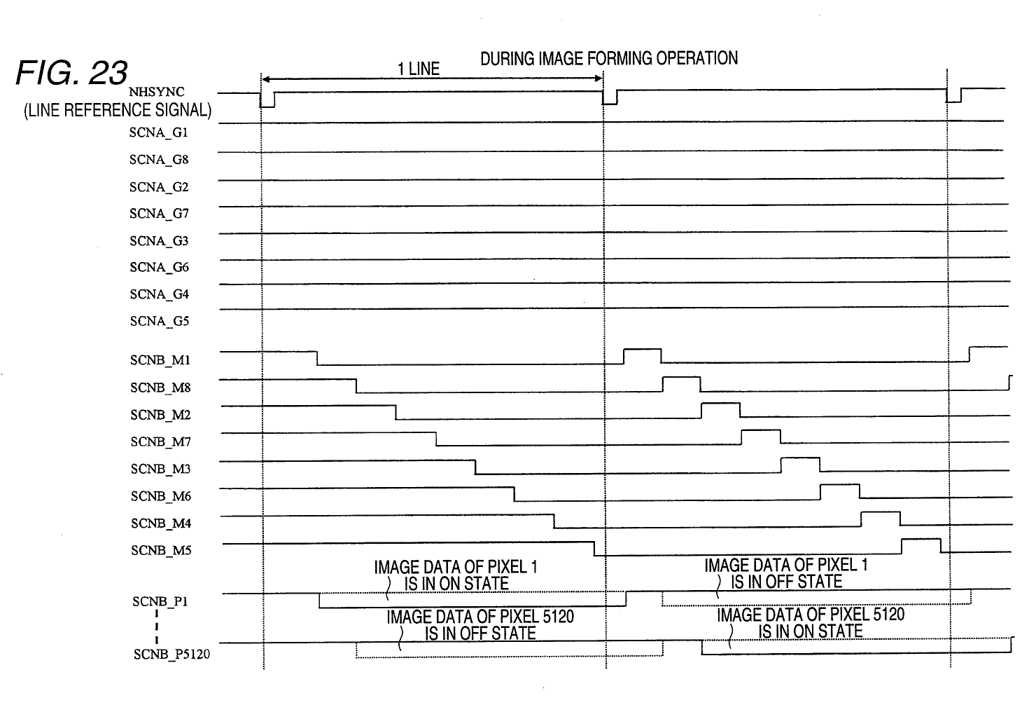

FIG. 23 is a timing chart showing timings of the image forming operation in the absence of the programming operation in accordance with the second embodiment of the invention.

Meanwhile, the light emission control operation in the course of the image forming operation is performed with a timing as shown in FIG. 23. The SCNB signals SCNB_P1 to SCNB_P5120 of each pixel is switched to the ON and OFF states in accordance with the image data, and the EL element corresponding to each pixel is lighted or unlighted. In the example shown in FIG. 22(a), the programming operation (the above-described auxiliary programming) is not performed to the pixel circuits 69 in the course of the image forming operation. In FIG. 23, since the programming control signals SCNA_G1 to SCNA_G8 are at their high level state and thus turn OFF the transistors Tr2 and Tr3 of the programming unit 71, the programming operation is not performed. In this manner, since the programming operation is not performed in the course of the image forming operation, the potential charged to the capacitance element Cs of the programming unit 71 in the standby state is slowly changed due to an influence such as leakage current, which may become a cause of the change in the current flowing into the EL element in the lighting state.

In order to diminish the influence, it may be effective to perform the auxiliary programming in the course of the image forming operation as shown in FIG. 22(b). In FIG. 22(b), with the timings shown in the timing chart of FIG. 21, the programming operation (the auxiliary programming) is performed for the second time length to the pixel circuits 69 of the entire EL elements in each line, and the capacitance element Cs of the programming unit 71 in the pixel circuits 69 of the entire EL elements is refreshed. Accordingly, it is possible to compensate the change in the electric potential of the capacitance element Cs due to an influence such leakage current and decrease irregularity in the light intensity of the EL element, thereby enabling to perform the image forming operation in a more stable manner.

According to the second embodiment, the programming operation is basically performed in the standby state, and in the course of the image forming operation, the programming operation is not performed or only the auxiliary programming operation is performed. Therefore, it is possible to perform the image forming operation by controlling the light emission of the EL elements in accordance with the image data. Accordingly, it is possible to decreast the programming period required for the image forming operation greatly, thereby realizing a further increase in the image forming speed. In addition, it is possible to increase the number of pixels to be processed by a single D/A converter 72 of the source driver 61. That is, in the programming operation performed for the entire pixel circuits 69 in the standby state, it is possible to save time corresponding to a plurality of lines, for example, shown in FIG. 20 and decrease or omit the programming period per one pixel required for the image forming operation. Therefore, it is possible to increase the number of pixels to be processed by a single D/A converter 72. Accordingly, it is possible to decrease the number (i.e., the number of output channels) of D/A converters 72 in the source driver 61 and simplify the configuration of the apparatus, thereby decreasing the manufacturing cost.

Once the driving current value of the EL element 63 is set by the programming unit (driving condition setting unit) 71 of the driving element 69, the charge programmed to the capacitance element Cs included in the programming unit 71 can be maintained at a constant level for a period (for example, until printing of one page is finished) where the line is exposed to light over a plurality of periods (in the second embodiment, one raster period is 350 μs). For example, by increasing the capacity of the capacitor Cs and setting the first time length in correspondence to the increased capacity, it is possible to secure the charging potential of the capacitor Cs required for the image forming operation even when the charging potential is changed by an influence such as leakage current. In other words, in the course of exposing a plurality of lines in accordance with image data corresponding to one page, the programming unit does not write (program) any settings in the driving element (i.e., the auxiliary programming is not required). In this case, it is desirable that the plurality of periods where the driving condition is maintained (the programming is not performed) corresponds to a raster number (the number of scannings) of a printed page (one page) of a recording medium such as the above-described recording paper 3. With such a configuration, it is possible to maintain the same printing condition in one page. Accordingly, it is possible to avoid a circumstance in which a change in the printed states in one page is prominent.

The second embodiment includes the following aspects.

A light-emitting element driving device in accordance with an aspect of the second embodiment includes a plurality of light-emitting elements, a driving element provided in correspondence to the light-emitting elements so as to drive the light-emitting elements on the basis of a predetermined driving condition, a driving condition setting unit that sets a driving condition of the light-emitting elements to the driving element, and a driving control unit that controls lighting and non-lighting of the light-emitting elements with a predetermined period via the driving element, in which the driving control unit stores therein the driving condition of the light-emitting elements set by the driving condition setting unit so as to drive the light-emitting elements for a plurality of periods. With such a configuration, it is possible to decrease the programming period required for each of the light-emitting elements. Accordingly, it is possible to realize a further speeding up and manufacturing cost reduction in an apparatus such as an image forming apparatus to which the light-emitting element driving device is applied.

A light-emitting element driving device in accordance with another aspect of the second embodiment is a light-emitting element driving device which drives a plurality of light-emitting elements. The light-emitting element driving device includes a plurality of driving elements, a plurality of first signal lines connected to the driving elements so as to input a light emission control signal for controlling lighting or non-lighting of the light-emitting elements to the driving elements, and a plurality of second signal lines connected to the driving elements so as to input, to the driving elements, a programming control signal for controlling an current to be supplied to the light-emitting elements, in which each of the driving element includes at least one light-emitting element, a driver unit for supplying and driving an current to the light-emitting element on the basis of the light emission control signal, and a programming unit for determining the value of the current on the basis of the programming control signal, and the second signal lines is used to input the programming control signal to the programming unit in a period where the light emission control signal is not input to the driver unit for a plurality of light emission periods of the light-emitting element, for execution of an auxiliary programming to prevent a change in the driving condition. With such a configuration, it is possible to decrease the programming period required for each of the light-emitting elements. Accordingly, it is possible to realize a further speeding up and manufacturing cost reduction in an apparatus such as an image forming apparatus to which the light-emitting element driving device is applied.

In addition, the programming unit may include a capacitance element for accumulating charge corresponding to the current to be supplied to the light-emitting element on the basis of the programming control signal. In addition, the plurality of first signal lines are may be configured to input the light emission control signal to the driving elements in a independent manner, and the plurality of second signal lines may be configured to input the programming control signal to each group of the plurality of driving elements.

The driver unit may include a first transistor connected in serial to the light-emitting element and a second transistor connected in parallel to the light-emitting element. The light emission control signal may be a signal based on data for forming an image to be formed by light emitted from the light-emitting element.

A light-emitting element driving device in accordance with a further aspect of the second embodiment includes a plurality of light-emitting elements, driving elements provided in correspondence to the light-emitting elements so as to drive the light-emitting elements on the basis of a predetermined driving condition, a driving condition setting unit that sets a driving condition of the light-emitting elements to the driving element for a first time length or a second time length smaller than the first time length, and a driving control unit that controls lighting and non-lighting of the light-emitting elements via the driving element in accordance with the driving condition set by the driving condition setting unit. Before the driving control unit starts its operation, the driving condition setting unit sets the driving condition of the light-emitting elements to the driving element for the first time length. After the driving control unit has started its operation, the driving condition setting unit sets the driving condition of the light-emitting elements to the driving element with a predetermined period for the first time length.

An organic EL element may be used as the light-emitting element. In addition, the light-emitting element driving device in accordance with the second embodiment is suitably applicable to an image forming apparatus. In this case, a raster gap or a page gap of printed page may be used as the above-described plurality of periods. Accordingly, it is possible to suppress an increase in the manufacturing cost of the image forming apparatus.

According to the second embodiment, it is possible to realize a further speeding up and manufacturing cost reduction in an apparatus such as an image forming apparatus to which the light-emitting element driving device is applied.

### Third Embodiment

Hereinafter, a light-emitting element driving device in accordance with a third embodiment of the invention will be described in detail.

The configuration of the image forming apparatus 1 to which the light-emitting element driving device in accordance with the third embodiment of the invention is applied and the configuration of the exposure devie 13 have beend described in detail in connection with the first embodiment, and thus descriptions thereof will be omitted.

The third embodiment of the invention has been made by investigating into the light emission control of the organic EL element 63 as the light-emitting element. With such an investigation, it is possible to decrease the programming period and realize a further increase in an image forming speed and a printing speed of the image forming apparatus 1.

The third embodiment of the invention can be applicable to other types of light-emitting elements as well as the organic EL element.

The following descriptions will be made with reference to FIG. 8 and FIGS. 18 and 19 which were referred in the descriptions of the first and second embodiments, respectively.

Definitions in the second embodiment of the pixel circuit 69, the driving element, the pixel, the driver circuit are similarly applicable to the present embodiment.

Similar to the case of the second embodiment, the one output of the source driver 61 is responsible for 8 pixels (8 pixel circuits), and descriptions therof will be omitted.

Hereinafter, descriptions will be made with reference to FIGS. 8, 18, and 19.

In the third embodiment, the light emission control signal line SCNB_P* as the first signal line output from the gate controller 68 shown in FIG. 8 is configured to input a total of 5120 signals (see FIG. 18 for reference) to the driving elements 69 of each pixie and output either ON or OFF as the light emission control signal with a predetermined timing in accordance with image data of each pixel. That is, the light emission control signal is a signal representing the lighting or non-lighting of the organic EL elements 63. In this manner, the programming is performed to the entire pixels on a line-by-line basis so that the pixels are controlled and instructed to be lighted or unlighted. Here, the SCNB_P* signal shown in FIG. 19 corresponds to the SCAN_B signal shown in FIG. 8. In addition, the SCNA_G* shown in FIG. 19 is the programming control signal line (the second signal line), corresponds to the SCAN_A shown in FIG. 8, and is used to output either ON or OFF as the programming control signal. The programming control signal is used to set the value of the electric current supplied to the organic EL element 63 to the driving element (the pixel circuit) 69 and provide timings for setting the driving condition of the organic EL element 63. The signal lines SCNB_G* and SCNA_G* are formed into an electrically active matrix structure, and the light-emitting element driving device in accordance with the third embodiment is also formed into an active matrix-type driving circuit (which can be considered as an application such as a display apparatus having pixels aligned in a 2-dimensional configuration and pixels on each row are aligned along a straight line).

That is, the light emission control signal SCNB_P* is independently set for each pixel and thus set to ON or OFF in accordance with the image data (data for forming an image to be formed by light emitted from the light-emitting element) of each pixel. In other words, the light emission control signal is switched to ON or OFF in accordance with the image data of each pixel in an independent manner for each pixel. When the image data is a 2-valued signal, the values “1” and “0” directly correspond to the ON and OFF of the organic EL element 63 (however, when an inverted logic is employed, “0” value in the image data corresponds to the ON state of the organic EL element).

Meanwhile, the programming control signal SCNA_G* is not set in an independent manner for each pixel, and thus is supplied to each group containing 8 pixels, for example.

In a case where the image data is supplied as the 2-valued signal and the value of the image data is “1”, i.e., the organic EL element 63 is lighted, the value being programmed to the driving element 69 is the light intensity correction data stored in the third area of the light intensity correction data memory 66 shown in FIG. 6.

Meanwhile, in a case where the image data is supplied as a multi-valued signal, a determination circuit for determining whether the value of the image data is “0” or “the other value” may be included. That is, the organic EL element 63 is controlled to be unlighted when the value of the image data is “0” and to be lighted when the image data hass “the other value”. In the case of “the other value”, the value of the electric current for driving the organic EL element 63 corresponds to the value being programmed in accordance with the multi-valued signal (i.e., the value stored as the analog potential in the capacitor Cs of the driving element 69 shown in FIG. 19).

As described above, the light intensity correctin data is a value that is set uniquely to each organic EL element 63 (see the third area shown in FIG. 6, for reference). When the image data is the multi-valued signal, there may arise a problem of adjusting a relationship between the image data representing a grayscale gradation and corresponding light intensity correction data. A countermeasure to such a problem will be described in detail in connection with a fourth embodiment.

Since the configuration of the pixel circuit (driving element) 69, the procedures of the current programming and light emission control operations, and the relationship between the current programming period and the lighting and non-lighting period of the organic EL element 63 have been already described in connection with the second embodiment with reference to FIGS. 8, 9, 18, and 19, descriptions thereof will be omitted.

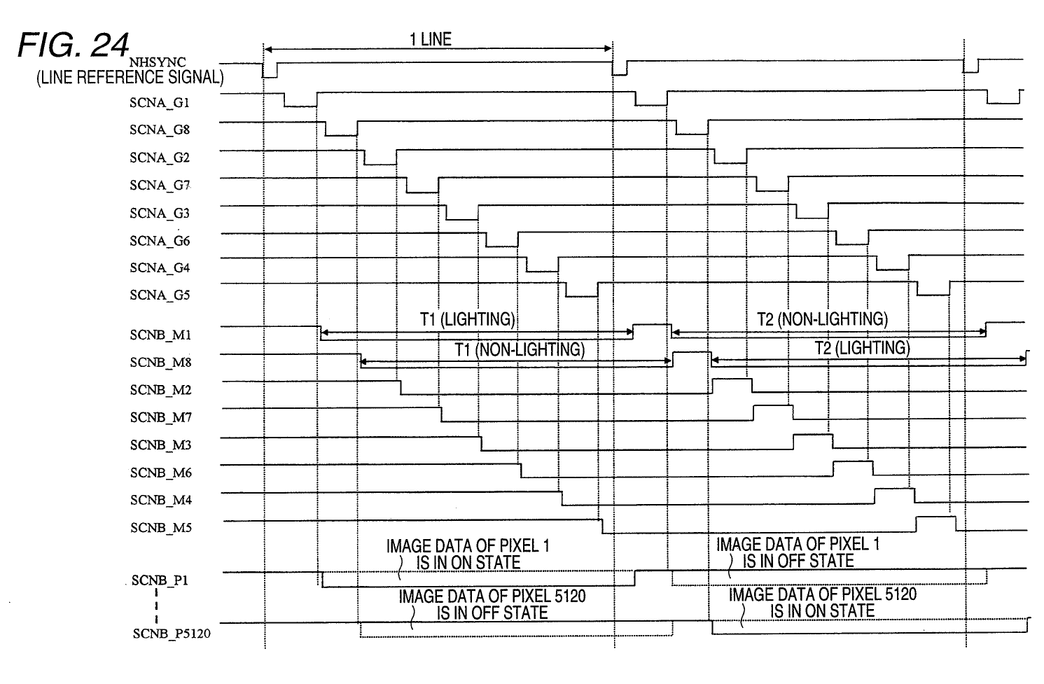

FIG. 24 is a timing chart showing turing ON and OFF timings of the programming control signals SCNA_G*(SCNA_G1 to SCNA_G8) and the light emission control signals SCNB_P*(SCNB_P1 to SCNB_P5120) in accordance with the third embodiment of the invention.

Here, reference numeral NHSYNC denotes a line reference signal, represents one line period, i.e., a period in which a number (5120) of organic EL elements 63 are lighted, and corresponds to 350 μs shown in FIG. 9. In addition, reference numeral SCNB_M* (SCNB_M1 to SCNB_M8) denotes a master signal (reference signal) of the light emission control signal SCNB_P*. The light emission control master signal is used to drive the organic EL elements 63 so as to be lighted in synchronization with the programming control signal SCNA_G* regardless of the ON and OFF of the image data, and, more specifically, is switched to the ON state in preparation of the light emission driving. In the drawing, a high level signal corresponds to the OFF state and a low level signal corresponds to the ON state.

In FIG. 24, the light emission control master signal SCNB_M* is input from an external source (for example, the source driver 61 or a control signal generation unit (not shown) in the exposure device) of the gate controller 68 (see FIG. 8 for reference) or is generated by the gate controller 68. However, the source of the light emission control master signal is not particularly limited.

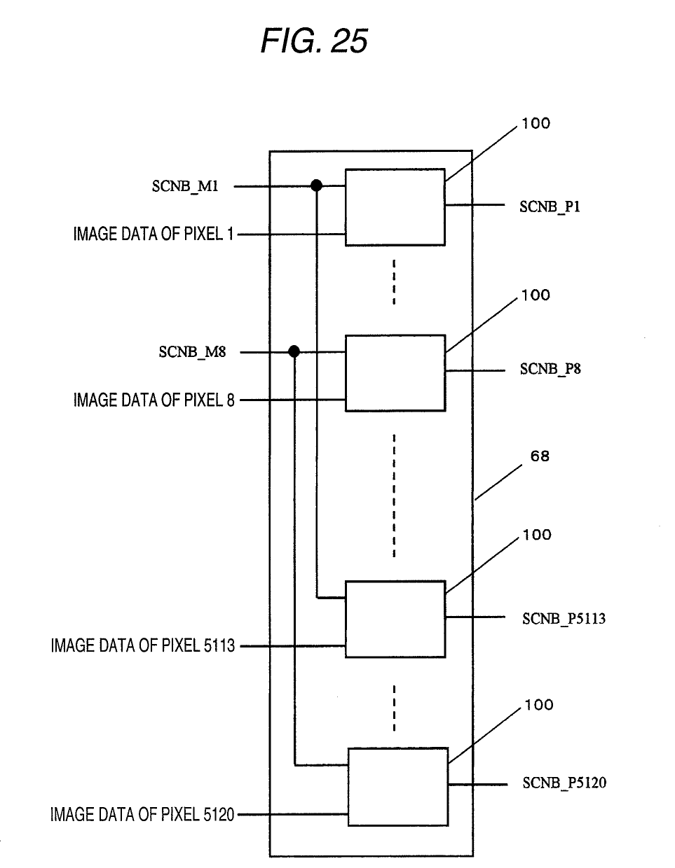

FIG. 25 is a diagram showing a configuration for the case where light emission control master signals SCNB_M* generated by an external control signal generation unit are supplied to an inner part of a gate controller 68 in accordance with the third embodiment of the invention.

The gate controller 68 is provided with a plurality of gate circuits 100, and the light emission control master signal SCNB_M* is connected and supplied to the gate circuits 100. Image data for driving each pixel is also supplied to the gate circuits 100. The gate controller 69 is driven by an 8-division method: i.e., the SCNB_M1 signal is connected to the corresponding gate circuits 100 of a group of pixels 1, 9, . . . , 5113 having a distance of 8 pixels; the SCNB_M2 signal is connected to the corresponding gate circuits 100 of a group of pixels 2, 10, . . . , 5114; and the SCNB_M8 signal is connected to the corresponding gate circuits 100 of a group of pixels 8, 16, . . . , 5120. The gate circuit 100 is a logic circuit of the image data of each input pixel and the light emission control master signals SCNB_M*, and as collectively represented by the SCNB_P1 and SCNB_P5120 in FIG. 24, the SCNB_P* of each pixel is switched ON and OFF in accordance with the image data and the light emission control signal SCNB_M*.

The programming control signal SCNA_G*and the light emission control master signal SCNB_M* may be basically grouped in a similar manner. In the third embodiment, since the above-described 8-division method is employed, the programming control signal SCNA_G* and the light emission control master signal SCNB_M* are commonly used in every 8 pixels.

In the third embodiment, the light emission control master signal SCNB_M* is used. The master signal may not be actually present. As long as the reference of the ON and OFF timings of the SCNB_P* signal can be determined (for example, the ON and OFF timings may be controlled by register's setting), the SCNB_P* signal can be derived from the image data of each pixel.

As can be seen from FIG. 24, in the organic EL element 63 corresponding to the number 1 pixel, the SCNB_M1 synchronized to the SCNA_G1 is in the ON state during a priod T1, and the SCNB_P1 corresponding to the pixel data at that moment is in the ON state. Therefore, the organic EL element 63 is lighted. However, even when the SCNB_M1 is in the ON state during a priod T1, the SCNB_P1 corresponding to the pixel signal at that moment is in the OFF state. Therefore, the organic EL element 63 is unlighted. Meanwhile, the organic EL element 63 corresponding to the number 8 pixel operates in a opposite manner to the case of the number 1 pixel.

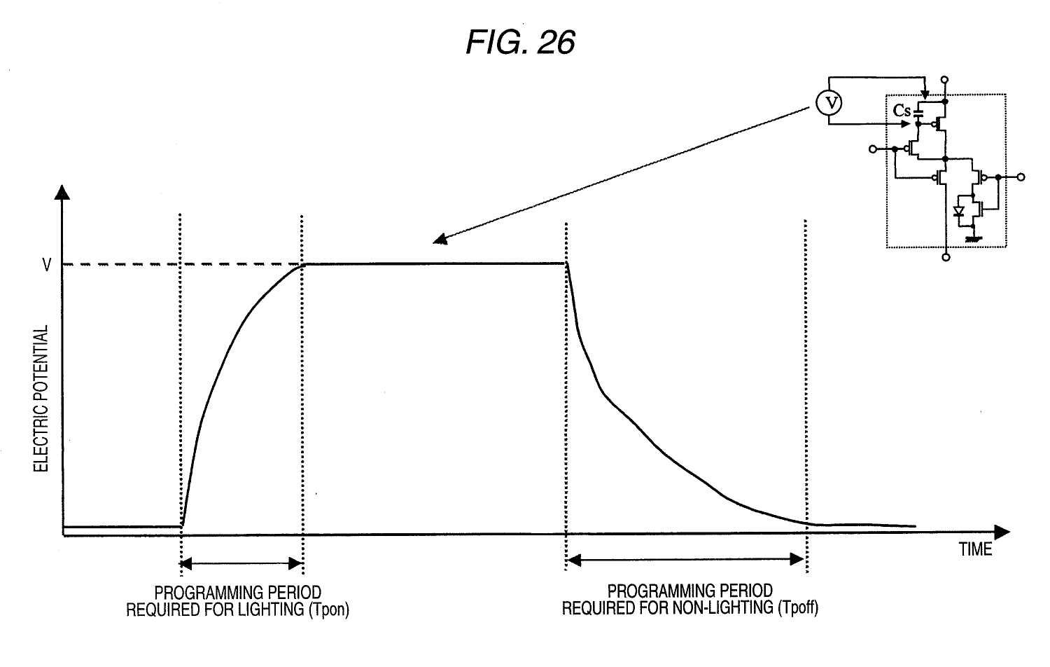

FIG. 26 is an explanatory diagram showing a change in electric potential of a capacitance element Cs (see FIG. 19 for reference) in a programming period.

Hereinafter, advantages of the third embodiment will be described with reference to FIG. 26.

In FIG. 26, the horizontal axis represents a time lapse, and the vertical axis represent an electric potential. The curve portion where the electric potential increases corresponds to a stage where charge required for the light emission of the organic EL element 63 is being accumulated (charged). The time lapse during that stage corresponds to a programming period Tpon required for lighting the organic EL element 63. The curve portion where the electric potential decreases corresponds to a stage where the accumulated charge is being output (discharged) to make the organic EL element 63 unlighted. The time lapse during that stage corresponds to a programming period Tpoff required for making the organic EL element 63 unlighted.

Unlike the second embodiment, in the present embodiment, without controlling the transistors Tr4 in pixels in an independent manner, as shown in FIG. 24, it is assumed that the transistors are driven only in accordance with the light emission control master signal SCNB_M*(SCNB_M1 to SCNB_M8). In this case, regardless of the ON and OFF of the image data, the same signal (the light emission control master signal SCNB_M* (SCNB_M1 to SCNB_M8)) is commonly input in every 8 pixels. Since the light emission control master signal SCNB_M* is switched ON and OFF with a predetermined timing regardless of the image data, it is necessary to completely discharge the electric potential of the capacitor Cs in order to put the organic EL element 63 in the non-lighting state. When the discharging operation is incompletely performed, the potential remaining in the capacitor Cs after the period Tpoff may erroneously make the organic EL element 63 slightly lighted at the ON time of the light emission control master signal SCNB_M*. Since such a slight lighting may cause a critical problem in that an image may be formed by the slight lighting (or erroneous light emission from the viepoint of an image forming apparatus), it is necessary to set the period Tpoff sufficiently great, which however may cause an increase in the programming period.

Meanwhile, in the third embodiment, as illustrated in the example of FIG. 26, since each pixel can be controlled to be lighted or unlighted by the SCNB_P* signal in accordance with the image data, the pixels are unlighted regardless of the potential of the capacitor Cs, even when the period Tpoff required for the non-lighting is great. Accordingly, the period Tpon required for the lighting can be set as the period required for the programming, and it is thus possible to decrease the programming period.

Accordingly, it is possible to decrease the programming period and realize a further increase in the image forming speed. In other words, it is possible to increase the number of pixels to be processed by a single D/A converter 72 of the source driver 61. That is, since it is possible to decrease the programming period pr one pixel, even when the the number of pixels to be processed by one D/A converter 72 is increased, it is possible to complete the programming for the entire pixels in the same period as that before increasing the number of pixels to be processed. Accordingly, it is possible to decrease the number (i.e., the number of output channels) of D/A converters 72 in the source driver 61 and simplify the configuration of the apparatus, thereby decreasing the manufacturing cost.

With such a configuration of the third embodiment, it is possible to decrease the programming period required for each pixel. Thus, it is possible to realize a further increase in an image forming period. Moreover, it is possible to simplify a configuration of an image forming apparatus and decrease the manufacturing cost.

The third embodiment includes the following aspects.

A light-emitting element driving device in accordance with an aspect of the third embodiment is a light-emitting element driving device which drives a plurality of light-emitting elements. The light-emitting element driving device includes a plurality of driving elements which drive the plurality of light-emitting elements in an independent manner, a plurality of first signal lines connected to the driving elements so as to input a light emission control signal for controlling lighting or non-lighting of the light-emitting elements to the driving elements, and a plurality of second signal lines connected to the driving elements so as to input, to the driving elements, a programming control signal for setting a driving condition of the light-emitting elements, in which each of the driving element includes in which each of the driving element includes a driver unit connected to the first signal lines so as to drive the light-emitting elements on the basis of the light emission control signal, and a programming unit connected to the second signal lines so as to set the driving condition on the basis of the programming control signal. The plurality of first signal lines are configured to input the light emission control signal to the driving elements in an independent manner, and the plurality of second signal lines are configured to input the programming control signal to each group of the plurality of driving elements. With such a configuration, it is possible to decrease the programming period required for each of the light-emitting elements. Accordingly, it is possible to realize a further speeding up and manufacturing cost reduction in an apparatus such as an image forming apparatus to which the light-emitting element driving device is applied.

In the light-emitting element driving device in accordance with the above aspect of the third embodiment, the programming unit is configured to set the current value or the voltage value for driving the EL elements as the driving condition.

In the light-emitting element driving device in accordance with the above aspect of the third embodiment, the driver unit may include a first transistor connected in serial to the light-emitting element and a second transistor connected in parallel to the light-emitting element.

In the light-emitting element driving device in accordance with the above aspect of the third embodiment, when the image data is a 2-valued signal, the data input to the light-emitting element driving device may be directly used as the light emission control signal. When the image data is a multi-valued signal, there may be provided a determination unit for determining whether the image data is non-zero data.

A light-emitting element driving device in accordance with another aspect of the third embodiment is a light-emitting element driving device with an electrically active matrix structure. The light-emitting element driving device includes a plurality of light-emitting elements, driving elements provided in correspondence to the light-emitting elements so as to drive the light-emitting elements on the basis of a predetermined driving condition, first signal lines for instructing lighting and non-lighting of the light-emitting elements to the driving elements, and second signal lines for supplying timings for setting the driving condition of the light-emitting elements to the driving elements. In this case, the driving elements may be configured to set the current value or the voltage value for driving the light-emitting elements in accordance with the driving condition setting timings.

In the third embodiment, an organic EL element may be used as the light-emitting element. In addition, the light-emitting element driving device in accordance with the third embodiment is desirably applicable to an image forming apparatus. Accordingly, it is possible to suppress an increase in the manufacturing cost of the image forming apparatus.

### Fourth Embodiment

Hereinafter, a fourth embodiment of the invention will be described in detail.

There have been known that the organic EL element may experience a so-called light intensity deterioration in which the luminance thereof is gradually deteriorated as the number of the drivings increases. Unlike the organic EL element used in a general display apparatus, the organic EL element used in the exposure device mounted on an image forming apparatus such as electrophotographic apparatus requires extremely high luminance and is likely to be influenced by the light intensity deterioration. Therefore, it is necessary to correct the exposure light intensity in order to maintain individual exposure light intensity of the organic EL elements at a state equivalent to an initial state.

In the image forming apparatus, a technology for decreasing the amount of driving data requird in a print head to decrease the amount of memories is disclosed for example in JP-A-01-075257.

However, since a number of organic EL elements are used in the image forming apparatus, it is necessary to supply the driving data corresponding to each element to drive the elements. For example, when an exposure amount is changed in accordance with the image data having a plurality of gradatation levels, in order to prepare the light intensity correction data in correspondence to each of the gradataion levels, the amount of the light intensity correction data may increase extremely, thereby increasing the amount of memories required for the apparatus. In addition, there may be caused an increase in the manufacturing cost of the apparatus.

According to the fourth embodiment, there is provided a light-emitting element driving device and a driving data generation method capable of decreasing the amount of required memory, and an image forming apparatus with a simple configuration and low manufacturing cost by utilizing the light-emitting element driving device and the driving data generation method.

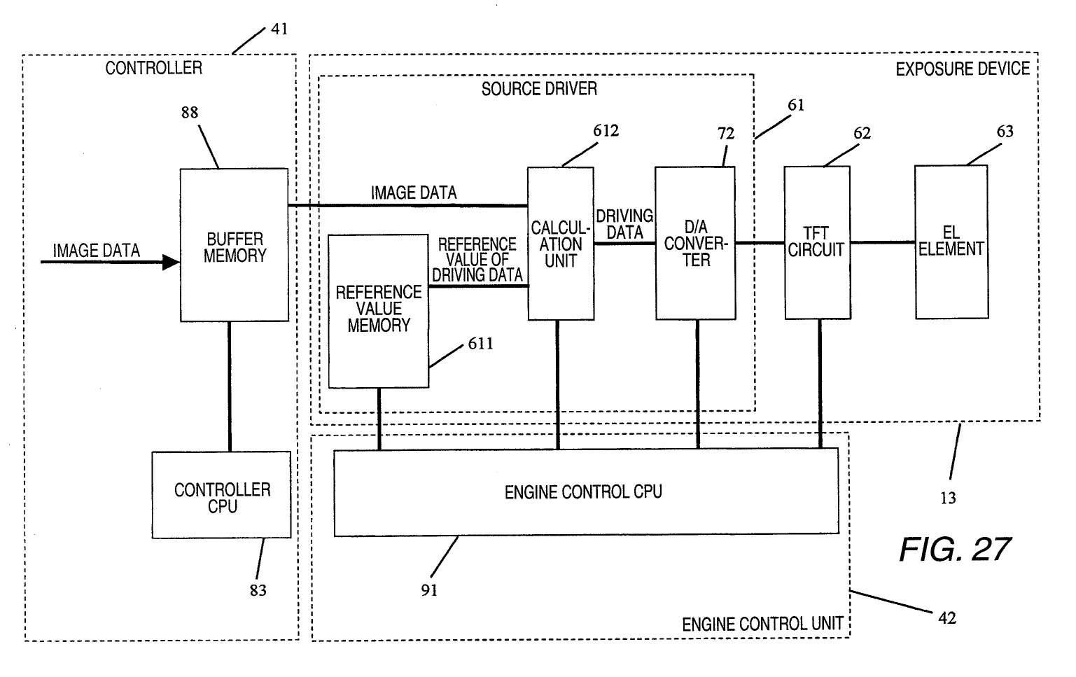

Next, a method of generating driving data of the organic EL element 63 and a configuration for executing the method which are the subject matter of the fourth embodiment will be described. In the driving data generation method in accordance with the fourth embodiment, a predetermined computation is performed on the basis of a driving data reference value of each element that is prepared in correspondence to the image data supplied from a main body (a controller 41 (see FIG. 5 for reference) of the image forming apparatus, and the driving data is generated in accordance with a gradation. FIG. 27 is a diagram showing a configuration of a portion of an image forming apparatus related to generation of driving data in accordance with a fourth embodiment of the invention.

In FIG. 27, other components of the source driver 61 excluding a reference value memory 611 and a calculation unit (driving data generation unit) 612 are already described above.

The buffer memory 88 stores therein multi-valued image data (for example, 2 bits per one pixel) stored in the image memory 65 (see FIG. 5 for reference) under the control of the controller CPU 83. Data (driving data) for driving the organic EL elements (each pixel) is sequentially read out by the source driver 61 with a predetermined timing. Then, the organic EL elements 63 are driven by the TFT circuit 62 drives in accordance with the driving data generated by the source driver 61.

The source driver 61 includes a driving data reference value memory 611 and a calculation unit 612. The driving data reference value memory 611 is a memory for maintaining data serving as a basis for driving (lighting) the organic EL elements 63, and the driving data reference value is maintained for each pixel. That is, when there are a total of 5120 elements and the data bit length is 8-bit, The driving data reference value memory 611 has a capacity of 5120 byte.

The calculation unit 612 serving as the driving data generatin unit performs a predetermined computation (such as multiplication of coefficient corresponding to a gradation) to the driving data reference value of a pixel in accordance with a pixel data value so as to generate driving data of each pixel. As described above, the D/A converter 72 converts the digital driving data to an analog parameter value for driving the organic EL element. As the analog parameter value, a current value, a voltage value, or a light emission period (pulse width) may be used.

In the light-emitting element driving device in accordance with the fourth embodiment, the reference value memory 611 and the calculation unit 612 are included in the source driver 61. However, the reference value memory 611 and the calculation unit 612 are not necessarily included in the source driver 61, but may be provided at other locations in the exposure device 13 or the image forming apparatus 1.

For example, when image data having 4 gradation levels per one element (i.e., 2-bit image data) is used as the multi-valued image data, the values in each digit can express four types of gradation data for the lighting states of each pixel including the non-lighting state. In this case, the coefficients k₀, k₁, k₂ and k₃ for expressing the gradations are expressed by 2-bit data (0, 0), (0, 1), (1, 0), (1,1), respectively.

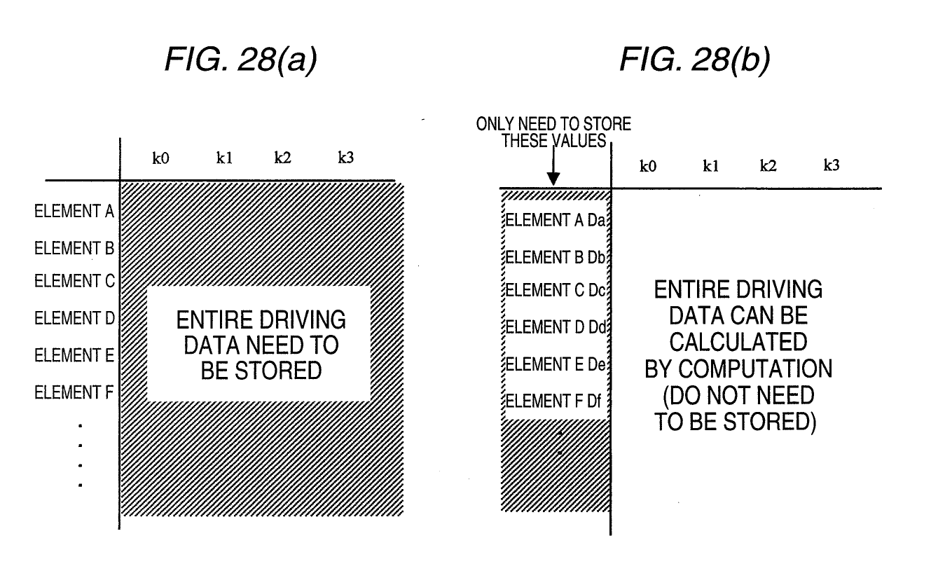

FIG. 28 is a diagram for explaining the concept of the driving data generation in accordance with the fourth embodiment of the invention in comparison with the known art.

In the configuration of the known art, as shown in FIG. 28(a), the driving data corresponding to the coefficients k₀, k₁, k₂ and k₃ supplied from the buffer memory 88 are memorized in the memory in correspondence to the entire elements. This is because the lighting characteristic of the light-emitting elements may differ from element to element and thus the driving data needs to have different values even when expressing the same gradation level. In such a configuration, the memory needs to have a large capacity, and the manufacturing cost of the image forming apparatus increases inevitably.

Therefore, in the fourth embodiment, as shown in FIG. 28(b), driving data reference values Da, DB, . . . , and the like are obtained in advance, through measurements, in correspondence to each of the elements, i.e., element A, element B, . . . , and the like, and are stored in a reference value memory 611. The driving data reference value is a reference value (current value, voltage value, or lighting period) required for the individual elements, in order to make the luminance of the entire organic EL elements 63 (more specifically, the exposure amount in the photosensitive member) substantially the same. Thereafter, the driving data reference value is corrected on the basis of the coefficient k₀, k₁, k₂, k₃ expressed by the image data transmitted from the buffer memory 88, and the driving data to be actually used to drive the elements is generated through computation. In this case, the coefficient may be transmitted as the multi-valued image data itself or its real value. In a case where 2-bit multi-valued image data itself is transmitted, a calculation unit 612 may convert the 2-bit multi-valued image data into the real value. As a specific example, the driving data may be obtained by multiplying the driving data reference value with the coefficient. The computation is performed by the calculation unit 612.

According to the fourth embodiment, it is possible to calculate the driving data of the light-emitting elements through a simple computation, thereby decreasing the amount of required memory greatly.

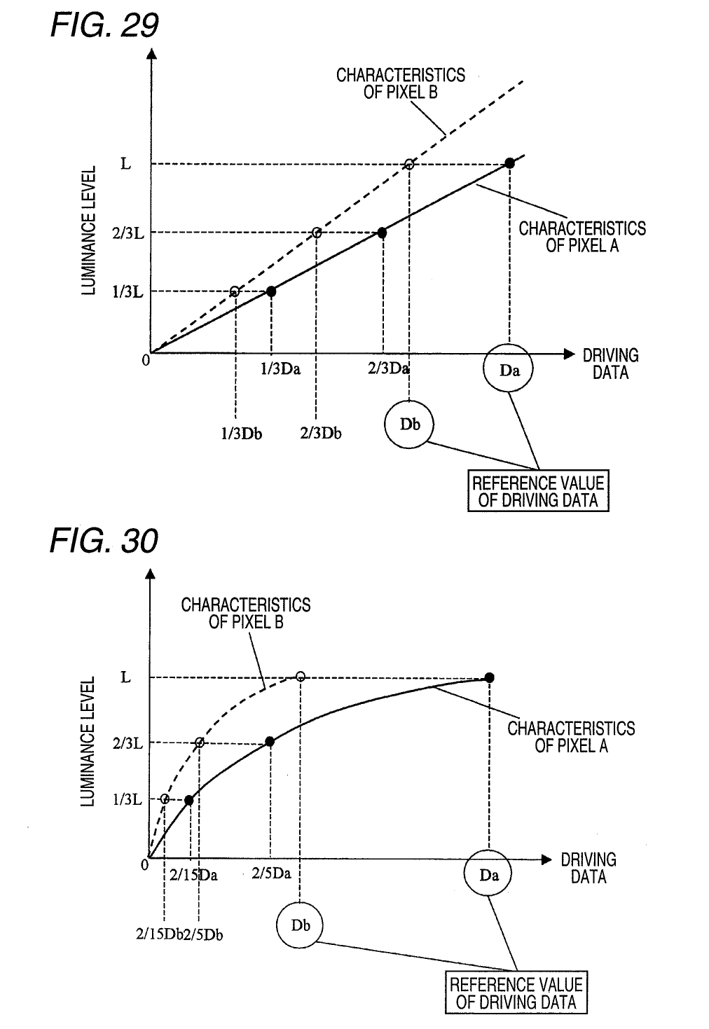

Next, as an example of the driving data generation method in accordance with the fourth embodiment, a method of controlling multi-gradations in the light-emitting elements will be described with reference to FIG. 29. In the drawing, an electric current value is used as a control parameter for controlling the organic EL element 63.

FIG. 29 is a characteristic diagram showing an example of a relationship between a driving current and a luminance of the EL element 63 in accordance with the fourth embodiment of the invention.

As shown in FIG. 29, the value of the current flowing through the organic EL element 63 is generally linear to the luminance of the organic EL element 63. Assuming that such a luminance characteristic with respect to the current value (the characteristic of the luminance change with respect to the current value change) is equal over the entire elements, the lighting characteristic of arbitrary two light-emitting elements A and B may be represented by the graph shown in FIG. 29.

As described above, the driving data reference value for each of the light-emitting elements is stored in the reference value memory 611 provied in correspondence to each of the light-emitting elements. For example, the driving data (current value) at which a plurality of light-emitting elements can have the same predetermined luminance L as a common luminance is defined as the driving data reference value. That is, driving data reference values Da, DB, . . . , and the like are obtained in advance, through measurements, in correspondence to each of the elements, i.e., element A, element B, . . . , and the like, and are stored in a reference value memory 611. In general, the same luminance L is commonly set to the entire light-emitting elements.

The calculation unit 612 determines the coefficient kₙ to be multiplied with the driving data reference value (Da, Db, . . . ) for each of the light-emitting elements in accordance with the received image data. In the example, as described above, four coefficients are defined in advance in correspondence to 2-bit data, for example, k₀, =0 (0, 0), k, =⅓ (0, 1), k₂=⅔ (1,0), k₃=1 (1,1). Then, the calculation unit 612 can determine the coefficient from the 2-bit data, i.e., form the received image data.

In the present example, since the current value and the luminance is linear to each other, four types of luminances 0, ⅓ L, ⅔ L, L are set to each element in correspondence to the image data. Then, the calculation unit 6123 multiplies the coefficients with the driving data reference value so that driving data of each element “Da, ⅔ Da, ⅓ Da, 0,” “Db, ⅔ Db, ⅓ Db, 0” are generated for each gradation level. This is equivalent to determining the real value to be used in the calculation unit 612 for computation in accordance with the received image data.

In the fourth embodiment, there is utilized a fact that as long as the pixels have substantially the same luminance characteristic (the current value and the luminance is linear to each other), or even when the luminance at a specific current value is different from element to element, as long as it is possible to know the current value at which a certain level of luminance is obtainable, it is possible to control the luminance through computation. In the fourth embodiment, the driving data of each of the light-emitting elements are obtained through computation only from the driving reference data of each element and the coefficient based on the received image data (for example, by multiplying the driving reference data with the coefficient). Therefore, it is unnecessary to memorize the driving data for each light-emitting element in advance in correspondence to each data value (gradation level) of the image data. Accordingly, it is possible to decrease the memory amount.

FIG. 30 is a characteristic diagram showing another example of a relationship between a driving current and a luminance of the EL element 63 in accordance with the fourth embodiment of the invention.

As shown in FIG. 30, the fourth embodiment may be applied to a case where the current for driving the light-emitting element and the luminance are not linear to each other. In the example, as the coefficients to be multiplied with the driving data reference value (Da, Db, . . . , and the like), k₀=0 (0, 0), k₁= 2/15 (0, 1), k₂=⅖ (1, 0), k₃=1 (1,1) are defined in advance in correspondence to 2-bit data. Then, the calculation unit 612 can determine the coefficient from the 2-bit data, i.e., form the received image data. In this case, four types of luminances 0, ⅓ L, ⅔ L, L are set to each element similar to the case of FIG. 29.

As described above with reference to FIG. 29, in the light-emitting element to which the fourth embodiment is desirably applicable, the proportion of change in the luminance (or exposure energy when controlling the lighting period) with respect to the proportion of change in driving data such as current value, voltage value, or lighting period in a plurality of light-emitting elements is substantially constant, i.e., they are proportional to each other. The fourth embodiment is applicable as long as the light-emitting element has such a characteristic, and an application object is not limited to the organic EL element.

As described with reference to FIG. 30, even when the driving current for driving the light-emitting element and the luminance are not linear to each other, the fourth embodiment can be applicable as long as a characteristic relationship between driving parameters such as driving current and the luminance (or exposure energy) can be known in advance. Such a characteristic relationship can be specified by a simple experiment.

In the above description, although the final driving data for driving the organic EL element 63 is determined through computation, the calculation unit 612 may be modified to convert the image data to the driving data using a look-up table LUT, for example.

In the fourth embodiment, although four types of gradations including the non-lighting state were set, the number of gradations is not limited to this. The driving data reference value is not limited to the current value, but voltage value or lighting period (pulse width) may be used as the driving data reference value. That is, in the fourth embodiment, the driving data reference value for making the luminance substantially the same is set to the reference value memory 611. However, as long as it can prevent the irregularity in the exposure amount on the photosensitive member 8 based on the output light from the light-emitting element, a driving data reference value may be set to the reference value memory 611 in correspondence to each of the light-emitting elements. In addition, it is unnecessary to make the exposure amount completely the same, the driving data reference value may be set in correspondence to each light-emitting element in such a manner that the exposure amount for each light-emitting element is substantially equal to each other, i.e., the difference of exposure amounts between light-emitting elements is in a predetermined range.

In the fourth embodiment, the maximum luminance L of the multi-valued image data is defined as a reference, and the reference L is multiplied with a coefficient equal to or smaller than 1, i.e., k₀=0, k₁=⅓, k₂=⅔, k₃=1. However, it is unnecessary to define the maximum luminance as the reference. When a value equal to or smaller than the maximum luminance is used as the reference value, the greater value may be expressed by multiplying a coefficient equal to or greater than 1. As long as the driving parameter and the luminance are proportional to each other, the final driving data may be calculated through interpolation or extrapolation. Even when the driving parameter and the luminance are not proportional to each other, the driving data may be calculated through extrapolation as long as the error that may be generated when using a relation that can be defined by a certain function (for example, a second-order function or an exponential function) is in a predetermined range. The same statement can be equally applicable to the exposure amount.

The location of the reference value memory 611 is not particularly limited, and may be installed at arbitrary locations in the exposure device 13 or the image forming apparatus. When the reference value memory 611 is installed in the exposure device 13, particularly in the source driver 61 on the glass substrate 50, it is possible to decrease the number of bus lines between the exposure device 13 and the controller 41, thereby simplifying the configuration of the image forming apparatus. This is because data transmitted from the controller 41 to the exposure device 13 is the image data representing the gradation level.

According to the fourth embodiment, in a light-emitting element driving device including a plurality of light-emitting elements and capable of setting an exposure amount based on the light emitted from the light-emitting elements in accordance with input image data, there is provided a method of generating driving data for driving the light-emitting elements.

The method includes a step of receiving the image data, and a step of generating the driving data for driving the light-emitting elements on the basis of the received image data and a driving data reference value in which the differene of the exposure amounts between the light-emitting elements is in a predetermined range. In addition, a program for executing such a method is also included in the fourth embodiment. Such a program may be memorized in the engine control unit 42 or in a memory or storage device prepared in the source driver 61, and is read into a calculation device such as the engine control CPU 91 and executed therein.

The “multi-valued image data” used in the fourth embodiment refers to image data having information amount equal to or greater than three values (2-bit or more). The fourth embodiment becomes more advantage as the information amount increases. However, the configuration of the fourth embodiment may not be applicable to the case of 2-valued image data.

The difference of exposure amounts between the organic EL elements is desirably set so that the range of irregularity in the exposure amount with respect to the average of the exposure amount of the entire light-emitting elements is in the range of ±3%. This is because it has been empirically known that the irregurality at the time of forming an image can be made invisible by controlling the error rate of the exposure amount to be within ±3% with respect to the average of the exposure amount of the entire light-emitting elements in the exposure device. Such a difference range may be obtainable by setting the data amount (number of bits) of the driving data reference value to, for example, 8 to 10 bits.

With such a configuration of the fourth embodiment, it is possible to eliminate the necessity of preparing the driving data for respective gradations of the light-emitting elements. Accordingly, it is possible to decrease the amount of the entire driving data greatly, thereby decreasing the amount of memories required in the image forming apparatus. Moreover, it is possible to suppress an increase in the manufacturing cost of the image forming apparatus.

The fourth embodiment includes the following aspects.

A light-emitting element driving device in accordance with an aspect of the fourth embodiment is a light-emitting element driving device including a plurality of light-emitting elements and capable of setting an exposure amount based on the light emitted from the light-emitting elements in accordance with input image data. The light-emitting element driving device includes a driving data generation unit generating driving data for driving light-emitting elements on the basis of the image data and a driving data reference value in which the differene of the exposure amounts between the light-emitting elements is in a predetermined range. With such a configuration, it is possible to eliminate the necessity of preparing the driving data for respective gradations of the light-emitting elements. Accordingly, it is possible to decrease the amount of the entire driving data greatly, thereby decreasing required memory amount.

In the light-emitting element driving device in accordance with the above aspect of the fourth embodiment, the driving data generation unit may be configured to receive the image data and the driving data reference value and output the driving data through a predetermined computation. Accordingly, it is possible to generate the driving data through a simple calculation. The predetermined computation is carried out by multiplying the driving data reference value with coefficients expressed by the image data, for example.

It is desirable that the light-emitting element has a characteristic that the finally obtained driving data is substantially linear to the luminance of the light-emitting element. With such a configuration, it is made easy to set the above-described coefficients.

The driving data reference value may be selected from at least one of the current value for driving the light-emitting element, the voltage value applied to the light-emitting element, and the light emission period of the light-emitting element.

The image data may be multi-valued (at least three or more) image data.

The light-emitting element driving device may include a reference value memory for storing the driving data reference value.

The light-emitting element, the reference value memory, and the driving data generation unit may be formed on a single substrate. The light-emitting element driving device may be configured such that the single substrate is configured with a glass substrate, the light-emitting element is formed in a TFT circuit formed on the glass substrate, and the reference value memory and the driving data generation unit are incorporated into an IC chip disposed on the glass substrate. With such a configuration, it is possible to simplify an operation of mounting the light-emitting element driving device on a main body (for example, an image forming apparatus).

In the fourth embodiment, an organic EL element may be used as the light-emitting element. In addition, the light-emitting element driving device in accordance with the fourth embodiment is desirably applicable to an image forming apparatus. Accordingly, it is possible to suppress an increase in the manufacturing cost of the image forming apparatus.

According to a further aspect of the fourth embodiment, in a light-emitting element driving device including a plurality of light-emitting elements and capable of setting an exposure amount based on the light emitted from the light-emitting elements in accordance with input image data, there is provided a method of generating driving data for driving the light-emitting elements. The method includes a step of receiving the image data, and a step of generating the driving data for driving the light-emitting elements on the basis of the received image data and a driving data reference value in which the differene of the exposure amounts between the light-emitting elements is in a predetermined range. In addition, a program for executing such a method is also included as an aspect of the fourth embodiment.

Hereinabove, the embodiments have been described with reference to an arrangement in which the lighting periods of the organic EL elements 63 constituting the exposure device 13 are set to a constant period and the light intensity of the organic EL elements 63 is controlled by changing the current value. However, the invention may be easily applied to a so-called PWM method in which the driving current value of the light emitting element such as the organic EL element 63 is set to a fixed value and the light intensity of the light emitting element is controlled by changing the lighting period. In this case, the content of the first area described with reference to FIG. 6 may be substituted by “the setting value of the driving period for making the cross sectional areas the latent images equal to each other.”

Although the above-described embodiments have been described with reference to a so-called electro-photographic apparatus, as an example of the image forming apparatus, which forms a latent image using an exposure, the invention is not limited to the electro-photographic method. Alternatively, the invention may be easily applied to an image forming apparatus being configured to expose a photographic paper to light beams corresponding to R, G, and B colors. While the invention has been described with reference to various embodiments, the invention is not limited to the above-described embodiments. However, various modifications can be made on the basis of the whole description of the specifications and the known technologies. Such modifications are also included in the technical scope of the invention.

As described above, when the light-emitting element driving device in accordance with the invention is used in an image forming apparatus, it is possible to decrease a programming period for driving individual light-emitting elements, flexibly cope up with an increased number of gradation levels in image data, and realize a further increase in an image forming speed and a printing speed while maintaining a stable operation. Accordingly, the light-emitting element driving device in accordance with the invention can be used in a printer, a copying machine, a facsimile machine, a photo printer, and the like, for example.

This application is based upon and claims the benefit of priority of Japanese Patent Application No 2006-112322 filed on Apr. 14, 2006, Japanese Patent Application No 2006-112323 filed on Apr. 14, 2006, Japanese Patent Application No 2006-112324 filed on Apr. 14, 2006, Japanese Patent Application No 2006-112325 filed on Apr. 14, 2006, the contents of which are incorporated herein by reference in its entirety.

What is claimed is:

1. A light-emitting driving device, comprising:
a light-emitting element array including a plurality of light-emitting elements;
a driver including a plurality of driving elements, the plurality of light-emitting elements included in the light-emitting element array being driven by the plurality of driving elements included in the driver;
a plurality of first signal lines connected to the plurality of driving elements, respectively; and
a plurality of power supply lines and a plurality of ground lines connected to the plurality of driving elements, respectively,
wherein an entire line width of each of the plurality of first signal lines is greater as a distance from a signal source increases.

2. The light-emitting element driving device according to claim 1,
wherein the plurality of first signal lines comprise driver signal lines connected to an external integrated circuit so as to input a driving current or a driving voltage to the plurality of light-emitting elements.

3. The light-emitting elements driving device according to claim 2,
wherein the integrated circuit has a relative positional relationship with the driver such that the integrated circuit is positioned substantially at a central portion of the light-emitting element array including the plurality of light-emitting elements.

4. The light-emitting element driving device according to claim 2,
wherein the integrated circuit comprises a plurality of integrated circuits, and
the plurality of integrated circuits have a relative positional relationship with the driver such that each of the plurality of integrated circuits is positioned substantially at a central portion of each element block obtained by dividing the light-emitting element array including the plurality of light-emitting elements into element blocks corresponding to a number of the plurality of integrated circuits.

5. The light-emitting element driving device according to claim 1, further comprising a plurality of second signal lines connected to the plurality of driving elements so as to input a second signal to the plurality of driving elements,
wherein the second signal lines are connected to the driver from a same direction as a connection direction of the plurality of first signal lines.

6. The light-emitting element driving device according to claim 5,
wherein the plurality of first signal lines comprise driver signal lines connected to an external integrated circuit so as to input a driving current or a driving voltage to the plurality of light-emitting elements, and
wherein one of the plurality of first signal lines and the plurality of second signal lines are light emission control signal lines for controlling an ON and OFF state of the plurality of light-emitting elements, and the other of the plurality of first signal lines and the plurality of second signal lines are programming control lines for setting a driving current or a driving voltage.

7. The light-emitting element driving device according to claim 6,
wherein the integrated circuit has a relative positional relationship with the driver such that the integrated circuit is positioned substantially at a central portion of the light-emitting element array including the plurality of light-emitting elements.

8. The light-emitting element driving device according to claim 6,
wherein the integrated circuit comprises a plurality of integrated circuits, and
the plurality of integrated circuits have a relative positional relationship with the driver such that each of the plurality of integrated circuits is positioned substantially at a central portion of each element block obtained by dividing the light-emitting element array including the plurality of light-emitting elements into element blocks corresponding to a number of the plurality of integrated circuits.

9. The light emitting element driving device according to claim 1,
wherein the light-emitting element is configured with an organic EL (electro-luminescence) element.

10. A light-emitting element driving device, comprising:
a light-emitting element array including a plurality of light-emitting elements aligned in an array configuration;
a driver including a plurality of driving elements aligned along the light-emitting element array, the plurality of light-emitting elements included in the light-emitting element array being driven by the plurality of driving elements included in the driver; and
a plurality of first signal lines connected to the plurality of driving elements, respectively;
a plurality of power supply lines and a plurality of ground lines connected to the plurality of driving elements, respectively; and
a plurality of second signal lines connected to the plurality of driving elements, respectively,
wherein the plurality of first signal lines and the plurality of second signal lines are connected from different directions to the driver in directions crossing an arrangement direction of the light-emitting element array,
wherein an entire line width of each of at least one of the plurality of first signal lines and the plurality of second signal lines is greater as a distance from a signal source increases.

11. The light emitting element driving device according to claim 10,
wherein the light-emitting element is configured with an organic EL (electro-luminescence) element.

12. A light-emitting element driving device with an electrically active matrix structure, comprising:
a plurality of light-emitting elements aligned in an array configuration;
driving elements provided in correspondence to the plurality of light-emitting elements so as to drive the plurality of light-emitting elements;
first signal lines for setting driving conditions of the plurality of light-emitting elements to the driving elements; and
second signal lines for controlling operations of the driving elements,
wherein the first signal lines and the second signal lines are configured not to cross each other,
wherein at least one of the plurality of first signal lines and the plurality of second signal lines have a greater line width as a distance from a signal source increases.

13. The light emitting element driving device according to claim 12,
wherein the light-emitting element is configured with an organic EL (electro-luminescence) element.
